(19) United States
(12) Patent Application Publication
(10) Pub. No.: US 2026/0111085 A1
(43) Pub. Date: Apr. 23, 2026

(54) ELECTRONIC DEVICE AND METHOD FOR RECOGNITION OF INPUT WITH RESPECT TO THREE-DIMENSIONAL IMAGE

(71) Applicant: Samsung Electronics Co., Ltd., Suwon-si (KR)

(72) Inventors: Hyunchul HONG, Suwon-si (KR); Daewon KANG, Suwon-si (KR); Byoungjun KIM, Suwon-si (KR); Cheolwoong PARK, Suwon-si (KR); Hyerim BAE, Suwon-si (KR); Shinhyuk YOON, Suwon-si (KR); Eunbi LEE, Suwon-si (KR); Jinwook CHUN, Suwon-si (KR)

(21) Appl. No.: 19/287,573

(22) Filed: Jul. 31, 2025

Related U.S. Application Data
(63) Continuation of application No. PCT/KR2025/011033, filed on Jul. 24, 2025.

(30) Foreign Application Priority Data
Oct. 22, 2024 (KR) 10-2024-0145333
Nov. 14, 2024 (KR) 10-2024-0162091

(51) Int. Cl. G06F 3/042; G02B 30/27; G06F 3/0354; G06F 3/041

(52) U.S. Cl. CPC G06F 3/0425; G02B 30/27; G06F 3/03545; G06F 3/0412

(57) ABSTRACT

An electronic device includes at least one camera, a touch sensitive display, at least one processor, and memory storing instructions. The instructions, when executed by the at least one processor individually or collectively, cause the electronic device to, based on a three-dimensional (3D) display mode, for providing a 3D effect image at a space in front of the touch sensitive display, display, via the touch sensitive display, two images, based on a position relationship between the electronic device and an eye of a user in front of the electronic device, set a spatial range positioned in the space with respect to the 3D effect image, identify, via the at least one camera, whether a specified portion of a stylus pen is moved into the spatial range; and, based on the specified portion of the stylus pen being moved into the spatial range, identify a position of the specified portion of the stylus pen as an input with respect to the 3D effect image.

### CROSS-REFERENCE TO RELATED APPLICATIONS

This application is a continuation of International Application No. PCT/KR2025/011033 designating the United States, filed on Jul. 24, 2025, in the Korean Intellectual Property Receiving Office and claiming priority to Korean Patent Application Nos. 10-2024-0145333, filed on Oct. 22, 2024, and 10-2024-0162091, filed on Nov. 14, 2024, in the Korean Intellectual Property Office, the disclosures of each of which are incorporated by reference herein in their entireties.

### BACKGROUND

### Field

The disclosure relates to an electronic device and a method for recognition an input with respect to a three-dimensional (3D) image.

### Description of Related Art

In order to execute a function in response to a finger or a stylus pen in contact with a display panel, an electronic device may include touch circuitry disposed with respect to the display panel. For example, the touch circuitry may include a touch sensor for identifying the contact based on a capacitive method, a resistive method, an infra-red method, an acoustic method, and/or a pressure method, and processing circuitry for obtaining data through the touch sensor.

The above-described information may be provided as a related art for the purpose of helping to understand the present disclosure. No assertion or determination is raised as to whether any of the above-described information may be applied as a prior art related to the present disclosure.

### SUMMARY

According to an example embodiment, an electronic device may comprise at least one camera. The electronic device may comprise a touch sensitive display. The electronic device may comprise at least one processor including processing circuitry. The electronic device may comprise memory, comprising one or more storage media, storing instructions. The instructions, when executed by the at least one processor individually or collectively, may cause the electronic device to, based on a three-dimensional (3D) display mode of the touch sensitive display, for providing a 3D effect image at a space in front of the touch sensitive display, display, via the touch sensitive display, two images separated from each other. The instructions, when executed by the at least one processor individually or collectively, may cause the electronic device to, based on a position relationship between the electronic device and an eye of a user in front of the electronic device, set a spatial range positioned in the space with respect to the 3D effect image. The instructions, when executed by the at least one processor individually or collectively, may cause the electronic device to, while providing the 3D effect image, identify, via the at least one camera, whether a specified portion of a stylus pen is moved into the spatial range. The instructions, when executed by the at least one processor individually or collectively, may cause the electronic device to, based on the specified portion of the stylus pen being moved into the spatial range, identify a position of the specified portion of the stylus pen as an input with respect to the 3D effect image.

According to an example embodiment, an electronic device may comprise at least one camera configured to obtain an image usable for identifying a distance from the electronic device to an eye and a position of a stylus pen being in conjunction with the electronic device. The electronic device may comprise at least one sensor configured to obtain data usable for identifying a direction of the eye with respect to the electronic device. The electronic device may comprise a touch sensitive display configured to operate in one of a two-dimensional (2D) display mode and a three-dimensional (3D) display mode. The electronic device may comprise at least one processor including processing circuitry. The electronic device may comprise memory, comprising one or more storage media, storing instructions. The instructions, when executed by the at least one processor individually or collectively, may cause the electronic device to, based on the 2D display mode that represents one effect image by displaying, via the touch sensitive display, one image, identify, using the touch sensitive display, an input received from the stylus pen. The instructions, when executed by the at least one processor individually or collectively, may cause the electronic device to, based on the 3D display mode that represents one effect image by displaying, via the touch sensitive display, two images separated from each other, identify, using the at least one sensor and the at least one camera, an input received from the stylus pen.

According to an example embodiment, a system may comprise an electronic device. The system may comprise a stylus pen being in conjunction with the electronic device. The electronic device may be configured to, based on a three-dimensional (3D) display mode of the electronic device, for providing a 3D effect image at a space in front of the electronic device, display two images separated from each other. The electronic device may be configured to, transmit, to the stylus pen, a signal to notify the 3D display mode of the electronic device. The stylus pen may be configured to obtain data usable for identifying a pressure applied to the stylus pen. The stylus pen may be configured to, in response to reception of the signal from the electronic device, transmit, to the electronic device, pressure information indicating the pressure applied to the stylus pen identified based on the data. The electronic device may be configured to receive, from the stylus pen, the pressure information indicating the pressure applied to the stylus pen. The electronic device may be configured to identify a position of a specified portion of the stylus pen as an input having the pressure with respect to the 3D effect image.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1A is a diagram illustrating an example method of recognizing an input on a display of an electronic device displaying a 2D image according to various embodiments;

FIG. 1B is a diagram illustrating an example method of recognizing an input on a display of an electronic device displaying a 3D image according to various embodiments;

FIG. 2 is a block diagram illustrating an example configuration of an electronic device and an external input device according to various embodiments;

FIG. 3A is an exploded perspective view illustrating an example electronic device including touch circuitry for identifying an external input device according to various embodiments;

FIG. 3B is a diagram illustrating an example of a display panel for displaying a 3D image according to various embodiments;

FIGS. 4A and 4B are diagrams illustrating examples of an example driving method for recognizing a touch input by an external input device according to various embodiments;

FIG. 5 is a diagram illustrating example methods in which an electronic device recognizes an input with respect to a 3D image displayed via a display according to various embodiments;

FIG. 6 is a flowchart illustrating an example method in which an electronic device transmits a signal to an external input device and executes a function, in accordance with a position of an external input device with respect to a 3D image displayed via a display according to various embodiments;

FIG. 7 is a diagram illustrating an example method of generating a 3D image according to various embodiments;

FIG. 8 is a diagram illustrating an example method in which an electronic device identifies a reference position defining a space above a display using at least one sensor according to various embodiments;

FIGS. 9A, 9B, 9C, 9D and 9E are diagrams illustrating examples of a method in which an electronic device identifies a position of an external input device in a space using at least one camera according to various embodiments;

FIGS. 10A and 10B are diagrams illustrating examples of a method in which an electronic device transmits a signal to an external input device in accordance with a position of the external input device according to various embodiments;

FIGS. 11A, 11B and 11C are diagrams illustrating examples of a method in which an external input device provides feedback according to various embodiments;

FIGS. 12A and 12B are diagrams illustrating examples of an operation of an electronic device in accordance with a position state of an external input device according to various embodiments;

FIG. 13 is a diagram illustrating an example method in which an electronic device displays a 3D image in a split view according to various embodiments;

FIG. 14 is a diagram illustrating an example method in which an external input device recognizes a pressure according to various embodiments;

FIG. 15 is a signal flow diagram illustrating an example method of correcting a position of an external input device as an electronic device receives motion information from the external input device according to various embodiments;

FIG. 16 is a signal flow diagram illustrating an example method in which an electronic device transmits, to an external input device, a signal allowing to execute a function in accordance with a comparison of a position of the external input device with a reference range according to various embodiments;

FIG. 17 is a diagram illustrating an example method in which an electronic device recognizes an input by an external object with respect to a 3D image displayed via a display according to various embodiments;

FIGS. 18A and 18B are diagrams illustrating an example method in which an electronic device recognizes a plurality of inputs with respect to a 3D image displayed via a display according to various embodiments; and

FIG. 19 is a block diagram illustrating an example electronic device in a network environment according to various embodiments.

### DETAILED DESCRIPTION

Terms used in the present disclosure are used to describe various example embodiments, and may are not intended to limit a range of the disclosure. A singular expression may include a plural expression unless the context clearly indicates otherwise. Terms used herein, including a technical or a scientific term, may have the same meaning as those generally understood by a person with ordinary skill in the art described in the present disclosure. Among the terms used in the present disclosure, terms defined in a general dictionary may be interpreted as identical or similar meaning to the contextual meaning of the relevant technology and are not interpreted as ideal or excessively formal meaning unless explicitly defined in the present disclosure. In some cases, even terms defined in the present disclosure may not be interpreted to exclude embodiments of the present disclosure.

In various embodiments of the present disclosure described below, a hardware approach will be described as an example. However, since the various embodiments of the present disclosure include technology that uses both hardware and software, the various embodiments of the present disclosure do not exclude a software-based approach.

In addition, in the present disclosure, the term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to ’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ refers to at least one of elements from A (including A) to B (including B).

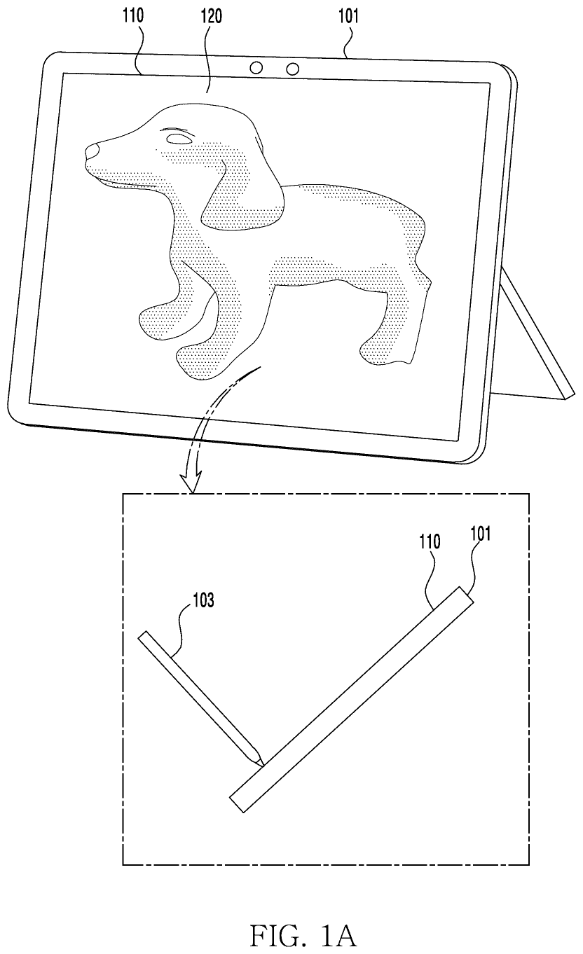

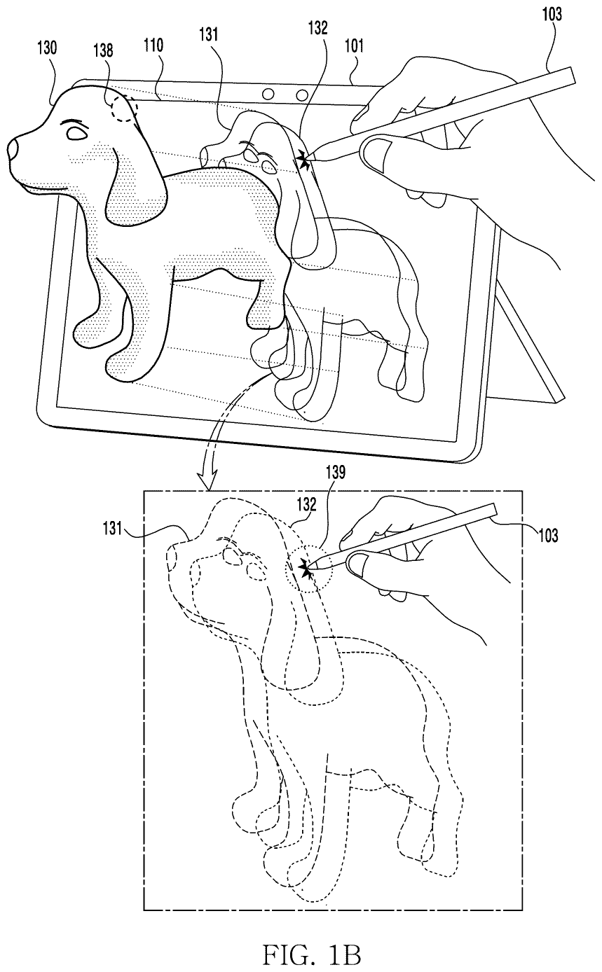

FIG. 1A is a diagram illustrating an example method of recognizing an input on a display of an electronic device displaying a 2D image according to various embodiments. FIG. 1B is a diagram illustrating an example method of recognizing an input on a display of an electronic device displaying a 3D image according to various embodiments.

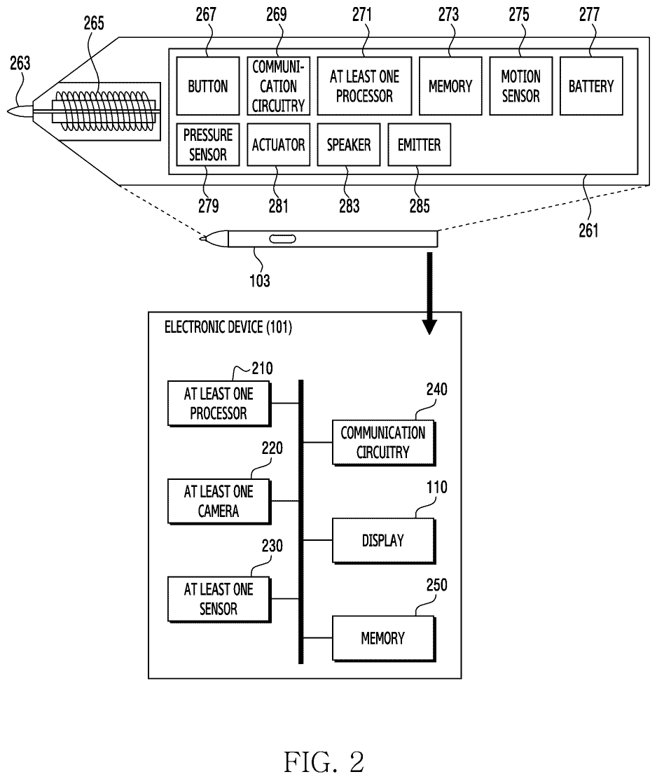

FIG. 1A illustrates an example of a method in which the electronic device 101 (e.g., the electronic device 101 of FIG. 2) recognizes an input on a display 110 while displaying an image 120 via the display 110. In FIG. 1A, the image 120 displayed via the display 110 may be a 2D image displayed on a display region of the display 110. FIG. 1B illustrates an example of a method in which the electronic device 101 recognizes an input on the display 110 while displaying images 131 and 132 via the display 110. In FIG. 1B, when the images 131 and 132 displayed via the display 110 are displayed, a user positioned in a space above (or in front of) the display 110 may recognize the image 130. For example, the image 130 may be a 3D image perceived as being positioned in the space above the display 110 (or the space above a display region of the display 110). For example, the image 130 may not be actually displayed in the space but may be perceived as being positioned in the space with respect to the user, as the electronic device 101 displays the images 131 and 132.

The electronic device 101 of FIGS. 1A and 1B may include a tablet personal computer (PC). However, the present disclosure is not limited thereto. For example, the electronic device 101 may include a smartphone, a smart watch, a television (TV), a monitor, or a device (e.g., a robot) including a display. As a non-limiting example, the electronic device 101 may be an example of an electronic device capable of displaying a 3D image.

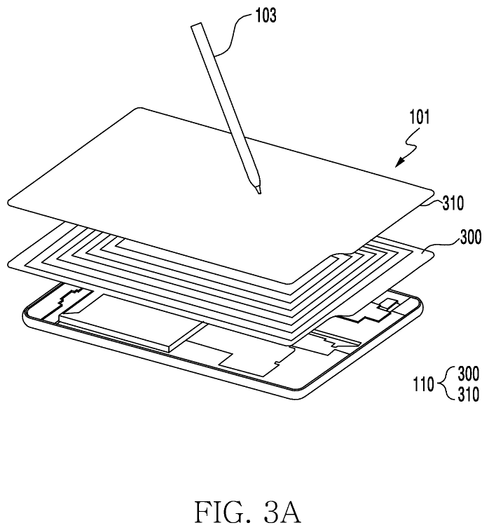

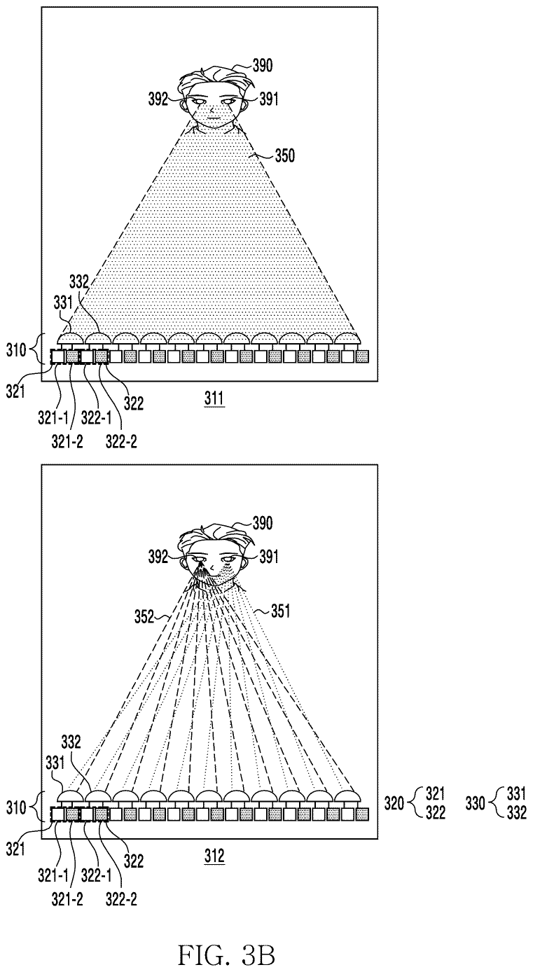

The display 110 of the electronic device 101 of FIGS. 1A and 1B may include a display capable of displaying an image and identifying an input by an external input device 103. In the present disclosure, the display 110 may be referred to as a touch sensitive display. For example, the display 110 may include a display panel including a display region that is visible from the outside. For example, the display panel may include the display region for displaying an image. For example, the display 110 may include a touch sensor for detecting contact points for a touch input received (or obtained or identified) about the display region of the display panel. For example, the touch input may include an input including contact points by the external input device 103 on the display region of the display panel or a hovering input by the external input device 103. For example, the touch sensor may be used to obtain (or measure) sensing data by sensing a change in an electrical characteristic (e.g., capacitance) caused by the contact points (or the contact points by an external object). For example, the display 110 may include an integrated circuit (IC) (or touch IC) that processes sensing data obtained from the touch sensor and controls operations of the touch sensor. For example, the touch sensor and the touch IC may be referred to as touch circuitry. For example, FIG. 3A may be referred to as an example of the display 110 including the touch circuitry.

In FIGS. 1A and 1B, the external input device 103 may include a stylus pen connected (connection established) with the electronic device 101. However, the present disclosure is not limited thereto. For example, the external input device 103 may be an external object (e.g., hand). Hereinafter, in the present disclosure, the external input device 103 may be referred to as a smart pen, an electronic pen, a stylus pen, or a stylus pen.

Referring to FIG. 1A, the electronic device 101 may display the image 120 on the display 110. For example, the image 120 may include a visual object (e.g., puppy). As a non-limiting example, the image 120 may have a size corresponding to the display region of the display 110, or may be smaller than the size of the display region. For example, the image 120 may include a visual object and a background image, or may include only a visual object.

For example, the electronic device 101 may receive an input from the external input device 103 while displaying the image 120 via the display 110. For example, the electronic device 101 may identify (or detect) a position (or position of contact points) of the display region of the display 110 of the external input device 103 in contact with the display 110, and recognize a touch input according to the position. In the example of FIG. 1A, an example of the touch input, which may include an input including contact points, is illustrated, but the present disclosure is not limited thereto. For example, the electronic device 101 may identify (or detect) a position of the external input device 103 spaced apart from the display 110 on the display region of the display 110, and recognize a touch input, which is a hovering input according to the position.

Referring to FIG. 1A, when displaying (or providing) a 2D image (or 2D media content, 2D effect image), the electronic device 101 may identify the external input device 103 positioned adjacent to (or in contact with) the display 110, and recognize a touch input by the external input device 103, thereby providing an output according to the touch input. For example, the output may include a change of the image 120, or execution of at least one function of the electronic device 101. For example, the at least one function may be a function triggered by a touch input.

The recognition of the touch input illustrated in FIG. 1A may indicate that the electronic device 101 displays a 2D image and recognizes a position on the display 110 corresponding to the displayed 2D image. In a case that the electronic device 101 displays a 3D image, specific details related to the electronic device 101 recognizing a position on the display 110 may be referred to FIG. 1B.

Referring to FIG. 1B, the electronic device 101 may display images 131 and 132 on the display 110. For example, each of the image 131 and the image 132 may include the same visual object (e.g., puppy). For example, the image 131 and the image 132 may be displayed in a partially overlapping state. In other words, the image 131 may be displayed in a portion of the display region of the display 110 that is different from a portion where the image 132 is displayed. As the image 131 and the image 132 are simultaneously displayed, a user positioned in front of the display 110 (or the electronic device 101) may recognize the image 130. For example, the image 130 may be referred to as 3D media content or a 3D effect image. For example, the image 130 may be perceived as being positioned in a space between the display 110 and the user.

As a non-limiting example, the display 110 may have a structure for simultaneously displaying the image 131 and the image 132. For example, the display 110 may be referred to as a lenticular display. For example details regarding the lenticular display, FIG. 3B below may be referred to. The display 110 may be a lenticular display including first display regions and second display regions. For example, the first display regions and the second display regions may alternate with each other. In an example, the display 110 may be formed in a structure in which the first display region, the second display region, the first display region, and the second display region are repeated in that order. In FIG. 1B, the first display regions may be used to display the image 131, and the second display regions may be used to display the image 132. As described above, the display 110, which is a lenticular display, may simultaneously display the image 131 via the first display regions and the image 132 via the second display regions, so the image 130 may be perceived by the user as being positioned in the space. For example, the image 130 may be a 3D image (or, 3D media content, a 3D effect image) with different depths for each part of the image 130.

For example, the electronic device 101 may receive an input by the external input device 103 while simultaneously displaying the images 131 and 132 via the display 110. For example, the electronic device 101 may identify (or detect) a position 139 (or position of contact points) on the display region of the display 110 of the external input device 103 that is in contact with the display 110, and recognize a touch input according to the position. In the example of FIG. 1B, an example of the touch input, which is an input including contact points, is illustrated, but the present disclosure is not limited thereto. For example, the electronic device 101 may identify (or detect) a position on the display region of the display 110 of the external input device 103 that is spaced apart from the display 110, and recognize a touch input, which is a hovering input according to the position.

Referring to FIG. 1B, the electronic device 101 recognizes the position 139, but it may be difficult to identify whether the position 139 is a point of the image 131 or a point of the image 132. When the user performs an input to the position 139 while recognizing (or viewing) the image 130 via the external input device 103, a position 138 different from the position 139 intended by the user may be indicated. In other words, the display 110 recognizing the touch input only receives an input to the image 131 (or the image 132) by the external input device 103, but cannot receive an input to the image 130, and an input to the image 131 (or image 132) (e.g., the input to the position 139)) may not be an input intended by the user. According to a sense of difference between an input intended by the user and an input recognized by the electronic device 101, the user may feel discomfort in using the electronic device 101 that displays (or provides) a 3D image (or 3D media content, a 3D effect image).

Although not illustrated in FIG. 1A and FIG. 1B, a wearable device (e.g., a head mounted display (HMD) device) providing extended reality (XR) may display an image providing extended reality via a display. For example, the wearable device may perform an operation to match a position of an input by a user in a real environment with a position in a virtual environment within the displayed image. For example, the operation may include displaying (or indicating) a virtual object (or indicator) corresponding to the user's hand (or a controller of the wearable device) within the image. The wearable device may receive an input reflecting the user's intention by the display of the virtual object. However, the wearable device may display both an image of the virtual environment and an indicator within the virtual environment via a display positioned in front of the user's eye, so the position within the real environment may be matched (or mapped, corresponded) to the position within the virtual environment.

However, as in the electronic device 101 of FIGS. 1A and 1B, recognizing an input to the image 130, which is perceived by the user as being displayed in the space by displaying the images 131 and 132 on the display 110, as an input to at least one of the images 131 and 132 may be difficult to accurately reflect the user's intention. Hereinafter, in the present disclosure, the electronic device 101 displaying a 3D image may identify a position of an external input device 103 with respect to the 3D image and recognize an input to the 3D image in accordance with the position. In other words, the electronic device 101 may recognize the position of the external input device 103 in a space (or midair) between the electronic device 101 and the user as a position (or input) to which an input to a 3D image (or, 3D media content, a 3D effect image) by the external input device 103 is to be applied. Accordingly, the present disclosure may improve the user's usability of the electronic device 101 that displays (or, provides) a 3D image (or, 3D media content, a 3D effect image) by reducing a sense of difference between the user's intention and the input recognized by the electronic device 101.

FIG. 2 is a block diagram illustrating an example configuration of an electronic device and an external input device according to various embodiments.

FIG. 2 is a block diagram illustrating various components included in an electronic device 101 and a components included in an external input device 103 connected to the electronic device 101. The block of the electronic device 101 in FIG. 2 may be a schematic view of the electronic device 101 of FIGS. 1A and 1B. The block diagram of the external input device 103 of FIG. 2 may be a schematic view of the external input device 103 of FIGS. 1A and 1B.

Referring to FIG. 2, the electronic device 101 may be connected to an external input device 103 via communication circuitry 240, based on a wireless network (or communication technique). For example, the wireless network may include a network such as long term evolution (LTE), 5g new radio (NR), wireless fidelity (Wi-Fi), Zigbee, near field communication (NFC), Bluetooth, Bluetooth low energy (BLE), or a combination thereof. In the example of FIG. 2, the electronic device 101 (e.g., tablet PC) and the external input device 103 (e.g., stylus pen) may be connected using the Bluetooth or BLE communication technique.

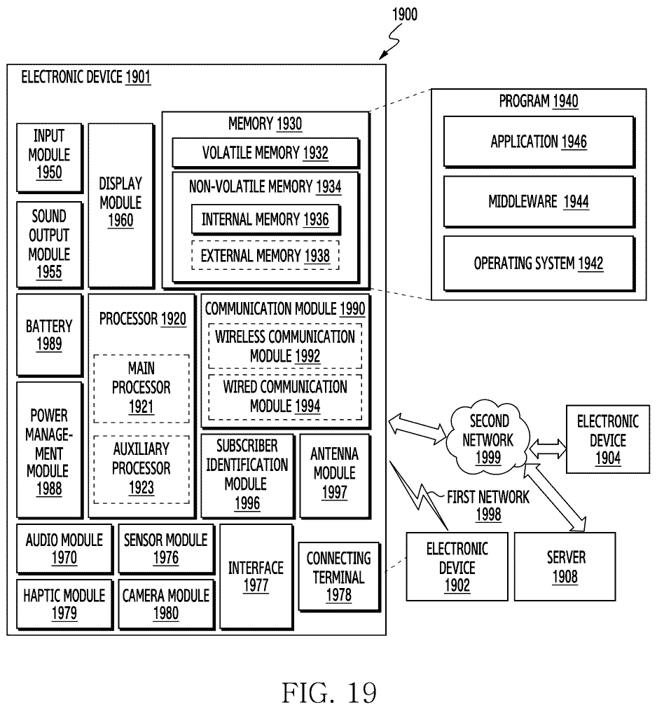

For example, the electronic device 101 may include at least one processor (e.g., including processing circuitry) 210, at least one camera 220, at least one sensor 230, communication circuitry 240, a display 110, and memory 250. For example, the at least one processor 210, the at least one camera 220, the at least one sensor 230, the communication circuitry 240, the display 110, and the memory 250 may be electronically and/or operably coupled with each other by a communication bus. In the following, hardware components being operably coupled may refer, for example, to a direct or indirect connection between hardware components being established by wire or wirelessly so that a second hardware component among the hardware components is controlled by a first hardware component. Although illustrated based on different blocks, the disclosure is not limited thereto, and some (e.g., at least a portion of the at least one processor 210, the communication circuitry 240, or the memory 250) of the hardware components illustrated in FIG. 2 may be included in a single integrated circuit such as a system on a chip (SoC) or a system in package (SIP). The type and/or number of the hardware components included in the electronic device 101 is not limited to those illustrated in FIG. 2. For example, the electronic device 101 may include only some of the hardware components illustrated in FIG. 2. The electronic device 101 may be an example of the electronic device 1901 of FIG. 19. For example, the electronic device 101 may include at least a portion of the electronic device 1901 of FIG. 19.

For example, the electronic device 101 may be implemented in various form factors. For example, the electronic device 101 may include not only an electronic device including the display of a bar-type, but also an electronic device including the display that is a flexible display. For example, the flexible display may include an electronic device including a foldable display, an electronic device including a multi-foldable display, or an electronic device including a rollable display. In addition, for example, the electronic device 101 may include a tablet PC. In addition, for example, the electronic device 101 may be implemented as a wearable device. For example, the wearable device may include a watch-shaped device. However, the present disclosure is not limited thereto.

For example, the at least one processor 210 of the electronic device 101 may include a hardware component for processing communication and/or data based on one or more instructions. For example, the hardware component for processing data may include arithmetic and logic unit (ALU), floating point unit (FPU), and field programmable gate array (FPGA). For example, the hardware component for processing data may include a central processing unit (CPU), a graphics processing unit (GPU), a digital signal processing (DSP), a microcontroller (MCU), and/or a neural processing unit (NPU). For example, the at least one processor 210 may have a structure of a multi-core processor such as a dual core, a quad core, or a hexa core. The content regarding the processor 1920 of FIG. 19 may be substantially applied to the at least one processor 210 of FIG. 2.

For example, the at least one processor 210 may include various processing circuits and/or multiple processors. For example, the term “processor” used in this disclosure, including the scope of claims, may include various processing circuitry including at least one processor, and one or more of the at least one processor may be configured to perform various functions described below individually and/or collectively in a distributed manner. As used below, when “processor”, “at least one processor”, and “one or more processors” are described as being configured to perform various functions, these terms are not limited thereto, and encompass situations in which one processor performs a portion of the cited functions and other processor(s) perform another portion of the cited functions and situations in which one processor performs all of the cited functions. Additionally, the at least one processor may include a combination of processors that perform various functions listed/disclosed in a distributed manner. The at least one processor may execute program instructions to achieve or perform various functions.

For example, the at least one camera 220 of the electronic device 101 may include one camera or a plurality of cameras. For example, the at least one camera 220 may be used to obtain an image of an actual environment. As a non-limiting example, the at least one camera 220 may be disposed in the electronic device 101 in a direction in which the display 110 of the electronic device 101 is disposed (or a direction in which the image displayed from the display 110 may be visible). In other words, the at least one camera 220 may obtain an image of a space above the display 110 (or a space in front of the display 110) in the direction in which the display 110 is disposed. For example, the space may be at least a portion of the actual environment. As a non-limiting example, the space may be a space corresponding to a field of view (FoV) of the at least one camera 220. For example, the at least one camera 220 may be an example of the camera module 1980 of FIG. 19. The at least one camera 220 may include at least a portion of the camera module 1980 of FIG. 19. As a non-limiting example, the at least one camera 220 of FIG. 2 may be referred to as an image sensor. In other words, the at least one camera 220 may be included in the at least one sensor 230.

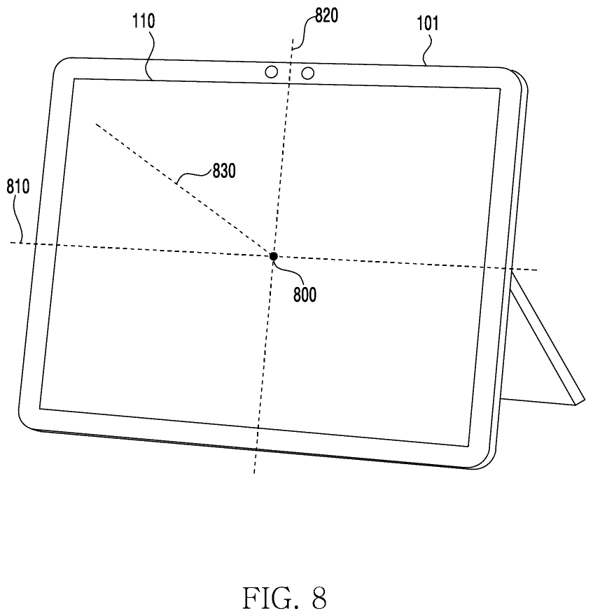

For example, the at least one sensor 230 of the electronic device 101 may include a motion sensor for sensing an orientation or posture (or movement) of the electronic device 101. For example, the motion sensor may include an accelerometer or a gyro sensor. The electronic device 101 may identify a posture of the electronic device 101 using sensing data obtained via the at least one sensor 230 and identify a reference position in accordance with the posture. Details related thereto may be referred to in FIG. 8 below. As a non-limiting example, the at least one sensor 230 may further include a time of flight (ToF) sensor, an infrared ray (IR) sensor, an optical sensor, a proximity sensor, a temperature sensor, or an atmospheric pressure sensor. For example, the ToF sensor, the IR sensor, or the optical sensor may be used to identify a position (or shape or direction) of the external input device 103 within the space.

According to an embodiment, the communication circuitry 240 of the electronic device 101 may be used to communicate with the external input device 103. As a non-limiting example, the communication circuitry 240 may include an antenna using Bluetooth or BLE communication techniques. For example, the electronic device 101 may be referred to as a source device, a master device, or a parent terminal for the external input device 103. For example, the at least one processor 210 may control an operation of the communication circuitry 240. As a non-limiting example, the at least one processor 210 may include a processor for controlling an operation or a function of the communication circuitry 240. The processor for controlling the operation or function of the communication circuitry 240 may be referred to as a communication processor or a BT processor.

For example, the display 110 (or the touch sensitive display 110) of the electronic device 101 may be used to display an image. For example, the display 110 may include a display panel including a display region displaying an image. For example, the display 110 of the electronic device 101 may include touch circuitry used to recognize a touch input by an external object on display 110 or the external input device 103. For example, the touch circuitry of the display 110 may include a touch sensor and a touch IC for controlling the touch sensor. Specific details related to the touch circuitry of the display 110 may be referred to in FIG. 3A below. For example, the display 110 may display a 3D image by displaying a plurality of images through different display regions (or pixels). The display 110 using different display regions to display a 3D image may be referred to as a lenticular display. Specific details related to the lenticular display may be referred to in FIG. 3B below.

According to an embodiment, the electronic device 101 may include memory 250. The memory 250 may include a hardware component for storing data and/or instruction inputted to and/or output from the at least one processor 210. For example, the memory 250 may include a volatile memory such as a random-access memory (RAM) and/or a non-volatile memory such as a read-only memory (ROM). For example, the volatile memory may include at least one of a dynamic RAM (DRAM), a static RAM (SRAM), a cache RAM, and a pseudo SRAM (PSRAM). For example, the non-volatile memory may include at least one of a programmable ROM (PROM), an erasable PROM (EPROM), an electrically erasable PROM (EEPROM), a flash memory, a hard disk, a compact disk, and an embedded multimedia card (eMMC). The details related to the memory 1930 of FIG. 19 may be substantially and identically applied to specific details related to the memory 250 of FIG. 2.

According to an embodiment, one or more instructions (or commands) indicating a calculation and/or an operation to be performed on data by the at least one processor 210 of the electronic device 101 may be stored in the memory 250 of the electronic device 101. A set of one or more instructions may be referred to as a program, a firmware, an operating system, a process, a routine, a sub-routine and/or an application. Hereinafter, an application being installed in an electronic device (e.g., the electronic device 101) may refer, for example, to one or more instructions provided in a form of an application are stored in the memory 250, and that the one or more applications are stored in a format executable by a processor of the electronic device (e.g., a file having an extension specified by an operating system of the electronic device 101). According to an embodiment, the electronic device 101 may execute one or more instructions stored in the memory 250 to perform an operation. For example, the one or more instructions, when executed by the at least one processor 210, may cause the electronic device 101 to perform at least a portion of operations of the electronic device 101.

Although not illustrated in FIG. 2, the electronic device 101 may include an output means for outputting information in a form other than a visualized form. As a non-limiting example, the electronic device 101 may further include an emitter that emits light of a specific color, a speaker that outputs sound information, and an actuator (or motor) for providing haptic feedback based on vibration. In addition, the electronic device 101 may include an input device (e.g., microphone) (or audio sensor) for obtaining (or receiving or detecting) sound information from the outside. For example, the audio sensor may include an accelerometer or piezoelectric sensor that detects sound based on vibration. For example, the audio sensor may be referred to as a voice pickup unit (VPU).

Referring to FIG. 2, the external input device 103 may include a printed circuit board 261, a pen tip 263, pen tip circuitry 265, a button 267, communication circuitry 269, at least one processor (e.g., including processing circuitry) 271, memory 273, a motion sensor 275, a battery 277, a pressure sensor 279, an actuator 281, a speaker 283, and an emitter 285. For example, the button 267, the communication circuitry 269, the at least one processor 271, the memory 273, the motion sensor 275, the battery 277, the pressure sensor 279, the actuator 281, the speaker 283, and the emitter 285 may be mounted (or equipped) on the PCB 261. In FIG. 2, the button 267, the communication circuitry 269, the at least one processor 271, the memory 273, the motion sensor 275, the battery 277, the pressure sensor 279, the actuator 281, the speaker 283, and the emitter 285 disposed on one PCB 261 are illustrated, but the present disclosure is not limited thereto. For example, the external input device 103 may include a plurality of PCBs or a component (e.g., socket) for mounting electronic components.

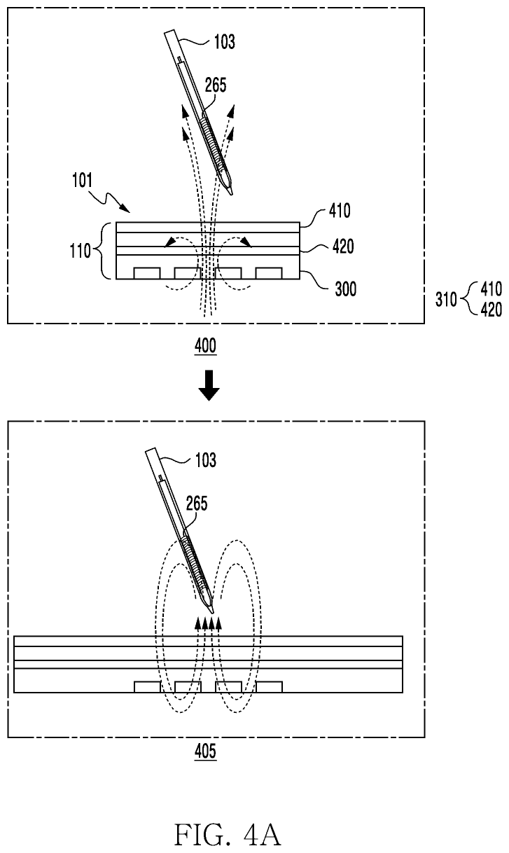

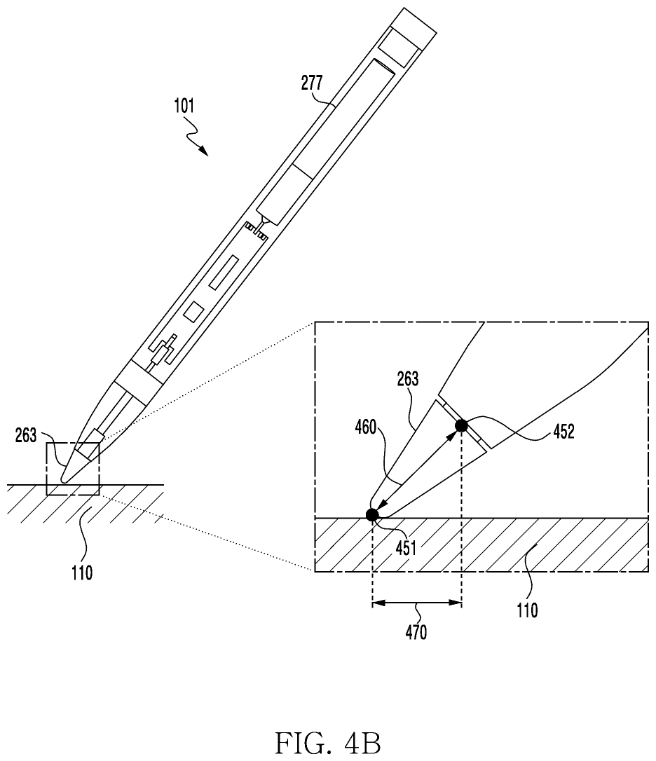

For example, the pen tip 263 of the external input device 103 may be fastened to a portion of the external input device 103. For example, the portion of the external input device 103 may include a fastening structure for connecting the pen tip 263. For example, the pen tip 263 may be connected (or electrically connected) to the pen tip circuitry 265 of the external input device 103. For example, the pen tip circuitry 265 may include circuitry forming a magnetic field (or an electric field or an electromagnetic field). For example, the pen tip circuitry 265 may include a coil (or an inductor or a solenoid). For example, the pen tip circuitry 265 may include resonance circuitry for forming a magnetic field through the coil. For example, the resonance circuitry may include at least one capacitor or a switch. According to an operation of the resonance circuitry, a resonance frequency of a signal forming the magnetic field may be changed. For example, the resonance circuitry may resonate based on energy transmitted (or provided) from a magnetic field caused by touch circuitry included in the display 110 of the electronic device 101. The change in the resonance frequency may be used to recognize a touch input of the external input device 103 with respect to the electronic device 101 or an input of the external input device 103 with respect to the button 267. A touch input method of the external input device 103 with respect to the electronic device 101 using the pen tip circuit 265 may be referred to as an electro-magnetic resonance (EMR) method (or an EMR passive method). Specific details related to the EMR method may be referred to in FIG. 4A below. In FIG. 2, an example of the external input device 103 including the pen tip circuitry 265 is illustrated, but the present disclosure is not limited thereto. For example, the external input device 103 may include the pen tip circuitry 265 including electrodes other than the resonance circuitry. For example, the pen tip circuitry 265 including electrodes may be used to directly transmit a signal (or an electrical signal). For example, the touch input method of the external input device 103 with respect to for electronic device 101 using the pen tip circuitry 265 including electrodes may be referred to as an active electrostatic solution (or AES) method (or an AES active method). Details related to the AES method may be referred to in FIG. 4B below. In the above example, the EMR method or the AES method is illustrated as a touch input method of the external input device 103 with respect to the electronic device 101, but the present disclosure is not limited thereto. For example, the electronic device 101 may recognize a touch input by the external input device 103, by identifying a change in capacitance by the external input device 103 using an electric field via the display 110. For example, the touch input method of the external input device 103 with respect to the electronic device 101 using the change in capacitance may be referred to as an electrically coupled resistance (ECR) method. In this case, the display 110 may be referred to as a touch screen panel (TSP).

For example, the button 267 of the external input device 103 may include a physical button for performing a preset function (or gesture) with respect to the external input device 103. As a non-limiting example, capacitance inside the pen tip circuitry 265 may be changed by an input (or press input) to the button 267. As the external input device 103 identifies a change in the capacitance inside the pen tip circuitry 265, the external input device 103 may recognize an input to the button 267. For example, the button 267 may be referred to as a physical button, an input button, or an input device.

For example, the communication circuitry 269 of the external input device 103 may be used to communicate with the electronic device 101. As a non-limiting example, the communication circuitry 269 may include an antenna using Bluetooth or BLE communication techniques. For example, the at least one processor 271 may control an operation of the communication circuitry 269. As a non-limiting example, the at least one processor 271 may include a processor for controlling an operation or a function of the communication circuitry 269. The processor for controlling the operation or function of the communication circuitry 269 may be referred to as a communication processor or a BT processor.

For example, the at least one processor 271 of the external input device 103 may include a hardware component for processing communication and/or data based on one or more instructions. For example, the hardware component for processing data may include arithmetic and logic unit (ALU), floating point unit (FPU), and field programmable gate array (FPGA). For example, the hardware component for processing data may include a central processing unit (CPU), a graphics processing unit (GPU), a digital signal processing (DSP), a microcontroller (MCU), and/or a neural processing unit (NPU). For example, the at least one processor 271 may have a structure of a multi-core processor such as a dual core, a quad core, or a hexa core.

For example, the at least one processor 271 may include various processing circuits and/or multiple processors. For example, the term “processor” used in this disclosure, including the scope of claims, may include various processing circuitry including at least one processor, and one or more of the at least one processor may be configured to perform various functions described below individually and/or collectively in a distributed manner. As used below, when “processor”, “at least one processor”, and “one or more processors” are described as being configured to perform various functions, these terms are not limited thereto, and encompass situations in which one processor performs a portion of the cited functions and other processor(s) perform another portion of the cited functions and situations in which one processor performs all of the cited functions. Additionally, the at least one processor may include a combination of processors that perform various functions listed/disclosed in a distributed manner. The at least one processor may execute program instructions to achieve or perform various functions.

According to an embodiment, the external input device 103 may include the memory 273. The memory 273 may include a hardware component for storing data and/or instruction inputted to and/or output from the at least one processor 271. For example, the memory 273 may include a volatile memory such as a random-access memory (RAM) and/or a non-volatile memory such as a read-only memory (ROM). For example, the volatile memory may include at least one of a dynamic RAM (DRAM), a static RAM (SRAM), a cache RAM, and a pseudo SRAM (PSRAM). For example, the non-volatile memory may include at least one of a programmable ROM (PROM), an erasable PROM (EPROM), an electrically erasable PROM (EEPROM), a flash memory, a hard disk, a compact disk, and an embedded multimedia card (eMMC).

For example, the motion sensor 275 of the external input device 103 may include a motion sensor for sensing an orientation or posture (or movement) of the external input device 103. For example, the motion sensor 275 may include an accelerometer or a gyro sensor. The external input device 103 may identify a posture of the external input device 103 using sensing data obtained via the motion sensor 275. For example, the motion sensor 275 may be referred to as a 6-axis sensor.

For example, the external input device 103 may include the battery 277. As a non-limiting example, the external input device 103 may include a power management integrated circuit (PMIC) controlling an operation of the battery 277 and at least one charging port. For example, the PMIC may be a processor for managing power of the battery 277 of the external input device 103. For example, the PMIC may provide power stored in the battery to hardware components of the external input device 103. In addition, for example, the PMIC may store power provided through the at least one charging port within the battery 277.

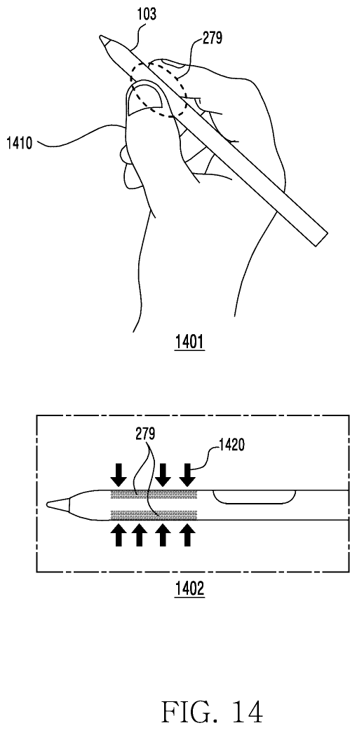

For example, the external input device 103 may include the pressure sensor 279. For example, the pressure sensor 279 may be used to detect a pressure by an external object (e.g., user's hand) gripping the external input device 103. For example, the external input device 103 may obtain and process data (or sensing data) on the pressure using the pressure sensor 279. As a non-limiting example, the external input device 103 may transmit data on the pressure to the electronic device 101. For example, the electronic device 101 may adjust a change in accordance with an input by the external input device 103, using the data on the pressure. For example, the pressure may be referred to as a pen pressure. Specific details related thereto may be referred to in FIG. 14 below.

In the example of FIG. 2, the motion sensor 275 and the pressure sensor 279 of the external input device 103 may be referred to as at least one sensor. For example, the at least one sensor included in the external input device 103 may further include sensors other than the motion sensor 275 and the pressure sensor 279. For example, the at least one sensor included in the external input device 103 may include an infrared ray (IR) sensor (or an optical sensor).

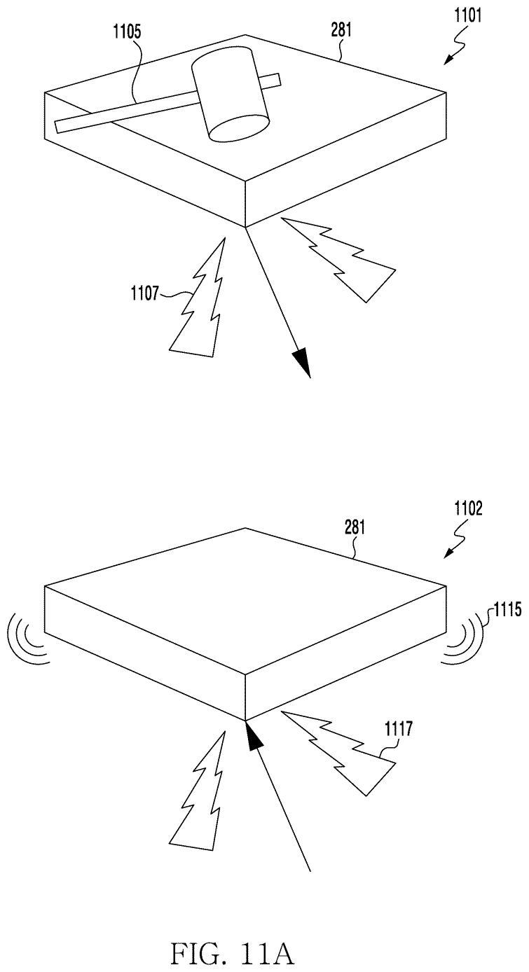

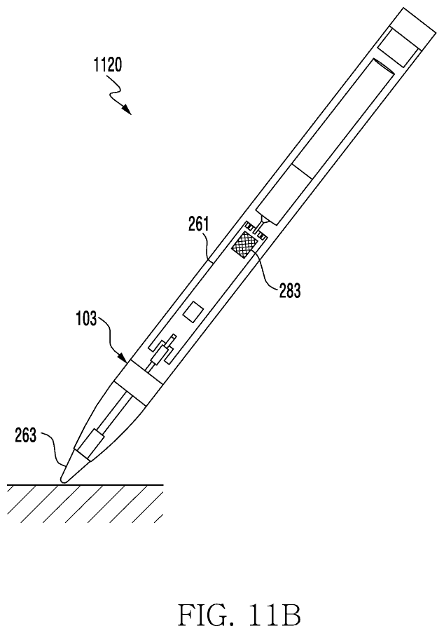

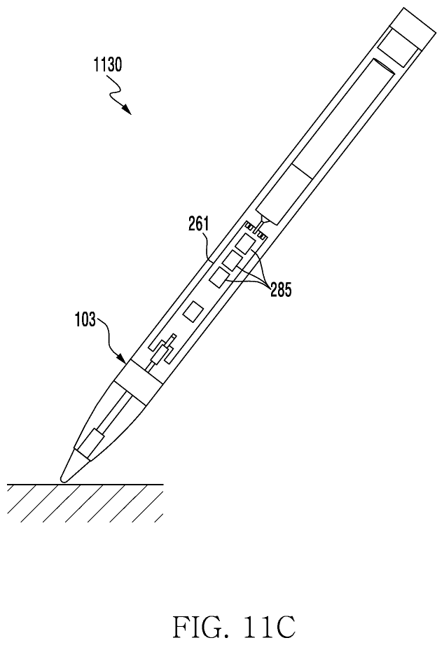

For example, the external input device 103 may include various components for providing feedback. For example, the external input device 103 may provide the feedback based on a signal received from the electronic device 101. For example, the feedback may be referred to as an output. For example, the external input device 103 may include tactile feedback, auditory feedback, or visual feedback. For example, in order to provide the tactile feedback, the external input device 103 may include the actuator 281. The actuator 281 may be an output device for providing vibration-based feedback. The actuator 281 may be referred to as a motor. Specific details related to the feedback provided using the actuator 281 may be referred to in FIG. 11. For example, in order to provide the auditory feedback, the external input device 103 may include the speaker 283. The speaker 283 may be an output device for providing sound-based feedback. Details related to the feedback provided using the speaker 283 may be referred to in FIG. 11B. For example, in order to provide the visual feedback, the external input device 103 may include the emitter 285. The emitter 285 may be an output device for providing feedback based on a color of the emitted light. Details related to the feedback provided using the emitter 285 may be referred to in FIG. 11C. In FIG. 2, the external input device 103 including the actuator 281, the speaker 283, and the emitter 285 is illustrated, but the present disclosure is not limited thereto. For example, the external input device 103 may include at least one of the actuator 281, the speaker 283, or the emitter 285. In addition, for example, the external input device 103 may provide feedback using a component other than the actuator 281, the speaker 283, and the emitter 285. For example, the external input device 103 may provide tactile feedback using an electronic component capable of providing electrical friction. For example, the electrical friction may also be referred to as static electricity. In addition, for example, the external input device 103 may provide tactile feedback (e.g., temperature change) using an electronic component capable of adjusting temperature. The external input device 103 may, for example, provide olfactory feedback using an electronic component capable of emitting a specific scent.

The examples of the components in the external input device 103 illustrated in FIG. 2 are merely examples illustrated for convenience of description, and the present disclosure is not limited thereto. In an example, the external input device 103 may not include the battery 277. The external input device 103 not including the battery 277 may not include the communication circuitry 269, the at least one processor 271, the memory 273, the motion sensor 275, the pressure sensor 279, the actuator 281, the speaker 283, and the emitter 285.

In addition, in an example, the external input device 103 may selectively drive (or turn on) at least one of the button 267, the communication circuitry 269, the at least one processor 271, the memory 273, the motion sensor 275, the battery 277, the pressure sensor 279, the actuator 281, the speaker 283, and the emitter 285. For example, the driving may include providing power. As a non-limiting example, the external input device 103 may drive all of the button 267, the communication circuitry 269, the at least one processor 271, the memory 273, the motion sensor 275, the battery 277, the pressure sensor 279, the actuator 281, the speaker 283, and the emitter 285 As a non-limiting example, the external input device 103 may always drive the button 267, the communication circuitry 269, the at least one processor 271, the memory 273, the battery 277, and the pressure sensor 279, and selectively drive the motion sensor 275, the actuator 281, the speaker 283, and the emitter 285. As a non-limiting example, the external input device 103 may always drive the button 267, the at least one processor 271, the memory 273, and the battery 277 and selectively drive the communication circuitry 269, the motion sensor 275, the actuator 281, the speaker 283, the emitter 285, and the pressure sensor 279. As a non-limiting example, the external input device 103 may always drive the button 267 and the battery 277 and selectively drive the communication circuitry 269, the at least one processor 271, the memory 273, the motion sensor 275, the actuator 281, the speaker 283, the emitter 285, and the pressure sensor 279.

Referring to the above description, the external input device 103 may reduce power consumption by selectively driving some components. In an example, the external input device 103 always drives a sensor for detecting that a user's body part (e.g., hand) is in contact with the external input device 103 and circuitry for driving the sensor, and may drive (or selectively drive) remaining components as detecting the contact. For example, the external input device 103 may drive remaining components according to identifying an input to the button 267 while only driving the button 267 and the battery 277.

FIG. 3A is an exploded perspective view illustrating an example electronic device including touch circuitry for identifying an external input device according to various embodiments.

Referring to FIG. 3A, an example of touch circuitry 300 of an electronic device 101 used to identify a position of an external input device 103 is illustrated. The electronic device 101 of FIG. 3A may be an example of the electronic device 101 of FIG. 2. The external input device 103 of FIG. 3A may be an example of the external input device 103 of FIG. 2. For example, the electronic device 101 may include a display 110 (or touch sensitive display 110) including the touch circuitry 300 and a display panel 310. For example, the touch circuitry 300 may be referred to as a digitizer.

For example, the display 110 may include a display panel 310 to which the external input device 103 is contacted. For example, the display panel 310 may include a display region (or light emitting elements) on which an image is displayed. For example, the display panel 310 may include a glass to protect (or cover) light emitting elements on which an image is displayed. For example, the glass may be a portion of the display 110 (or the display panel 310) to which the external input device 103 is contacted. However, the present disclosure is not limited thereto. For example, the glass may be a separate component that is not a portion of the display 110 (or the display panel 310).

For example, the display 110 may include the touch circuitry 300 disposed under the display panel 310. For example, the touch circuitry 300 may generate a magnetic field by generating a current (or alternating current). For example, the electronic device 101 may identify a position of the external input device 103 and recognize a touch input by the external input device 103, by detecting a change in the magnetic field (or change in capacitance according to the change in the magnetic field).

FIG. 3B is a diagram illustrating an example of a display panel for displaying a 3D image according to various embodiments.

FIG. 3B illustrates examples 311 and 312 of a method of displaying a 3D image on the display panel 310 of the electronic device 101. The electronic device 101 of FIG. 3B may be an example of the electronic device 101 of FIG. 2. For example, the display panel 310 may be included in the electronic device 101 (or the display 110 of the electronic device 101). For example, the display panel 310 may be referred to as a lenticular display.

In FIG. 3B, the display panel 310 may include a pixel layer 320 and a lenticular layer 330. For example, the pixel layer 320 may include a plurality of pixels 321 and 322. For example, the lenticular layer 330 may include a plurality of lenticular lenses 331 and 332. For example, a first lenticular lens 331 may correspond to a first pixel 321-1 and a second pixel 321-2. For example, a second lenticular lens 332 may correspond to a third pixel 322-1 and a fourth pixel 322-2. The lenticular lens corresponding to the pixels may indicate that the lenticular lens is disposed on a path (or emission path) of light emitted from the pixels.

Referring to the example 311 of FIG. 3B, the display panel 310 may display one image via the pixels 321 and 322. For example, the display panel 310 may display one image to a user 390 by emitting light 350 for one image through each of all pixels 321 and 322 of the pixel layer 320. In this case, the light 350 emitted to the user 390 may be respectively provided to both eyes 391 and 392 of the user 390. In other words, the light 350 emitted through the first pixel 321-1 may be diffused (or refracted) to be provided to both eyes 391 and 392 of the user 390, and the light 350 emitted through the second pixel 321-2 may be diffused to be provided to both eyes 391 and 392 of the user 390. In the example 311, since the light 350 emitted from each of the pixels 321 and 322 is provided equally to both eyes 391 and 392 of the user 390, the user 390 may recognize one image displayed on the display panel 310. In this case, one image recognized by the user 390 may be a 2D image.

Referring to the example 312 of FIG. 3B, the display panel 310 may display a plurality of images through the pixels 321 and 322. For example, the display panel 310 may display a first image to the user 390, by emitting light 351 for the first image through a first set of pixels of the pixel layer 320. Furthermore, the display panel 310 may display a second image to the user 390, by emitting light 352 for the second image through a second set of pixels of the pixel layer 320. For example, the first set of pixels may include the first pixel 321-1 and the third pixel 322-1. For example, the second set of pixels may include the second pixel 321-2 and the fourth pixel 322-2. For example, the first set of pixels may be referred to as first display regions of the display 110, and the second set of pixels may be referred to as second display regions of the display 110. As a non-limiting example, the first set of pixels and the second set of pixels may alternate with each other. For example, the second pixel 321-2 may be disposed next to the first pixel 321-1, the third pixel 322-1 may be disposed next to the second pixel 321-2, and the fourth pixel 322-2 may be disposed next to the third pixel 322-1. The light 351 emitted to the user 390 may be provided to a left eye 391 among the eyes 391 and 392 of the user 390, and the light 352 emitted to the user 390 may be provided to a right eye 392 among the eyes 391 and 392 of the user 390. In other words, the light 351 emitted through each of the first pixel 321-1 and the third pixel 322-1 may be concentrated (or refracted) to be provided to the left eye 391 of the user 390, and the light 352 emitted through each of the second pixel 321-2 and the fourth pixel 322-2 may be concentrated to be provided to the right eye 392 of the user 390. In the example 312, since the lights 351 and 352 emitted from each of the pixels 321 and 322 are individually provided to each of the two eyes 391 and 392 of the user 390, the user 390 may recognize two images (e.g., the first image and the second image) displayed on the display panel 310. Accordingly, the user 390 may recognize a 3D image in accordance with disparity between a plurality of images.

Referring to the above description, the electronic device 101 may identify gaze information of the eyes 391 and 392 of the user 390, using at least one camera 220 or at least one sensor 230. For example, the gaze information may include a position of the eyes 391 and 392 or a gaze direction in which the eyes 391 and 392 are directed. For example, based on the gaze information, the electronic device 101 may provide the light 351 to the left eye 391 and the light 352 to the right eye 392.

In the above example, diffusion and concentration of light may be caused by the lenticular lenses 331 and 332 of the lenticular layer 330. In an example, the electronic device 101 may perform diffusion (or refraction) and/or concentration (or refraction) of light by controlling the lenticular lenses 331 and 332 of the lenticular layer 330. In an example, the electronic device 101 may perform diffusion and/or concentration of light by adjusting a voltage applied to the lenticular lenses 331 and 332. In the example of FIG. 3B, the display panel 310 that provides a 2D image (or 2D media content, a 2D effect image) and a 3D image (or 3D media content, a 3D effect image) to one user 390 is illustrated, but the present disclosure is not limited thereto. For example, a 2D image and a 3D image may be provided to users in different positions. In an example, in order to provide a 3D image to a plurality of users, the display panel 310 may include a lenticular layer 330 including a plurality of layers rather than a lenticular layer 330 including one layer. Accordingly, by refracting light to each of the users in different positions through a plurality of layers (or stacked layers), a 3D image may be provided to each of the plurality of users via one display panel 310.

FIGS. 4A and 4B are diagrams illustrating examples of a driving method for recognizing a touch input by an external input device according to various embodiments.

FIG. 4A illustrates examples 400 and 405 of an EMR method for recognizing a touch input by an external input device 103. FIG. 4B illustrates an example of an AES method for recognizing a touch input by an external input device 103. The electronic device 101 of FIG. 4A may be an example of the electronic device 101 of FIG. 2. The external input device 103 of FIG. 4A may be an example of the external input device 103 of FIG. 2. The external input device 103 of FIG. 4B may be an example of the external input device 103 of FIG. 2.

Referring to the example 400 of FIG. 4A, the electronic device 101 may generate a magnetic field through the touch circuitry 300 of the display 110. For example, the electronic device 101 may generate a magnetic field through the touch circuitry 300 by providing a current to the touch circuit 300. For example, the touch circuitry 300 may be disposed under the display panel 310 of the display 110. For example, the display panel 310 may include a glass 410 and a layer 420 disposed under the glass 410. For example, the layer 420 may include the pixel layer 320 and the lenticular layer 330 of FIG. 3B. As a non-limiting example, providing a current to the touch circuitry 300 may be performed periodically. The magnetic field generated by the touch circuitry 300 may affect pen tip circuitry 265 (or a coil of the pen tip circuitry 265) of the external input device 103. The pen tip circuitry 265 may be induced by a magnetic field generated by the touch circuitry 300.

Referring to the example 405, the pen tip circuitry 265 may generate a magnetic field with a specified resonant frequency, as it is induced (or current is induced) by a magnetic field generated by the touch circuitry 300. For example, the electronic device 101 may recognize a touch input by the external input device 103, by identifying (or receiving) a magnetic field with the specified resonant frequency generated from the pen tip circuitry 265 through the touch circuitry 300. For example, identifying the magnetic field may include identifying a change in the magnetic field. In other words, the external input device 103 may operate as a transmitter, and the electronic device 101 (or the touch circuitry 300) may operate as a receiver.

In example 405 of FIG. 4A, a case of a hovering input, which is a touch input in which the external input device 103 is not in contact with the display 110 of the electronic device 101, is illustrated, but the present disclosure is not limited thereto. For example, even in a case of an input including contact points, which is a touch input in which the external input device 103 is in contact with the display 110 of the electronic device 101, it may be understood substantially the same.

For example, in a case that the external input device 103 is in contact with the display 110 of the electronic device 101, the electronic device 101 may identify a pressure of the touch input by the external input device 103. For example, when the external input device 103 is in contact with the display 110, the pen tip 263 of the external input device 103 may be pressed. As the pen tip 263 is pressed, a connection state of the pen tip circuitry 265 in the external input device 103 may be changed. For example, capacitance of a variable capacitor in the pen tip circuitry 265 may be changed. As the capacitance of the variable capacitor in the pen tip circuitry 265 is changed, a resonant frequency of resonant circuitry of the pen tip circuitry 265 may be changed. As a non-limiting example, as the pen tip 263 is pressed, the capacitance of the variable capacitor may increase, and accordingly, the resonant frequency may be reduced. In this case, the electronic device 101 (or the touch circuitry 300) may identify a pressure of the touch input by the external input device 103 according to receiving a magnetic field having the reduced resonance frequency.

As described above, in the EMR method, in a case that the electronic device 101 recognizes a touch input (e.g., a hovering input or an input including contact points) of the external input device 103 using the touch circuitry 300, the external input device 103 may not include the battery 277. In other words, even when the external input device 103 does not include the battery 277, the touch circuitry 300 may receive a magnetic field generated (or transmitted) from the pen tip circuitry 265 (or a coil in the pen tip circuitry 265) of the external input device 103 induced by a magnetic field generated (or transmitted) from the touch circuitry 300. However, the present disclosure is not limited thereto. For example, even in a case of the EMR method, the external input device 103 may include the battery 277. The external input device 103 may include the battery 277, obtain data (or motion information) indicating a movement of the external input device 103 via the motion sensor 275 using power provided from the battery 277, and transmit the obtained data (or the motion information) to the electronic device 101 via the communication circuitry 269. For example, the electronic device 101 may identify the movement (or gesture) of the external input device 103, based on the motion information. For example, the electronic device 101 may provide a function of the electronic device 101 in accordance with the movement (or gesture).

Referring to FIG. 4B, the electronic device 101 may receive a signal transmitted from the external input device 103 via the touch circuitry 300 of the display 110. For example, the external input device 103 may transmit a signal using electrodes 451 and 452 included in the pen tip circuitry 265. For example, the electrodes 451 and 452 may include a first electrode 451 positioned at a distal end of the pen tip 263 and a second electrode 452 positioned at another distal end of the pen tip 263. For example, the external input device 103 may transmit a signal via each of the electrodes 451 and 452 controlled based on the at least one processor 271. For example, the touch circuitry 300 may receive a signal transmitted from each of the electrodes 451 and 452 of the external input device 103. Receiving the signal via the touch circuitry 300 may be referred to as scanning via the touch circuitry 300. For example, the electronic device 101 may identify a position of the first electrode 451 and an orthographic projection position of the second electrode 452 on the display 110 using signals received via the touch circuitry 300. In this case, the orthographic projection position of the second electrode 452 may indicate a position orthographically projected onto the display 110 from the second electrode 452. For example, the electronic device 101 may identify a slope of the external input device 103 using a distance 460 between the electrodes 451 and 452 and a distance 470 between positions identified with respect to the electrodes 451 and 452. For example, the electronic device 101 may recognize a pressure of a touch input by the external input device 103, using the slope of the external input device 103. In the above example, an example of a method in which the electronic device 101 recognizes the pressure by directly identifying the slope of the external input device 103 is described, but the present disclosure is not limited thereto. For example, the electronic device 101 may receive information regarding the slope of the external input device 103 transmitted via the communication circuitry 269 from the external input device 103, and recognize the pressure using the received information.

As described above, in the AES method, in a case that the electronic device 101 recognizes a touch input (e.g., a hovering input or an input including contact points) of the external input device 103 using the touch circuitry 300, the external input device 103 may include the battery 277. The battery 277 may be included in the external input device 103 in order for the external input device 103 to transmit a signal via the electrodes 451 and 452.

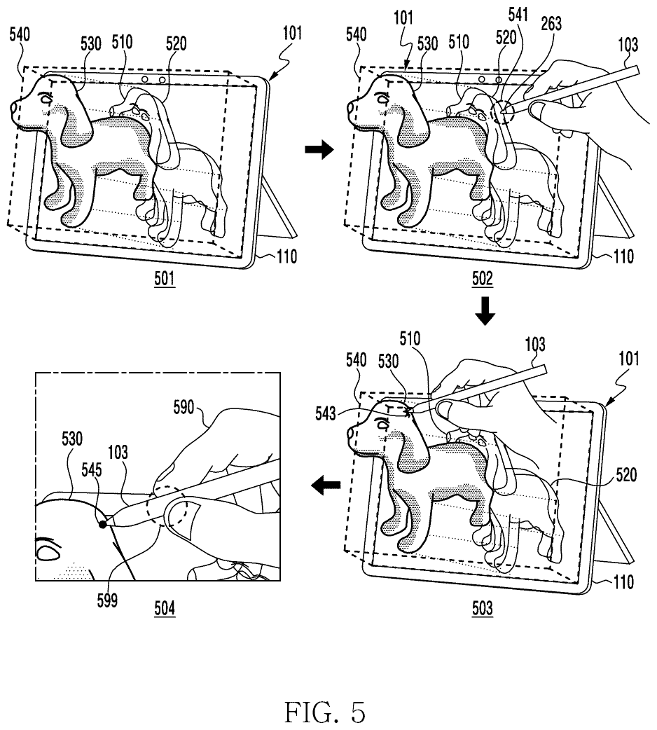

FIGS. 4A and 4B describe example driving methods for the electronic device 101 to recognize a touch input by an external input device 103 that is adjacent to or in contact with the display 110 (or the touch circuitry 300). However, in a case that electronic device 101 displays a 3D image, the electronic device 101 may not recognize an input of the external input device 103 with respect to a 3D image, which is performed at a distance out of a recognizable distance by the touch circuitry 300, even when the touch circuitry 300 is used. A method for recognizing an input by the external input device 103 in a space in which a 3D image is perceived as being positioned may be described in greater detail below with reference to FIG. 5.

FIG. 5 is a diagram illustrating examples of a method in which an electronic device recognizes an input with respect to a 3D image displayed via a display according to various embodiments.

FIG. 5 illustrates examples 501, 502, 503, and 504 of a method in which the electronic device 101 recognizes an input (or user input) of the external input device 103 with respect to a 3D image while displaying the 3D image via the display 110. The electronic device 101 of FIG. 5 may be an example of the electronic device 101 of FIG. 2. The external input device 103 of FIG. 5 may be an example of the external input device 103 of FIG. 2.

Referring to the example 501, the electronic device 101 may display (or provide) a 3D image 530 via the display 110. In order to display (or provide) the 3D image 530, the electronic device 101 may simultaneously display a first image 510 and a second image 520 via the display 110. The first image 510 may include a visual object (e.g., puppy), and the second image 510 may include the visual object included in the first image 510. For example, the first image 510 may be displayed via first display regions (e.g., the first pixel 321-1 and the third pixel 322-1 included in the first set of pixels of FIG. 3B) of the display 110. For example, the second image 520 may be displayed via second display regions (e.g., the second pixel 321-2 and the fourth pixel 322-2 included in the second set of pixels of FIG. 3B) of the display 110. For example, the first display regions and the second display regions may alternate with each other. As the first image 510 and the second image 520 are simultaneously displayed, the 3D image 530 (or the visual object (e.g., puppy) of the 3D image 530) may be perceived as being positioned within a space 540. The first image 510 and the second image 520 may be separated from each other. For example, the space 540 may be referred to as an actual environment above the display 110. As a non-limiting example, a range (or size) of the space 540 may be determined in accordance with a FoV of at least one camera 220 of the electronic device 101. In FIG. 5, for convenience of description, a shape of the space 540 is illustrated in a hexahedron, but the present disclosure is not limited thereto.

As a non-limiting example, the electronic device 101 may simultaneously display the first image 510 and the second image 520 to display the 3D image 530 while the electronic device 101 (or the display 110) is within a 3D display mode. For example, the electronic device 101 may simultaneously display the first image 510 and the second image 520, based on the execution of the 3D display mode of the electronic device 101. Although not illustrated in FIG. 5, the electronic device 101 may display, via the display 110, a 2D image (or 2D media content, a 2D effect image), before the execution of the 3D display mode (or while the 2D display mode (or normal display mode) of the electronic device 101 is executed). For example, the electronic device 101 may display one image including the visual object via a display region of the display 110. For example, the display region of the display 110 may include at least a portion of the first display region and the second display region. For example, one image including the visual object may be perceived as the visual object being positioned within (or on) the display region of the display 110.

Referring to the example 502, the electronic device 101 may identify a position 541 of a specified portion of the external input device 103 while simultaneously displaying the first image 510 and the second image 520. As a non-limiting example, the position 541 of the specified portion of the external input device 103 may be a position of the pen tip 263 of the external input device 103. In other words, the specified portion may indicate the pen tip 263. For example, the electronic device 101 may identify the position 541 of the external input device 103 in the space 540 using the at least one camera 220. Although it is illustrated that the electronic device 101 identifies the position 541 of the external input device 103, the present disclosure is not limited thereto. For example, the electronic device 101 may identify not only the position of the external input device 103 but also a shape or a direction of the external input device 103.

Although not illustrated in FIG. 5, the electronic device 101 may define coordinates corresponding to positions in the space 540, and may define a coordinate corresponding to the position 541 of the external input device 103. For example, the coordinates corresponding to positions in the space 540 may be defined in accordance with a reference position. For example, the reference position may be changed in accordance with a position relationship between the electronic device 101 and an eye of a user in front of the electronic device 101. For example, the position relationship above may include a distance between the electronic device 101 and the eye of the user and a direction of the eye of the user with respect to the electronic device 101. For example, the distance between the electronic device 101 and the eye of the user may be referred to as a position of the eye of the user. For example, the direction of the eye of the user with respect to the electronic device 101 may be referred to as an angle between a virtual line defined with respect to the electronic device 101 (or the at least one camera 220) and another virtual line between the electronic device 101 and the eye of the user. The direction of the eye of the user with respect to the electronic device 101 may be changed in accordance with a posture of the electronic device 101. Details related to a method of identifying the reference position may be referred to in FIG. 8 below.

For example, a position within the space 540 where the 3D image 530 is perceived to be provided may be changed in accordance with the position relationship between the electronic device 101 and the eye of the user. For example, the electronic device 101 may display the first image 510 and the second image 520 to provide the 3D image 530 so that it is perceived as being positioned at a specified distance from the eye of the user in the space 540 in accordance with the position relationship. As a non-limiting example, the specified distance may be fixed. As a non-limiting example, the specified distance may be changed in accordance with a setting in the electronic device 101.

Referring to the example 503, the electronic device 101 may determine whether a position 543 of the external input device 103 is positioned within a reference range. For example, the position 543 of the external input device 103 may be a position changed from the position 541 in accordance with a movement of the external input device 103. For example, the reference range may be referred to as a spatial range within the space 540. As a non-limiting example, the reference range may extend from recognition positions of the 3D image 530 within the space 540. As a non-limiting example, the reference range may be the recognition positions of the 3D image 530 within the space 540. For example, the recognition positions of the 3D image 530 may indicate positions of the 3D image 530 (or the visual object included in the 3D image 530) to be perceived as being positioned within the space 540 when the first image 510 and the second image 520 are displayed. For example, the electronic device 101 may set the reference range (or the spatial range) based on the position relationship between the electronic device 101 and the eye of the user.

As a non-limiting example, whether the position 543 of the external input device 103 is positioned within the reference range may indicate identifying whether the external input device 103 (or a specified portion (e.g., the pen tip 263) of the external input device 103) is moved into the reference range. For example, the electronic device 101 may identify whether the specified portion of the external input device 103 is moved into the reference range (or the spatial range), based on the position 543 of the external input device 103.

For example, when the position 543 is within the reference range extended from the recognition positions of the 3D image 530, the electronic device 101 may transmit, to the external input device 103 via the communication circuitry 240, a signal for allowing to execute a function of the external input device 103. As a non-limiting example, the signal may allow to provide feedback as a function of the external input device 103. For example, the feedback may include at least one of tactile feedback, auditory feedback, or visual feedback. Details related to the feedback may be referred to in FIGS. 11A, 11B and 11C.

When the position 543 is out of the reference range extended from the recognition positions of the 3D image 530, the electronic device 101 may refrain from transmitting the signal allowing to execute a function of the external input device 103 to the external input device 103 via the communication circuitry 240. For example, the electronic device 101 may periodically identify a position (e.g., the position 543) of the external input device 103 and may not transmit the signal.

In example 504, the electronic device 101 may obtain data indicating a movement (or position 545, or gesture) of the external input device 103 while the position 545 of the external input device 103 is within the reference range. For example, the electronic device 101 may identify an input with respect to the 3D image 530 (or the visual object, 3D media content, 3D effect image included in the 3D image 530), using data indicating the movement of the external input device 103. For example, the electronic device 101 may identify the position 545 of the external input device 103 (or specified portion (e.g., the pen tip 263) of the external input device 103) as a user input with respect to the 3D image 530.

As a non-limiting example, the electronic device 101 may display an indicator (or pointer) indicating (or representing) the position 545 of the external input device 103 within the 3D image 530, while the position 545 of the external input device 103 is within the reference range. For example, the electronic device 101 may display the indicator within the 3D image 530, by displaying the first image 510 and the second image 520 changed to represent the indicator via the display 110. For example, the indicator may be used to indicate to a user performing an input with respect to the 3D image 530, which is 3D media content (or a 3D effect image), the position of the input within the 3D image 530.

As a non-limiting example, when identifying the position 545 of the external input device 103 as the input, the electronic device 101 may provide feedback for notifying that a user input with respect to the 3D image 530 starts. For example, the feedback may be provided using a change of the indicator (or a visual effect represented with respect to the indicator). For example, the feedback may be provided via an output device (e.g., speaker, actuator) of the electronic device 101 using an auditory effect or a tactile effect. For example, the feedback may be provided using a signal transmitted from the electronic device 101 to the external input device 103. For example, the signal transmitted to the external input device 103 may allow to provide a function (or feedback) of the external input device 103.

For example, the electronic device 101 may execute at least one function based on the identified input. For example, the at least one function executed by the electronic device 101 may include a change of the 3D image 530 (or the visual object included in the 3D image 530). For example, the electronic device 101 may simultaneously display, via the display 110, a third image including a 3D image (or another visual object) changed from the 3D image 530 (or the visual object included in the 3D image 530) and a fourth image including the changed 3D image (or the other visual object), based on the identified input. For example, the electronic device 101 may display the third image via the first display regions, and the fourth image via the second display regions. For example, as the electronic device 101 simultaneously displays the third image and the fourth image, the changed 3D image (or the other visual object) may be perceived as being positioned within the space 540. As a non-limiting example, the changed 3D image may be an image in which a visual effect (e.g., color, shape of line, thickness of line, and contrast) is changed from the 3D image 530. The electronic device 101 may generate the third image and the fourth image by identifying a coordinate in the space 540 corresponding to the position 545 of the external input device 103 and respectively changing the first image 510 and the second image 520 corresponding to the coordinate.

In the example, the electronic device 101 may change the first image 510 and the second image 520 into the third image and the fourth image, based on a pressure of the input with respect to the 3D image 530 of the external input device 103. For example, the electronic device 101 may receive, from the external input device 103, pressure information indicating the pressure applied to the external input device 103. For example, the pressure information may indicate a pressure applied to a portion 599, at which the pressure sensor 279 of the external input device 103 is positioned, by a body part 590 (e.g., hand) of the user with respect to the external input device 103. For example, when the pressure is a first pressure, the third image may be generated from the first image 510 based on a first change. When the pressure is a second pressure different from the first pressure, the third image may be generated from the first image 510 based on a second change different from the first change. As a non-limiting example, when the visual effect is a thickness of a line, the first change may include the addition of a line having a first thickness, and the second change may include the addition of a line having a second thickness different from the first thickness. However, the present disclosure is not limited thereto.

Referring to the above description, a system including the electronic device 101 and the external input device 103 may provide an input with respect to the 3D image 530, in accordance with an interaction between the electronic device 101 and the external input device 103. For example, when providing the 3D image 530 by displaying the first image 510 and the second image 520, the electronic device 101 may transmit, to the external input device 103, a signal to notify the external input device 103 that it is in a 3D display mode. For example, the signal may be transmitted to the external input device 103 (or the communication circuitry 269 of the external input device 103) via the communication circuitry 240 of the electronic device 101. In an example, the external input device 103 may obtain data usable for identifying a pressure applied to the external input device 103. For example, the data usable for identifying the pressure may be obtained via the pressure sensor 279 of the external input device 103. For example, the external input device 103 may transmit, to the electronic device 101 (or the communication circuitry 240 of the electronic device 101) via the communication circuitry 269, pressure information indicating the pressure. For example, the electronic device 101 may receive, from the external input device 103, the pressure information indicating the pressure applied to the external input device 103. For example, the electronic device 101 may identify a position of the external input device 103 (or a specified portion of the external input device 103 (e.g., the pen tip 263), as a user input having the pressure with respect to the 3D image 530. For example, the electronic device 101 may perform at least one function (e.g., changed display of the 3D image 530) in accordance with the identified user input.

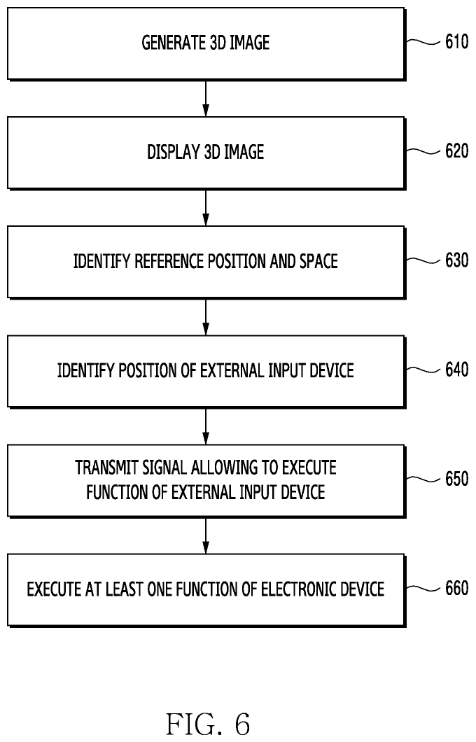

Referring to FIG. 5, the electronic device 101 may identify, while displaying a 3D image, a position of the external input device 103 within a space (e.g., the space 540) at which the 3D image is positioned, transmit a signal to provide feedback to the external input device 103 in accordance with the position of the external input device 103, or recognize an input of the external input device 103 with respect to the 3D image. The above-described operations of the electronic device 101 may be illustrated and described in greater detail below with reference to FIG. 6.

FIG. 6 is a flowchart illustrating an example method in which an electronic device transmits a signal to an external input device and executes a function, in accordance with a position of an external input device with respect to a 3D image displayed via a display according to various embodiments.

At least a portion of the method of FIG. 6 may be performed by the electronic device 101 of FIG. 2. For example, at least a portion of the method may be controlled by the at least one processor 210 of the electronic device 101. In the following embodiment, each operation may be performed sequentially, but is not necessarily performed sequentially. For example, a sequence of each operation may be changed, and at least two operations may be performed in parallel.

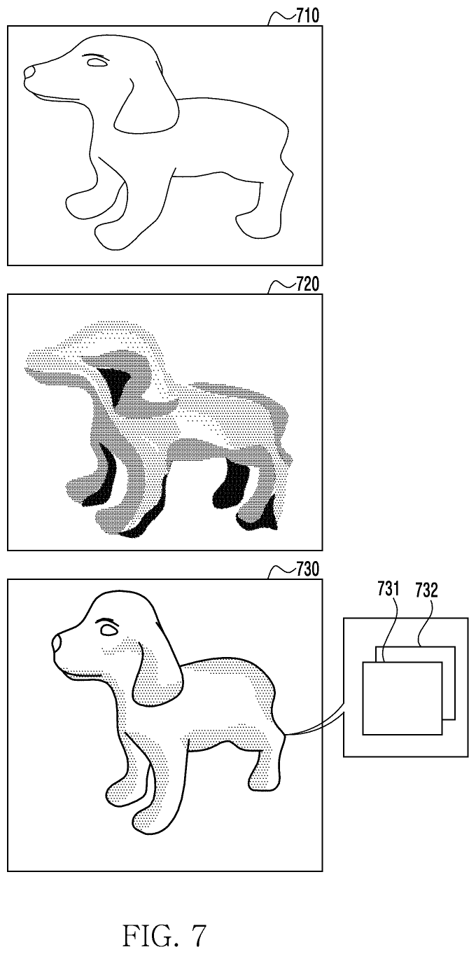

In operation 610, the electronic device 101 may generate a 3D image (or 3D media content, a 3D effect image). For example, the electronic device 101 may generate a plurality of images for displaying a 3D image. As a non-limiting example, the electronic device 101 may identify depth information (or depth map) with respect to one 2D image by analyzing the one 2D image (or 2D media content, a 2D effect image). For example, the one 2D image may be an image obtained using the at least one camera 220 and/or the at least one sensor 230 of the electronic device 101 or obtained (or received or downloaded) from an external electronic device (e.g., server). For example, the electronic device 101 may generate a plurality of images for displaying the 3D image based on the one 2D image and the depth information. Specific details related thereto may be referred to in FIG. 7 below.

In operation 620, the electronic device 101 may display a 3D image. As a non-limiting example, the electronic device 101 may display (or provide) the 3D image (or 3D media content, a 3D effect image), based on execution of the 3D display mode. For example, the electronic device 101 may simultaneously display, via the display 110, the plurality of images generated to display the 3D image. When the plurality of images include a first image and a second image, the electronic device 101 may display the first image via first display regions of the display 110 and display the second image via second display regions of the display 110. Specific details related thereto may be referred to in FIGS. 3B and 5 described above. As a non-limiting example, each of the first image and the second image may be an image including the same visual object.

In operation 630, the electronic device 101 may identify (or set) a reference position and space. For example, the electronic device 101 may obtain data indicating a posture of the electronic device 101, based on data obtained using the at least one sensor 230. For example, the electronic device 101 may identify (or set) the reference position of the display 110 in accordance with the posture of the electronic device 101, based on the data indicating the posture of the electronic device 101. Details of a method of identifying the reference position may be referred to in FIG. 8 below. The electronic device 101 may identify a space above the display 110 (or the electronic device 101) defined from the identified reference position. For example, the space may be an actual environment in which a 3D image will be perceived as being positioned. For example, a center (or origin) within the space may be the reference position. As a non-limiting example, the electronic device 101 may identify the reference position and the space while displaying the 3D image in operation 620. In FIG. 6, it is illustrated that operation 630 is performed after operation 620, but the present disclosure is not limited thereto. For example, the electronic device 101 may identify the reference position and the space before or at the same time as displaying the 3D image in operation 620.

In operation 640, the electronic device 101 may identify a position of the external input device 103. For example, the electronic device 101 may identify the position of the external input device 103 within the space, using the at least one camera 220. As a non-limiting example, when the at least one camera 220 includes two cameras, the electronic device 101 may identify the position of the external input device 103 using images obtained via the two cameras. As a non-limiting example, when the at least one camera 220 includes one camera, the electronic device 101 may identify the position of the external input device 103 using images obtained through the one camera.

As a non-limiting example, the electronic device 101 may identify (or correct) the position of the external input device 103, based on information obtained (or received) via the communication circuitry 240 from the external input device 103. For example, the information obtained from the external input device 103 may include motion information indicating a movement of the external input device 103. As a non-limiting example, the electronic device 101 may identify (or correct) the position of the external input device 103, based on motion information of the external input device 103 obtained using the at least one camera 220 and/or the at least one sensor 230 of the electronic device 101.

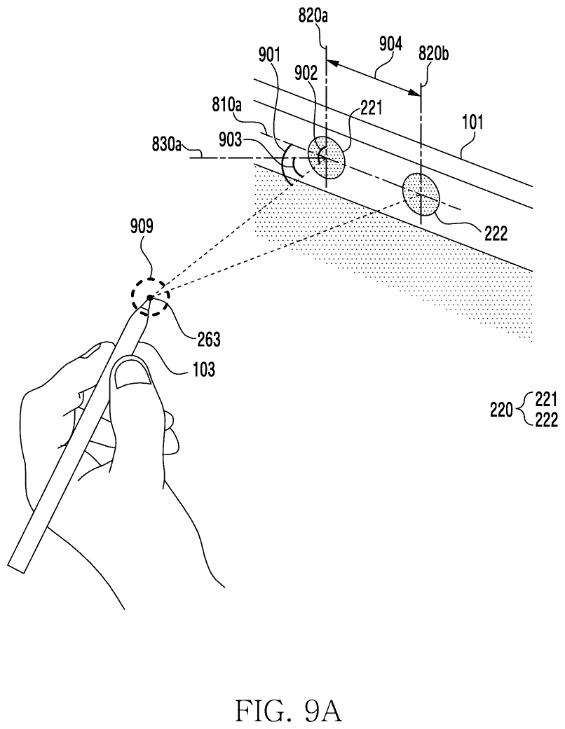

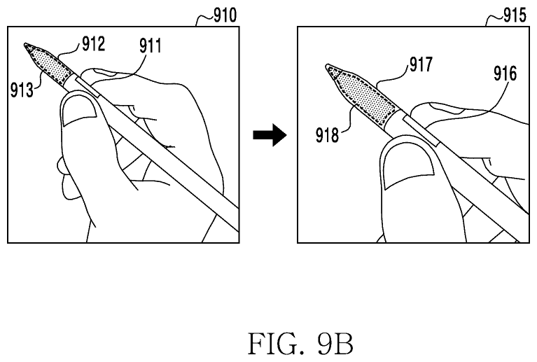

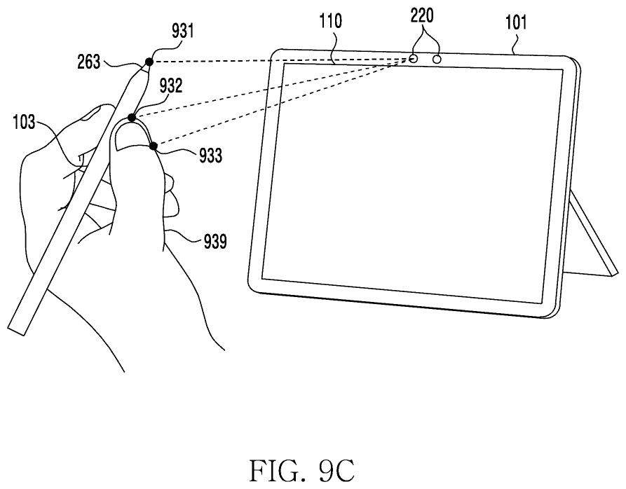

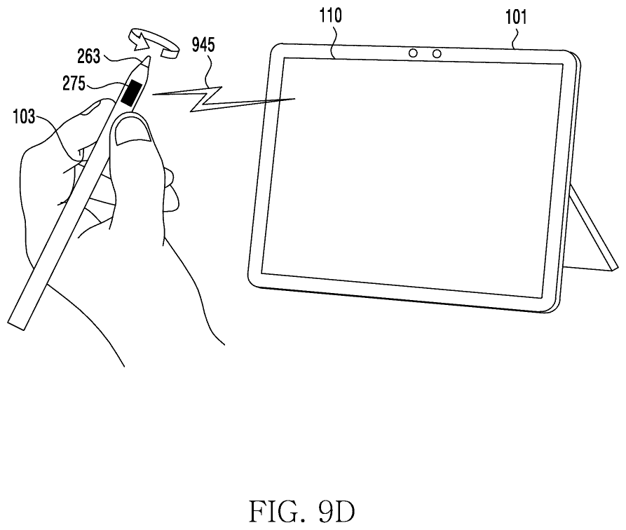

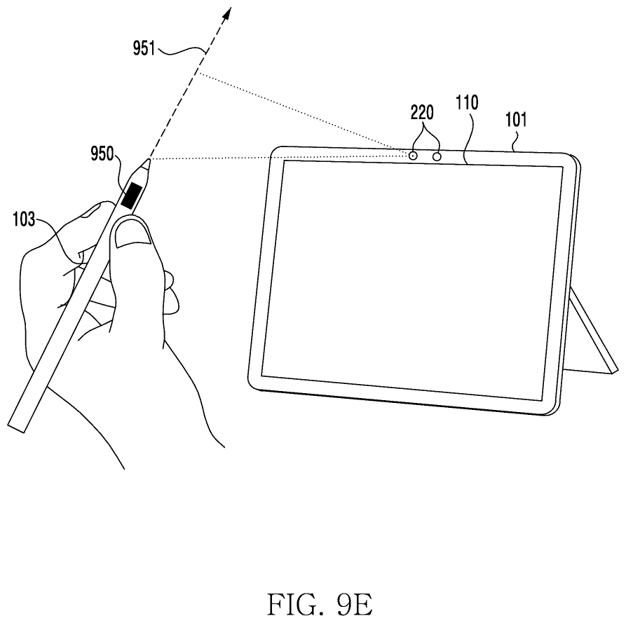

Details of an operation of identifying or correcting the position of the external input device 103 may be referred to in FIGS. 9A, 9B, 9C, 9D and 9E below.

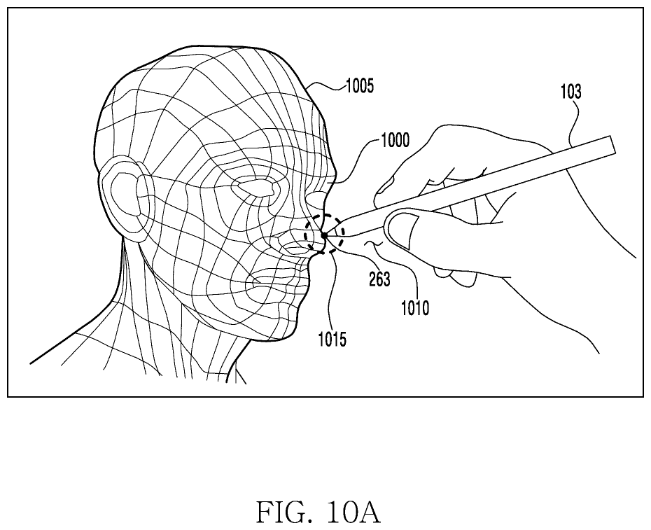

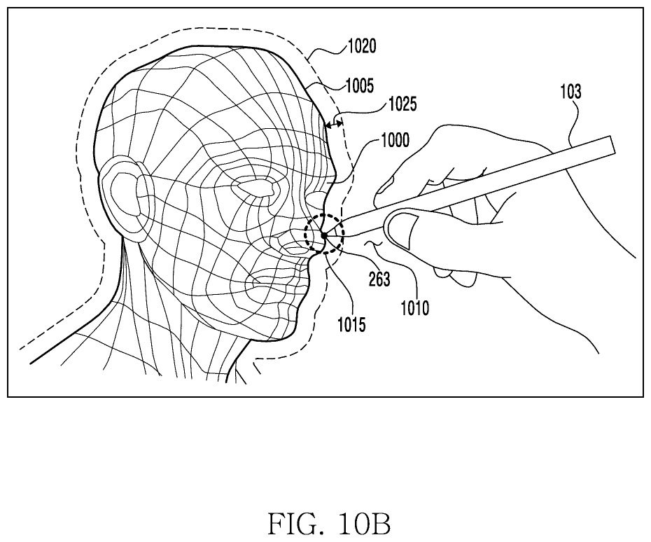

In operation 650, the electronic device 101 may transmit a signal allowing to execute a function of the external input device 103. For example, the electronic device 101 may perform a comparison between the position of the external input device 103 and a reference range (or spatial range). For example, the reference range may be determined (or set) in accordance with a position relationship between the electronic device 101 and the eye of the user. For example, the position relationship may include a distance between the electronic device 101 and the eye of the user and a direction the eye of the user with respect to the electronic device above 101. For example, the distance between the electronic device 101 and the eye of the user may be referred to as a position of the user's eye. For example, the direction of the user's eye with respect to the electronic device 101 may be referred to as an angle between a virtual line defined with respect to the electronic device 101 (or the at least one camera 220) and a virtual line between the electronic device 101 and the user's eye. The direction of the user's eye with respect to the electronic device 101 may be changed in accordance with a posture of the electronic device 101. For example, the electronic device 101 may determine whether the position of the external input device 103 is within the reference range. As a non-limiting example, whether the position of the external input device 103 is positioned within the reference range may indicate identifying whether the external input device 103 (or specified portion (e.g., the pen tip 263) of the external input device 103) is moved into the reference range. For example, the electronic device 101 may identify whether the specified portion of the external input device 103 is moved into the reference range (or, the spatial range), based on the position of the external input device 103. Details related to a method of determining whether the position of the external input device 103 is within the reference range may be referred to in FIGS. 10A and 10B below.

For example, when the position is within the reference range, the electronic device 101 may transmit, to the external input device 103 via the communication circuitry 240, the signal for allowing to execute the function of the external input device 103. For example, the external input device 103 may execute the function based on receiving the signal. For example, the function executed by the external input device 103 may include providing feedback. For example, the feedback may include at least one of tactile feedback, auditory feedback, or visual feedback. Examples of the feedback as the function executed by the external input device 103 may be referred to in FIGS. 11A, 11B and 11C below.

In operation 660, the electronic device 101 may execute at least one function of the electronic device 101. For example, the electronic device 101 may obtain data indicating a movement of the external input device 103, using the at least one camera 220 and/or the at least one sensor 230, while the position of the external input device 103 is within the reference range. For example, the electronic device 101 may identify an input with respect to a 3D image, using the data indicating the movement of the external input device 103.

As a non-limiting example, the electronic device 101 may display an indicator (or pointer) indicating (or representing) the position of the external input device 103 within the 3D image (or the 3D media content, the 3D effect image), while the position of the external input device 103 with the 3D image (or 3D media content, 3D effect image) is within the reference range. For example, the electronic device 101 may display the indicator within the 3D image, by displaying the first image and the second image that are changed to represent the indicator via the display 110. For example, the indicator may be used to indicate a position of the input within the 3D image to a user performing an input (or user input) with respect to the 3D image that is the 3D media content.

As a non-limiting example, the electronic device 101 may provide feedback to notify that a user input with respect to a 3D image starts when the electronic device 101 identifies the position of the external input device 103 as the input (or user input). For example, the feedback may be provided using a change of the indicator (or a visual effect represented with respect to the indicator). For example, the feedback may be provided using an auditory effect or a tactile effect via an output device (e.g., speaker, actuator) of the electronic device 101. For example, the feedback may be provided using a signal transmitted from the electronic device 101 to the external input device 103. For example, the signal transmitted to the external input device 103 may allow to provide a function (or feedback) of the external input device 103.

For example, the electronic device 101 may execute at least one function based on the identified input. For example, the at least one function executed by the electronic device 101 may include a change of the 3D image being displayed. For example, the electronic device 101 may simultaneously display, via the display 110, a third image and a fourth image for displaying a 3D image changed from the 3D image being displayed, based on the identified input. For example, the third image may be an image changed from the first image, and the fourth image may be an image changed from the second image. For example, each of the third image and the fourth image may equally include another visual object changed from the visual object included in the first image and the second image. For example, the electronic device 101 may display the third image via the first display regions, and display the fourth image via the second display regions.

For example, as the electronic device 101 simultaneously displays the third image and the fourth image, the changed 3D image (or the other visual object) may be perceived as being positioned within the space. As a non-limiting example, the changed 3D image may be an image in which a visual effect (e.g., color, line shape, line thickness, contrast) is changed from the 3D image displayed in the operation 620. The electronic device 101 may identify a coordinate within the space corresponding to the position of the external input device 103, and may generate the third image and the fourth image by respectively changing the first image and the second image corresponding to the coordinates.

The electronic device 101 may change the first image and the second image into the third image and the fourth image, based on a pressure of an input with respect to the 3D image displayed in operation 620 of the external input device 103. For example, the electronic device 101 may receive, from the external input device 103, pressure information indicating a pressure applied to the external input device 103. For example, the pressure information may indicate a pressure applied to a portion, at which the pressure sensor 279 of the external input device 103 is positioned, by a body part (e.g., hand) of the user with respect to the external input device 103. Specific details related thereto may be referred to in FIG. 14 below. For example, when the pressure is a first pressure, the third image may be generated from the first image based on a first change. When the pressure is a second pressure different from the first pressure, the third image may be generated from the first image based on a second change different from the first change. As a non-limiting example, when the visual effect is a line thickness, the first change may include the addition of a line having a first thickness, and the second change may include the addition of a line having a second thickness different from the first thickness. However, the present disclosure is not limited thereto.

FIG. 7 is a diagram illustrating an example method of generating a 3D image according to various embodiments.

FIG. 7 illustrates an example of a method in which the electronic device 101 generates a 3D image 730 from one 2D image 710.

For example, the electronic device 101 may obtain the 2D image 710 using the at least one camera 220 and/or the at least one sensor 230 of the electronic device 101. For example, the electronic device 101 may obtain the 2D image 710 from an external electronic device (e.g., a server) using the communication circuitry 240 of the electronic device 101. The 2D image 710 may be referred to as an original image of the 3D image 730. In other words, the original image may be an image for providing 3D media content.

For example, the electronic device 101 may identify depth information 720 with respect to the 2D image 710, by analyzing the 2D image 710. For example, the depth information 720 may include depth values for each position (or pixels of the 2D image 710) within the 2D image 710. For example, the depth information 720 may be identified (or generated) using and analyzing the 2D image 710 obtained through each of two cameras, similar to how a person perceives a three-dimensional object by obtaining images of an object through two eyes and processing them in the brain.

In FIG. 7, for convenience of description, the depth information 720 is illustrated as visualized information, but the depth information 720 may be data including depth values. For example, within the visualized depth information 720, the contrast may indicate depth values. For example, a bright portion of the depth information 720 may indicate a relatively close position (or shallow depth) compared to a dark portion.

For example, the electronic device 101 may generate the 3D image 730 using the 2D image 710 and the depth information 720. For example, generating the 3D image 730 may include generating a plurality of 2D images 731 and 732 from the 2D image 710, using the depth information 720. For example, the electronic device 101 may display the 3D image 730 by simultaneously displaying the plurality of 2D images 731 and 732 via the display 110. For example, based on the depth information 720, the 2D images 731 and 732 may be generated so that a close portion of the 3D image 730 is perceived to be closer and a far portion of the 3D image 730 is perceived as farther away. In other words, a coordinate for each position (or each pixel) of the 3D image 730 (or each of the 2D images 731 and 732) may be calculated based on the depth information 720.

FIG. 8 is a diagram illustrating an example method in which an electronic device identifies a reference position defining a space above a display using at least one sensor according to various embodiments.

Referring to FIG. 8, the electronic device 101 may obtain data indicating a posture of the electronic device 101 using the at least one sensor 230. For example, the posture of the electronic device 101 may include an angle at which the electronic device 101 is inclined. For example, the at least one sensor 230 may include a motion sensor (or accelerometer, gyro sensor). For example, the electronic device 101 may identify a reference position 800 of the display 110 according to the posture. In FIG. 8, for convenience of description, a case in which a center point of the display 110 is the reference position 800 is illustrated. For example, the electronic device 101 may define three axes 810, 820, and 830 around the reference position 800. For example, the three axes 810, 820, and 830 may be orthogonal to each other. For example, the first axis 810 may be referred to as the x-axis. For example, the second axis 820 may be referred to as the y-axis. For example, the third axis 830 may be referred to as the z-axis. For example, the space above the display 110 may define the reference position 800 as the origin. For example, the space may be defined as a coordinate system using the three axes 810, 820, and 830 passing through the reference position 800.

For example, according to the posture of the electronic device 101, a direction of an eye of a user with respect to the electronic device 101 may be changed. For example, the direction of the eye of the user may be referred to as an angle between a virtual line defined with respect to the electronic device 101 (or the at least one camera 220) and another virtual line between the electronic device 101 and the eye of the user. For example, the virtual line may indicate a line that is substantially parallel to the third axis 830 and passes through the at least one camera 220. For example, the other virtual line may indicate a line extending from the at least one camera 220 to the eye. For example, the direction may indicate a direction in which the other virtual line faces. As a non-limiting example, the other virtual line and the virtual line may be aligned.

FIGS. 9A, 9B, 9C, 9D and 9E are diagrams illustrating examples of a method in which an electronic device identifies a position of an external input device in a space using at least one camera according to various embodiments.

FIG. 9A illustrates an example of a method in which an electronic device 101 identifies a position 909 of an external input device 103 within a space using two cameras 221 and 222. For example, at least one camera 220 may include a first camera 221 and a second camera 222. For example, the first camera 221 may have a first FoV. For example, the second camera 222 may have a second FoV. As a non-limiting example, the first FoV may be identical to the second FoV. However, the present disclosure is not limited thereto. For example, the first FoV may be different from the second FoV.

For example, the electronic device 101 may obtain first image data having the first FoV obtained via the first camera 221. For example, the first image data may include a virtual object corresponding to the external input device 103. For example, the electronic device 101 may calculate (or identify) a first angle 901, a second angle 902, and a third angle 903 based on the first image data. For example, the first angle 901 may indicate an angle between a first axis 810a among three axes 810a, 820a, and 830a defined with respect to a position of the first camera 221 and a straight line from the position of the first camera 221 to the external input device 103 (or position of the pen tip 263, which is a point of the external input device 103). For example, the first axis 810a may be an axis that is moved in parallel from the first axis 810 defined with respect to the reference position 800 of FIG. 8. For example, the second angle 902 may indicate an angle between the second axis 820a among the three axes 810a, 820a, and 830a defined with respect to the position of the first camera 221 and the straight line from the position of the first camera 221 to the external input device 103 (or position of the pen tip 263, which is a point of the external input device 103). For example, the second axis 820a may be an axis that is moved in parallel from the second axis 820 defined with respect to the reference position 800 of FIG. 8. For example, the third angle 903 may indicate an angle between the third axis 830a among the three axes 810a, 820a, and 830a defined with respect to the position of the first camera 221 and the straight line from the position of the first camera 221 to the external input device 103 (or position of the pen tip 263, which is a point of the external input device 103). For example, the third axis 830a may be an axis that is moved in parallel from the third axis 830 defined with respect to the reference position 800 of FIG. 8.

In the above example, a case of identifying angles 901, 902, and 903 with respect to the first image data obtained through the first camera 221 is described, but the present disclosure is not limited thereto. For example, the electronic device 101 may obtain second image data having the second FoV through the second camera 222. For example, the second image data may include the virtual object corresponding to the external input device 103. For example, the electronic device 101 may calculate (or identify) a fourth angle, a fifth angle, and a sixth angle based on the second image data. As a method of identifying the fourth angle, a method of identifying the first angle 901 may be substantially identically applied. As a method of identifying the fifth angle, a method of identifying the second angle 902 may be substantially identically applied. As a method of identifying the sixth angle, a method of identifying the third angle 903 may be substantially identically applied.

For example, the electronic device 101 may identify a distance 904 between the first camera 221 and the second camera 222. For example, the distance 904 may indicate a distance between an axis 820b defined with respect to a position of the second camera 222 and the second axis 820a. For example, the axis 820b may be an axis that is moved in parallel from the second axis 820 defined with respect to the reference position 800 of FIG. 8.

For example, the electronic device 101 may identify a position 909 of the external input device 103, based on the identified angles (e.g., the first angle 901, the second angle 902, the third angle 903, the fourth angle, the fifth angle, and the sixth angle) and the distance 904. For example, the position 909 may be a position of the pen tip 263 of the external input device 103 within the space.

Although not illustrated in FIG. 9A, the electronic device 101 may calculate (or identify) relative coordinates with respect to the reference position 800 of FIG. 8 when identifying the position 909 of the external input device 103. In other words, the electronic device 101 may define the position 909 as a coordinate (e.g., (x, y, z)) within the space defined from the reference position 800.

In FIG. 9A, it is illustrated that two cameras of the at least one camera 220 are used, but the present disclosure is not limited thereto. For example, the electronic device 101 may identify the position of the external input device 103 by measuring a distance to the external input device 103 using the at least one sensor 230.

FIG. 9B illustrates an example of a method in which an electronic device 101 identifies a position of an external input device 103 within a space using one camera (e.g., one of the first camera 221 or the second camera 222 of FIG. 9A). For example, the electronic device 101 may identify a position of the external input device 103 using the camera of the at least one camera 220.

For example, the electronic device 101 may obtain first image data 910 using the camera. For example, after obtaining the first image data 910, the electronic device 101 may obtain second image data 915 using the camera.

For example, the first image data 910 may include a virtual object 911 corresponding to the external input device 103. For example, a portion 912 of the virtual object 911 may correspond to a portion including the pen tip 263 of the external input device 103. For example, the electronic device 101 may identify a size 913 of the portion 912, based on the first image data 910.

For example, the second image data 915 may include a virtual object 916 corresponding to the external input device 103. For example, a portion 917 of the virtual object 916 may correspond to the portion including the pen tip 263 of the external input device 103. In other words, the portion of the external input device 103 corresponding to the portion 917 may be identical to the portion of the external input device 103 corresponding to the portion 912. For example, the electronic device 101 may identify a size 918 of the portion 917, based on the second image data 915.

As a non-limiting example, the size 918 may be larger than the size 913. When the size 918 of the second image data 915 obtained later is greater than the size 913, it may indicate that the external input device 103 becomes closer to the electronic device 101. However, the present disclosure is not limited thereto.

For example, the electronic device 101 may identify a position of the external input device 103 within the space, based on the first image data 910 and the second image data 915. For example, the electronic device 101 may identify (or calculate) a position (or coordinate corresponding to the position) of the external input device 103 within the space, using a difference between the size 913 of the portion 912 of the first image data 910 and the size 918 of the portion 917 of the second image data 915. Compared to the method of FIG. 9A, although the accuracy with respect to the position of the external input device 103 is lower, the method of FIG. 9B may identify the position of the external input device 103 with lower power consumption.

In FIG. 9B, it is illustrated that the one camera of the at least one camera 220 is used, but the present disclosure is not limited thereto. For example, the electronic device 101 may identify the position of the external input device 103 by measuring the distance to the external input device 103 using the at least one sensor 230.

The above-described FIGS. 9A and 9B illustrate a case where the electronic device 101 identifies the position of the pen tip 263 of the external input device 103 as the position of the external input device 103, but the present disclosure is not limited thereto. For example, the electronic device 101 may identify a plurality of positions related to the external input device 103. Details related thereto may be referred to in FIG. 9C below.

FIG. 9C illustrates an example of a method in which the electronic device 101 identifies positions of the external input devices 103 within a space. For example, the electronic device 101 may identify a position of the external input devices 103, using the at least one camera 220.

For example, the electronic device 101 may identify positions 931, 932, and 933 of the external input device 103. For example, the electronic device 101 may identify the position 931, which is a position of the pen tip 263 (or another point) of the external input device 103. For example, the electronic device 101 may identify the position 932 of the external input device 103. As a non-limiting example, the position 932 may be a position where a hand 939 of the user and the external input device 103 are in contact. For example, the electronic device 101 may identify the position 933 of the hand 939 gripping the external input device 103. For example, the position 933 may be different from the position 932. For example, the method of FIG. 9A and FIG. 9B may be used as a method for identifying each of the positions 931, 932, and 933. In FIG. 9c, it is illustrated that three positions are identified, but the present disclosure is not limited thereto. For example, the electronic device 101 may identify two positions or four or more positions.

For example, the electronic device 101 may obtain motion information of the external input device 103 by periodically identifying positions 931, 932, and 933 of the external input device 103. For example, the motion information may include a position, a movement, or a slope (or posture) of the external input device 103. For example, the electronic device 101 may correct a position (e.g., the position 931) of the external input device 103 based on the motion information. For example, the electronic device 101 may use the corrected position as the position of the external input device 103.

The above-described FIGS. 9A, 9B and 9C illustrate a case where the electronic device 101 independently identifies the position of the external input device 103, but the present disclosure is not limited thereto. For example, the electronic device 101 may identify the position of the external input device 103 using information received from the external input device 103 or using information provided by the external input device 103. Details related thereto may be referred to in FIGS. 9D and 9E below.

FIG. 9D illustrates an example of a method in which an electronic device 101 identifies a position of an external input device 103 using motion information 945 received from the external input device 103.

For example, the external input device 103 may obtain data indicating the motion information 945 of the external input device 103 using the motion sensor 275. As a non-limiting example, the motion information 945 may include a position, a movement (or rotation), or a slope (or posture) of the external input device 103 using the data, which is a sensor value obtained through an accelerometer and/or a gyro sensor. For example, the external input device 103 may generate the motion information 945 processed based on the data. For example, the external input device 103 may transmit the motion information 945 to the electronic device 101 via communication circuitry 269. In the above example, the motion information 945 processed by the external input device 103 (or the at least one processor 271 of the external input device 103) is described as being transmitted to the electronic device 101, but the present disclosure is not limited thereto. For example, the external input device 103 may transmit the data obtained using the motion sensor 275 to the electronic device 101 without processing it. Thereafter, the data may be used to generate motion information within the electronic device 101. A method of transmitting the data may reduce power consumption of the external input device 103 compared to transmitting the motion information 945.

For example, the electronic device 101 may use the received motion information 945 (or the data) to identify the position of the external input device 103. For example, the electronic device 101 may correct the position of the external input device 103 identified through FIGS. 9A, 9B and 9C based on the received motion information 945.

FIG. 9E illustrates an example of a method in which an electronic device 101 identifies a position of an external input device 103 by identifying a light 951 emitted from an IR sensor 950 of the external input device 103.

For example, the electronic device 101 may identify the light 951 emitted from the IR sensor 950 of the external input device 103 using the at least one camera 220. For example, the light 951 emitted from the IR sensor 950 may be infrared. Accordingly, the light 951 emitted from the external input device 103 may not be recognized by the user's eyes, but may be detected by the at least one camera 220 of the electronic device 101. For example, the electronic device 101 may obtain data indicating a movement (or motion, posture) of the light 951 emitted from the IR sensor 950. For example, the electronic device 101 may identify motion information (e.g., position, movement, slope) of the external input device 103 using the obtained data. For example, the electronic device 101 may be used to identify the position of the external input device 103 based on the motion information. For example, the electronic device 101 may correct the position of the external input device 103 identified through FIGS. 9A, 9B and 9C, based on the identified motion information.

FIGS. 10A and 10B are diagrams illustrating examples of a method in which an electronic device transmits a signal to an external input device in accordance with a position of the external input device according to various embodiments.

Referring to FIG. 10A, the electronic device 101 may identify positions (or recognition positions) at which a 3D image 1000 (or a visual object) is to be perceived as being positioned within a space 1010 when displaying the 3D image 1000. For example, the electronic device 101 may identify a boundary 1005 of the recognition positions of the 3D image 1000.

For example, the electronic device 101 may identify a position 1015 of the pen tip 263 of the external input device 103. For example, the electronic device 101 may identify the position 1015 of the external input device 103, based on the methods of FIG. 8 and FIGS. 9A, 9B, 9C, 9D and 9E. For example, the position 1015 may be a position within the space 1010.

For example, the electronic device 101 may identify that the position 1015 matches the boundary 1005. For example, the electronic device 101 may determine whether a coordinate corresponding to the position 1015 matches one of coordinates corresponding to the boundary 1005. For example, when the position 1015 matches the boundary 1005, the electronic device 101 may transmit, to the external input device 103 via the communication circuitry 240, a signal allowing to execute a function of the external input device 103.

Referring to FIG. 10B, the electronic device 101 may identify positions (or recognition positions) at which the 3D image 1000 is to be perceived as being positioned within the space 1010 when displaying the 3D image 1000 (or a visual object). For example, the electronic device 101 may identify the boundary 1005 of the recognition positions of the 3D image 1000. For example, the electronic device 101 may identify a reference range 1020 extending from the recognition positions (or the boundary 1005 of the recognition positions) within the space 1010. For example, the reference range 1020 may include a range spaced apart by a distance 1025 from the boundary 1005 of the recognition positions.

For example, the electronic device 101 may identify the position 1015 of the pen tip 263 of the external input device 103. For example, the electronic device 101 may identify the position 1015 of the external input device 103, based on the methods of FIG. 8 and FIGS. 9A, 9B, 9C, 9D and 9E. For example, the position 1015 may be a position within the space 1010.

For example, the electronic device 101 may identify whether the position 1015 is within the reference range 1020. For example, the electronic device 101 may determine whether a coordinate corresponding to the position 1015 matches one of coordinates corresponding to positions included within the reference range 1020. For example, when the position 1015 is within the reference range 1020, the electronic device 101 may transmit, to the external input device 103 via the communication circuitry 240, a signal allowing to execute a function of the external input device 103.

Although FIGS. 10A and 10B illustrate that the boundary 1005 and the reference range 1020 are distinct from each other, the present disclosure is not limited thereto. For example, the boundary 1005 may be included in the reference range 1020 or may be referenced as the reference range 1020.

FIGS. 11A, 11B and 11C are diagrams illustrating examples of a method in which an external input device provides feedback according to various embodiments.

FIG. 11A illustrates examples 1101 and 1102 of a method in which an external input device 103 provides tactile feedback. Although not illustrated in FIG. 11A, the external input device 103 may receive, from the electronic device 101, a signal allowing to execute a function of the external input device 103.

For example, the external input device 103 may include an actuator 281 for providing tactile feedback. The examples 1101 and 1102 illustrate an example of an operation (or piezo effect) of a piezo (or piezo element) used as the actuator 281. As a non-limiting example, the piezo element may include a piezoelectric element (or piezoelectric ceramic). However, the present disclosure is not limited thereto. For example, the actuator 281 may be a motor.

Referring to the example 1101, when an external pressure (or external impact) 1105 is applied to the actuator 281, a voltage 1107 (or electricity) may be generated in the actuator 281 according to the piezoelectric effect. Referring to the example 1102, when an external voltage 1117 (or electricity) is applied to the actuator 281, a vibration 1115 may be generated in the actuator 281 according to a reverse piezoelectric effect. For example, as the actuator 281 contracts or expands, the vibration 1115 may be caused.

As described above, the external input device 103 may execute the function of outputting a vibration by the actuator 281 according to receiving from the electronic device 101 a signal allowing to execute a function of the external input device 103. As a non-limiting example, the external input device 103 may adjust an intensity of the vibration output by the actuator 281 according to receiving the signal. As a non-limiting example, the external input device 103 may adjust a pattern of the vibration output by the actuator 281 according to receiving the signal. For example, the pattern of the vibration may be defined by a timing in which the vibration occurs, intensity, and order. For example, the pattern of the vibration may be stored in the memory 273 of the external input device 103, or may be received from the electronic device 101.

FIG. 11B is a diagram illustrating an example 1120 of a method in which the external input device 103 provides auditory feedback according to various embodiments. Although not illustrated in FIG. 11B, the external input device 103 may receive from the electronic device 101 a signal allowing to execute a function of the external input device 103.

For example, the external input device 103 may include a speaker 283 for providing auditory feedback. For example, the speaker 283 may be mounted (or equipped) on the PCB 261. For example, the speaker 283 may be a surface mounted device (SMD) mounted on a surface of the PCB 261. In the example of FIG. 11B, the speaker 283 is illustrated as being positioned in an area far from the pen tip 263 among areas of the PCB 261, but the present disclosure is not limited thereto. For example, the area in which the speaker 283 is positioned on the PCB 261 may be changed.

As described above, the external input device 103 may execute the function of outputting sound by the speaker 283, according to receiving from the electronic device 101 a signal allowing to execute a function of the external input device 103. As a non-limiting example, the external input device 103 may adjust an intensity of the sound output by the speaker 283 according to receiving the signal. As a non-limiting example, the external input device 103 may adjust a pattern of the sound output by the speaker 283 according to receiving the signal. For example, the pattern of the sound may be defined by a pitch (or amplitude) of the sound, a frequency of the sound, and an intensity of the sound. For example, the pattern of the sound may be stored in the memory 273 of the external input device 103, or may be received from the electronic device 101.

As a non-limiting example, the speaker 283 of FIG. 11B may include a piezoelectric element comprising the actuator 281 of FIG. 11A. For example, the piezoelectric element included in the speaker 283 may output sound by vibration. For example, when a frequency of the vibration by the piezoelectric element included in the speaker 283 is changed, a sound having a musical scale corresponding to the changed frequency may be output. Accordingly, the speaker 283 using (or including) the piezoelectric element may generate various patterns of the sound.

FIG. 11C is a diagram illustrating an example 1130 of a method in which the external input device 103 provides visual feedback according to various embodiments. Although not illustrated in FIG. 11C, the external input device 103 may receive from the electronic device 101 a signal allowing to execute a function of the external input device 103.

For example, the external input device 103 may include an emitter 285 for providing visual feedback. For example, the emitter 285 may include a plurality of light-emitting elements (e.g., light emitting diode (LED)). For example, each of the plurality of light-emitting elements may emit visible light of a specific color. For example, the plurality of light-emitting elements included in the emitter 285 may emit visible light of different colors.

As described above, according to receiving, from the electronic device 101, a signal allowing to execute a function of the external input device 103, the external input device 103 may execute the function of outputting light by the emitter 285. As a non-limiting example, the external input device 103 may adjust a brightness of the light output by the emitter 285, according to receiving the signal. As a non-limiting example, the external input device 103 may adjust a color of the light output by the emitter 285, according to receiving the signal. As a non-limiting example, the external input device 103 may adjust a pattern of the light output by the emitter 285, according to receiving the signal. For example, the pattern of the light may be defined by a color of the light, an emission period of the light, and an emission intensity of the light. For example, the pattern of the light may be stored in the memory 273 of the external input device 103 or received from the electronic device 101.

Although not illustrated in FIGS. 11A, 11B and 11C, the external input device 103 may provide feedback using components other than the actuator 281, the speaker 283, and the emitter 285. For example, the external input device 103 may provide tactile feedback using an electronic component capable of providing electrical friction. For example, the electrical friction may be used to feel a texture of a material represented in a 3D image with respect to a body part (e.g., hand or finger) in contact with the external input device 103. For example, the electrical friction may also be referred to as static electricity. For example, the external input device 103 may provide tactile feedback (e.g., a change in temperature) using an electronic component capable of controlling temperature. For example, the external input device 103 may provide olfactory feedback using an electronic component capable of emitting a specific scent.

As described above, it is described that the external input device 103 provides feedback when a position (e.g., the position 1015 of FIG. 10B) of the external input device 103 is positioned within a reference range (e.g., the reference range 1020 of FIG. 10B), but the present disclosure is not limited thereto. For example, the electronic device 101 may provide feedback via an output device (e.g., speaker) of the electronic device 101 when a position (e.g., the position 1015 of FIG. 10B) of the external input device 103 is positioned within a reference range (e.g., the reference range 1020 of FIG. 10B).

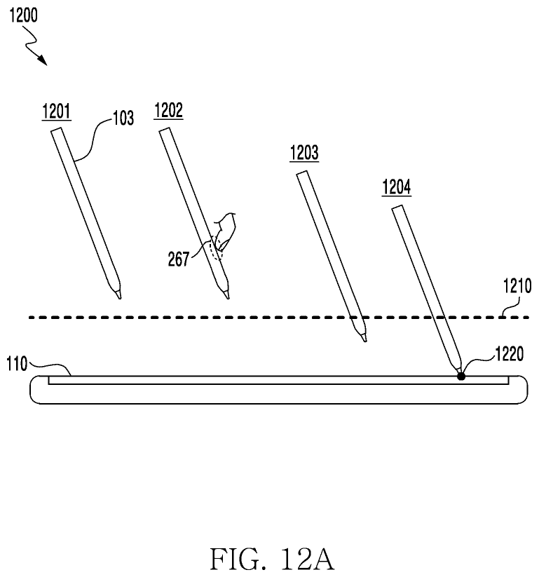

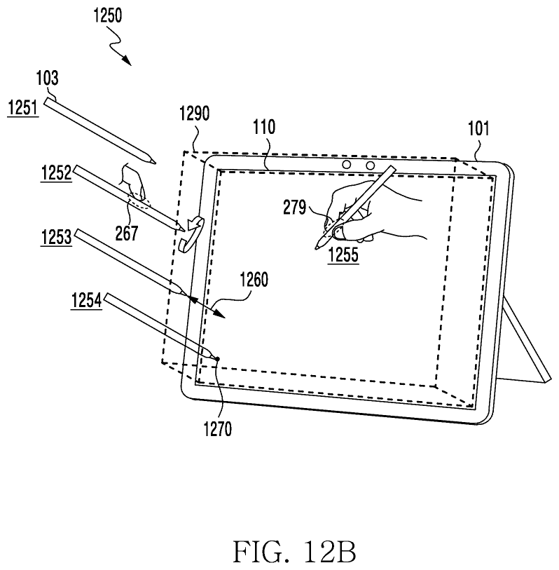

FIGS. 12A and 12B are diagrams illustrating examples of an operation of an electronic device in accordance with a position state of an external input device according to various embodiments.

FIG. 12A illustrates an example 1200 of an operation of an electronic device 101 according to a position state of an external input device 103 within a 2D display mode of the electronic device 101. FIG. 12B illustrates an example 1250 of an operation of the electronic device 101 according to a position state of the external input device 103 within a 3D display mode of the electronic device 101.

Referring to the example 1200 of FIG. 12A, it illustrates a state 1201 in which the external input device 103 is positioned outside another reference range 1210 from the electronic device 101 and a button 267 of the external input device 103 is not pressed, a state 1202 in which the external input device 103 is positioned outside the other reference range 1210 from the electronic device 101 and the button 267 is pressed, a state 1203 in which the external input device 103 is positioned within the other reference range 1210 from the electronic device 101 and is spaced apart from the display 110, and a state 1204 in which the external input device 103 is in contact with the display 110 of the electronic device 101. For example, the other reference range 1210 may define a distance from a surface of the display 110 capable of recognizing a hovering input during a touch input.

As a non-limiting example, the electronic device 101 may receive, from the external input device 103 via the communication circuitry 240, pressure information indicating a pressure applied to the external input device 103. For example, the electronic device 101 may recognize that a body part (e.g., a hand) of the user is in contact with (or grips) the external input device 103 based on the received pressure information. The following states 1201, 1202, 1203, and 1204 may be a state in which the electronic device 101 recognizes that the body part of the user is in contact with the external input device 103. However, the present disclosure is not limited thereto. For example, the electronic device 101 may perform an operation according to the following states 1201, 1202, 1203, and 1204 without receiving the pressure information.

In the state 1201, since a touch input by the external input device 103 positioned outside the other reference range 1210 may not be recognized and the button 267 is not pressed, the electronic device 101 may refrain from (or may cease, or may not perform) identifying a gesture by the external input device 103. Accordingly, in the state 1201, the electronic device 101 may refrain from interacting with the external input device 103 or executing a function caused by the external input device 103.

In the state 1202, a touch input by the external input device 103 positioned outside the other reference range 1210 may not be recognized, but the button 267 is pressed, so the electronic device 101 may identify a gesture by the external input device 103. The electronic device 101 may identify the gesture by the external input device 103 and execute a function corresponding to (or mapped to, defined for) the gesture. As a non-limiting example, the gesture may include a click, a drag, or a rotation. In the above example, it is describes that the electronic device 101 identifies a gesture by the external input device 103, in which the button 267 is pressed, with respect to the external input device 103 positioned outside the other reference range 1210, but the present disclosure is not limited thereto. For example, the electronic device 101 may identify a gesture by the external input device 103 according to whether a grip is identified by the pressure sensor 279 of the external input device 103, rather than whether the button 267 of the external input device 103 is pressed. As a non-limiting example, the electronic device 101 may receive sensing data (or pressure information identified based on the sensing data) obtained by the external input device 103 via the pressure sensor 279, and may recognize that a body part (e.g., a hand) of a user is in contact with (or grips) the external input device 103 using the received sensing data (or pressure information). At this time, the electronic device 101 may identify a gesture by the external input device 103 positioned outside the other reference range 1210. In addition, for example, the external input device 103 may identify, via the pressure sensor 279, an input (e.g., double tap, or a press through a portion (e.g., fingernail) of the user's body part) with respect to a housing (or exterior) of the external input device 103 as the gesture, rather than an input (e.g., double tap) with respect to the button 267. The electronic device 101 may receive, from the external input device 103, the sensing data (or pressure information) indicating the identified input, and identify a gesture accordingly.

In the state 1203, the electronic device 101 may recognize a hovering input by the external input device 103, which is positioned within the other reference range 1210 and spaced from (or not in contact with) the display 110. For example, the electronic device 101 may identify a position on the display 110 for the hovering input in accordance with a change in a magnetic field by the external input device 103. Based on the identified position, the electronic device 101 may recognize the hovering input by the external input device 103. As a non-limiting example, the hovering input may include a click, a drag, or a rotation.

In the state 1204, the electronic device 101 may recognize an input including contact points by the external input device 103 that is in contact with the display 110. For example, the electronic device 101 may identify a position 1220 on the display 110 for an input including the contact points in accordance with a change in a magnetic field by the external input device 103. Based on the identified position 1220, the electronic device 101 may recognize the input including the contact points by the external input device 103. As a non-limiting example, the input including the contact points may include a click, a drag, or a rotation.

As a non-limiting example, the electronic device 101 may identify a pressure by the external input device 103 on the display 110, by identifying a degree to which the pen tip 263 of the external input device 103 is pressed, in accordance with a change in a magnetic field (or resonant frequency). For example, the electronic device 101 may execute a function according to the input by the external input device 103, based on the pressure. As a non-limiting example, the function may include changing an image (or visual object) being displayed.

In the 2D display mode, the electronic device 101 may perform operations by recognizing a gesture or a touch input (e.g., a hovering input or an input including contact points) of the external input device 103, using the touch circuitry 300 included in the display 110 of the electronic device 101, the communication circuitry 240, or the at least one camera 220.

Referring to the example 1250 of FIG. 12B, it illustrates a state 1251 in which the external input device 103 is positioned outside a space 1290 from the electronic device 101 and the button 267 of the external input device 103 is not pressed, a state 1252 in which the button 267 of the external input device 103 is pressed, a state 1253 in which the external input device 103 is positioned within another reference range 1260 from the electronic device 101 and is spaced apart from the display 110, a state 1254 in which the external input device 103 is in contact with the display 110 of the electronic device 101, and a state 1255 in which a position of the external input device 103 corresponds to (or is mapped to, or matches) recognition positions defined with respect to a 3D image displayed by the electronic device 101. For example, the space 1290 (e.g., the space 540 of FIG. 5) may be at least a portion of the real environment in which the 3D image above the display 110 is to be perceived as being positioned. As a non-limiting example, the space may be a space corresponding to a field of view (FoV) of the at least one camera 220. For example, the other reference range 1260 (e.g., the other reference range 1210 of FIG. 12A) may define a distance from a surface of the display 110 capable of recognizing a hovering input during a touch input.

For example, the electronic device 101 may receive, from the external input device 103 via the communication circuitry 240, pressure information indicating a pressure applied to the external input device 103. For example, based on the received pressure information, the electronic device 101 may recognize that a body part (e.g., hand) of the user is in contact with (or grips) the external input device 103. The following states 1251, 1252, 1253, 1254, and 1255 may be a state in which the electronic device 101 recognizes that the body part of the user is in contact with the external input device 103. In the 3D display mode, the electronic device 101 may perform an operation according to the following states 1251, 1252, 1253, 1254, and 1255, based on recognizing that the user's body part is in contact with the external input device 103. In addition, the electronic device 101 may perform an operation according to the following states 1251, 1252, 1253, 1254, and 1255, based on the execution of the 3D display mode.

In the state 1251, since the electronic device 101 may not recognize a touch input by the external input device 103 positioned outside the space 1290 and the button 267 is not pressed, the electronic device 101 may refrain from (or may cease, may not perform) identifying a gesture by the external input device 103. Accordingly, in the state 1251, the electronic device 101 may refrain from interacting with the external input device 103 or executing a function caused by the external input device 103.

In the state 1252, the electronic device 101 may perform a gesture recognition mode according to a relationship between a position of the external input device 103 and the space 1290, when the button 267 of the external input device 103 is pressed. For example, the electronic device 101 may perform a 2D gesture recognition mode, when the button 267 of the external input device 103 is pressed and is positioned outside the position of the external input device 103 and the space 1290. For example, the electronic device 101 may perform a 3D gesture recognition mode, when the button 267 of the external input device 103 is pressed and is positioned within the position of the external input device 103 and the space 1290. For example, a function corresponding to (or mapped to, defined for) a specified gesture within the 2D gesture recognition mode may be different from a function corresponding to (or mapped to, defined for) the specified gesture within the third gesture recognition mode. In the 2D gesture recognition mode (or the third gesture recognition mode), the electronic device 101 may identify the gesture by the external input device 103 and execute a function corresponding to (or mapped to, defined for) the gesture. As a non-limiting example, the gesture may include a click, a drag, or a rotation. In the above example, a case of distinguishing between the 2D gesture recognition mode and the third gesture recognition mode is illustrated, but the present disclosure is not limited thereto. For example, the electronic device 101 may operate in a gesture recognition mode, when the button 267 of the external input device 103 is pressed. In the gesture recognition mode, a function corresponding to (or mapped to, defined for) a specific gesture may be executed regardless of the position of the external input device 103.

In the state 1253, the electronic device 101 may recognize a hovering input by the external input device 103, which is positioned within the other reference range 1260 and is spaced from (or not in contact with) the display 110. For example, in the 3D display mode, when it is recognized that the position of the external input device 103 is positioned within the other reference range 1260 in accordance with a movement of the external input device 103, the electronic device 101 may switch (or change, convert) a mode of the electronic device 101 from the 3D display mode to the 2D display mode. The content related to the state 1203 of FIG. 12A may be substantially identically applied to a method of recognizing the hovering input in the 2D display mode.

In the state 1254, the electronic device 101 may recognize an input including contact points by the external input device 103 in contact with the display 110. For example, the electronic device 101 may identify a position 1270 on the display 110 for an input including the contact points according to a change of a magnetic field by the external input device 103. As described above in the state 1253, the electronic device 101 may be in a state where a mode of the electronic device 101 is switched from the 3D display mode to the 2D display mode. The contents related to the state 1204 of FIG. 12A may be substantially identically applied to a method of recognizing the input including the contact points within the 2D display mode.

In the state 1255, the electronic device 101 may identify that a position of the external input device 103 corresponds to (or is mapped to, matches with) recognition positions defined with respect to the 3D image displayed by the electronic device 101. The position of the external input device 103 may be positioned within a reference range (e.g., the reference range 1020 of FIG. 10B) of the space 1290. The reference range may extend from the recognition positions defined with respect to the 3D image. For example, the electronic device 101 may obtain data indicating a movement of the external input device 103, using the at least one camera 220 and/or the at least one sensor 230, while the position of the external input device 103 is positioned within the reference range. For example, the electronic device 101 may identify an input with respect to a 3D image, using data indicating the movement of the external input device 103. For example, the electronic device 101 may execute a function based on the identified input.

As a non-limiting example, the electronic device 101 may execute the function based on pressure information indicating a pressure applied to the external input device 103. For example, the pressure information may indicate a pressure applied to a portion of the external input device 103 at which the pressure sensor 279 of the external input device 103 is positioned, by a body part (e.g., hand) of the user with respect to the external input device 103.

In the 3D display mode, the electronic device 101 may perform operations by recognizing a gesture or a touch input (e.g., a hovering input or an input including contact points) of the external input device 103, using the touch circuitry 300 included in the display 110 of the electronic device 101, the communication circuitry 240, or the at least one camera 220.

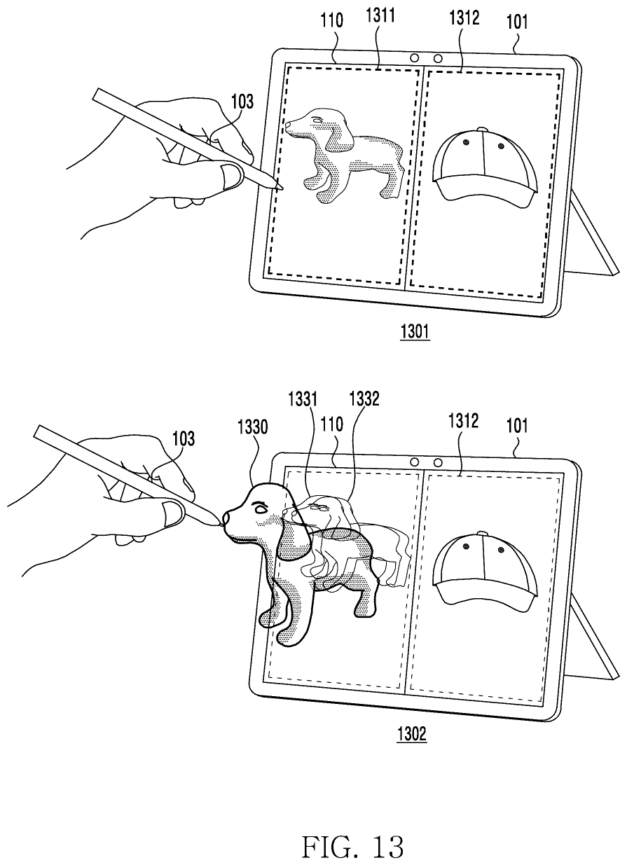

FIG. 13 is a diagram illustrating an example method in which an electronic device displays a 3D image in a split view according to various embodiments.

FIG. 13 illustrates examples 1301 and 1302 of a method for displaying a 3D image while an electronic device 101 displays a plurality of images 1311 and 1312 via a display 110 within a split view. The electronic device 101 of FIG. 13 may be an example of the electronic device 101 of FIG. 2. The external input device 103 of FIG. 13 may be an example of the external input device 103 of FIG. 2.

Referring to FIG. 13, in the split view, the electronic device 101 may display an image 1311 on a first portion among a display region of the display 110, and may display an image 1312 on a second portion among the display region of the display 110. For example, the second portion may be distinguished from the first portion of the display region.

Referring to the example 1301, the electronic device 101 may display the image 1311 and the image 1312 within the split view while the electronic device 101 is in a 2D display mode. For example, the image 1311 may be perceived as being positioned on the display region (or the first portion among the display region) of the display 110, according to the 2D display mode. For example, the image 1312 may be perceived as being positioned on the display region (or the second portion among the display region) of the display 110, according to the 2D display mode.

As a non-limiting example, the electronic device 101 may display an icon for switching between the 3D display mode and the 2D display mode, and may perform switching between the 3D display mode and the 2D display mode of the electronic device 101 according to receiving an input with respect to the icon. However, the present disclosure is not limited thereto. For example, the electronic device 101 may perform switching between the 3D display mode and the 2D display mode of the electronic device 101, by identifying a gesture of the external input device 103 corresponding to (or mapped to, defined for) switching between the 3D display mode and the 2D display mode. As described above in FIG. 12B, the electronic device 101 may switch to the 2D display mode when recognizing a touch input (e.g., a hovering input or an input including contact points) by the external input device 103 in the 3D display mode. In this case, when the touch input by the external input device 103 is terminated and a position of the external input device 103 is moved away from the display 110, the electronic device 101 may switch from the 2D display mode back to the 3D display mode.

Referring to the above description, the electronic device 101 may perform switching between the 3D display mode and the 2D display mode. When the plurality of images 1311 and 1312 are displayed in the display region of the display 110, the electronic device 101 may display some image 1311 as 3D image and maintain displaying a remaining image 1312 as 2D image. In other words, the electronic device 101 may apply a partial 3D display mode. The electronic device 101 may identify an input (or gesture) with respect to a portion to which the 3D display mode is to be applied (e.g., the first portion among the display region of the display 110) and apply the partial 3D display mode to the portion based on the identified input.

Referring to the example 1302, the electronic device 101 may simultaneously display the first image 1331 and the second image 1332 on the first portion among the display region of the display 110. According to simultaneously displaying the first image 1331 and the second image 1332, a 3D image 1330 may be perceived as being positioned within a space above the display 110 (or a space above the first portion among the display region of the display 110). For example, the first image 1331 may be displayed via a portion of first display regions (e.g., the first pixel 321-1 and the third pixel 322-1 included in the first set of pixels of FIG. 3B) of the display 110. The portion of the first display regions may indicate pixels corresponding to the first portion. For example, the second image 1332 may be displayed via a portion of second display regions (e.g., the second pixels 321-2 and the fourth pixels 322-2 included in the second set of pixels of FIG. 3B) of the display 110. The portion of the second display regions may indicate pixels corresponding to the second portion. While the display of the 3D image 1330 is performed, the electronic device 101 may maintain displaying the image 1312 on the second portion among the display region of the display 110.

FIG. 13 illustrates a case where the electronic device 101 displays images 1311 and 1312 within the split view, but the present disclosure is not limited thereto. For example, the method of FIG. 13 may be substantially equally applied to a case where an image is displayed on the display region of the display 110 within a normal screen that is not the split view, and the displayed image includes a plurality of visual objects.

FIG. 14 is a diagram illustrating an example method in which an external input device recognizes a pressure according to various embodiments.

FIG. 14 illustrates examples 1401 and 1402 of a method in which an external input device 103 obtains data indicating a pressure applied to the external input device 103 using a pressure sensor 279 and recognizes the pressure based on the obtained data. The external input device 103 of FIG. 14 may be an example of the external input device 103 of FIG. 2. While the electronic device 101 displays a 3D image perceived as being positioned in a space, since a real object such as the display 110 does not exist in the space, a pen tip 263 of the external input device 103 is not pressed, so the pressure sensor 279 of the external input device 103 may be used.

Referring to the example 1401, the external input device 103 may be in contact with a body part (e.g., hand) 1410 of a user. For example, the user may grip the external input device 103 using the body part 1410. For example, the external input device 103 may obtain data indicating a pressure applied to the external input device 103, using the pressure sensor 279 positioned adjacent to a portion of the external input device 103 that is in contact with the body part 1410. For example, the pressure sensor 279 may include a piezo element, a touch sensor, or a sensor that measures an electrical characteristic (e.g., inductance or resistance).

Referring to the example 1402, the external input device 103 may recognize a pressure 1420 by the body part 1410 with respect to the portion of the external input device 103 on which the pressure sensor 279 is disposed, based on the data obtained using the pressure sensor 279. For example, the pressure 1420 may be changed according to a strength with which the user grips the external input device 103 via the body part 1410.

Although not illustrated in FIG. 14, the external input device 103 may transmit pressure information indicating the pressure 1420 to the electronic device 101. For example, the electronic device 101 may identify the pressure 1420 of the input with respect to the 3D image, based on the pressure information indicating the pressure 1420. As described above, the electronic device 101 may perform a function in accordance with the input with respect to the 3D image, based on the pressure 1420 used as a pen pressure. As a non-limiting example, the function may include adjusting a visual effect (e.g., line thickness) indicating a change in an image according to the input of the external input device 103, in accordance with the pressure 1420. As a non-limiting example, the function may include a rotation (e.g., a rotation from left to right) of the 3D image when the pressure 1420 is being greater than a reference pressure and the input of the external input device 103 is identified as a swipe gesture (e.g., a swipe from left to right). The rotation of the 3D image may indicate a change in a portion of the 3D image that is viewed from a direction in which the user is looking. As a non-limiting example, the function may include a display of an internal image of the 3D image, when the pressure 1420 is being greater than the reference pressure. For example, the internal image of the 3D image may include a portion of the 3D image cut along a surface corresponding to the position of the external input device 103.

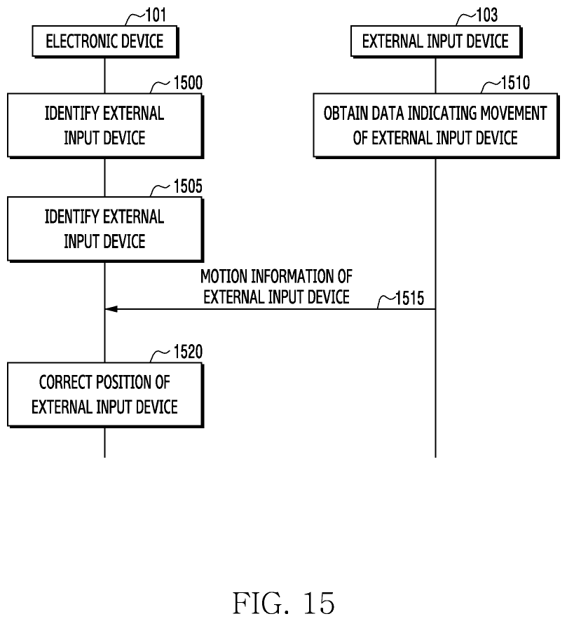

FIG. 15 is a signal flow diagram illustrating an example method of correcting a position of an external input device as an electronic device receives motion information from the external input device according to various embodiments.

FIG. 15 illustrates an example of a signal flow for a method in which an electronic device 101 identifies a position of an external input device 103 and corrects the identified position of the external input device 103 based on motion information received from the external input device 103. The electronic device 101 of FIG. 15 may be an example of the electronic device 101 of FIG. 2. The external input device 103 of FIG. 15 may be an example of the external input device 103 of FIG. 2.

In operation 1500, the electronic device 101 may identify the external input device 103. For example, the electronic device 101 may identify whether the external input device 103 exists. As a non-limiting example, the electronic device 101 may identify whether the external input device 103 exists, using a at least one camera 220, at least one sensor 230, or communication circuitry 240. In an example, the electronic device 101 may identify that the external input device 103 exists, based on a connection being established with the external input device 103, using the communication circuitry 240. The electronic device 101 may identify whether the external input device 103 exists periodically (or aperiodically, or according to a specified event), when the electronic device 101 identifies that the external input device 103 does not exist.

In operation 1505, the electronic device 101 may identify a position of the external input device 103. For example, the electronic device 101 may identify the position of the external input device 103 using the at least one camera 220 or the at least one sensor 230. Specific details related thereto may be referred to operation 640 of FIG. 6. In addition, although not illustrated in FIG. 15, the electronic device 101 may identify a reference position of the electronic device 101 (or the display 110) and a space above the display 110 defined from the reference position. Specific details related thereto may be referred to operation 630 of FIG. 6.

In operation 1510, the external input device 103 may obtain data indicating a movement of the external input device 103. For example, the external input device 103 may obtain the data indicating the movement, using the motion sensor 275.

As a non-limiting example, the external input device 103 may generate motion information of the external input device 103 by processing the data. For example, the motion information may include a position, a movement, or a slope (or posture) of the external input device 103.

In operation 1515, the electronic device 101 may receive the motion information of the external input device 103 from the external input device 103. In an example, the external input device 103 may periodically transmit the motion information to the electronic device 101, or transmit the motion information to the electronic device 101 according to a specified event (e.g., a request received from the electronic device 101).

In the example of FIG. 15, the motion information generated by the external input device 103 is illustrated as being transmitted from the external input device 103 to the electronic device 101, but the present disclosure is not limited thereto. For example, the external input device 103 may transmit the data indicating the movement to the electronic device 101, and the electronic device 101 may generate the motion information based on the received data indicating the movement.

In operation 1520, the electronic device 101 may correct a position of the external input device 103. For example, the electronic device 101 may correct the position of the external input device 103 identified in operation 1505, based on the motion information. Correcting the position may include correcting a coordinate corresponding to the identified position to a new coordinate.

As a non-limiting example, the electronic device 101 may predict a movement of the external input device 103, based on the motion information. In an example, the electronic device 101 may identify a position of the external input device 103 in accordance with the predicted movement.

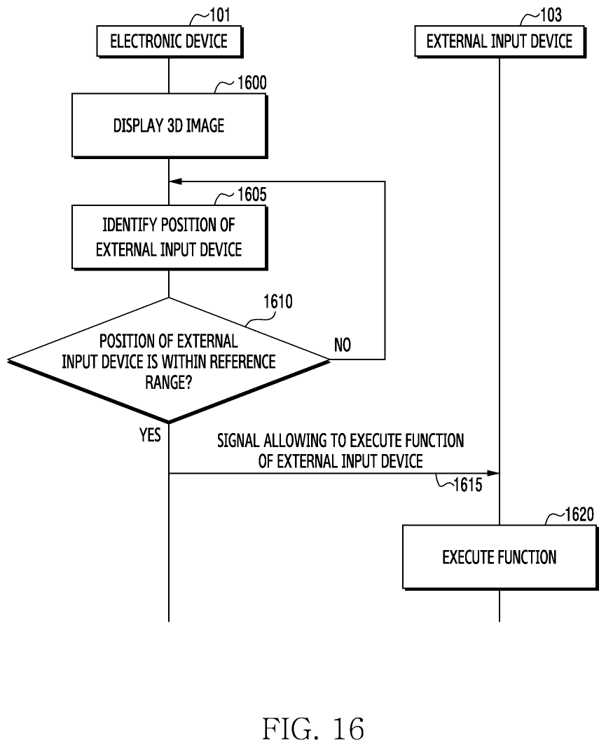

FIG. 16 is a signal flow illustrating an example method in which an electronic device transmits, to an external input device, a signal allowing to execute a function in accordance with a comparison of a position of the external input device with a reference range according to various embodiments.

FIG. 16 illustrates an example of a signal flow for a method in which an electronic device 101 transmits a signal allowing to execute a function to an external input device 103, based on a comparison between a position of the external input device 103 and a reference range. The electronic device 101 of FIG. 16 may be an example of the electronic device 101 of FIG. 2. The external input device 103 of FIG. 16 may be an example of the external input device 103 of FIG. 2.

In operation 1600, the electronic device 101 may display a 3D image. As a non-limiting example, the electronic device 101 may display the 3D image, based on the execution of a 3D display mode. For example, the electronic device 101 may simultaneously display, via the display 110, the plurality of images generated to display the 3D image. When the plurality of images include a first image and a second image, the electronic device 101 may display the first image via first display regions of the display 110 and display the second image via second display regions of the display 110. Details related thereto may be referred to in FIG. 3B and FIG. 5 described above. As a non-limiting example, each of the first image and the second image may be an image including the same visual object.

In operation 1605, the electronic device 101 may identify a position of the external input device 103. For example, the electronic device 101 may identify the position of the external input device 103 using at least one camera 220 or at least one sensor 230. Specific details related thereto may be referred to operation 640 of FIG. 6. In addition, although not illustrated in FIG. 16, the electronic device 101 may identify a reference position of the electronic device 101 (or the display 110) and a space above the display 110 defined from the reference position. Specific details related thereto may be referred to operation 630 of FIG. 6.

In operation 1610, the electronic device 101 may determine whether the position of the external input device 103 is within the reference range. Details related to a method for determining whether the position of the external input device 103 is within the reference range may be referred to in FIGS. 10A and 10B described above. In operation 1610, the electronic device 101 may execute operation 1615, when the position is within the reference range. In contrast, in operation 1610, the electronic device 101 may execute operation 1605, when the position is outside the reference range.

In operation 1615, the electronic device 101 may transmit a signal allowing to execute a function of the external input device 103. For example, the electronic device 101 may transmit the signal allowing to execute the function of the external input device 103 via the communication circuitry 240, when the position is within the reference range. The signal may be transmitted via the communication circuitry 240 using a communication technique such as BT (or BLE).

Although not illustrated in FIG. 16, the electronic device 101 may also directly provide feedback using an output device (e.g., speaker, actuator, emitter) of the electronic device 101, when the position is within the reference range.

In operation 1620, the external input device 103 may execute a function. For example, the external input device 103 may execute the function, based on receiving the signal. For example, the function executed by the external input device 103 may include providing feedback. For example, the feedback may include at least one of tactile feedback, auditory feedback, or visual feedback. Examples of the feedback as the function executed by the external input device 103 may be referred to in FIGS. 11A, 11B and 11C described above.

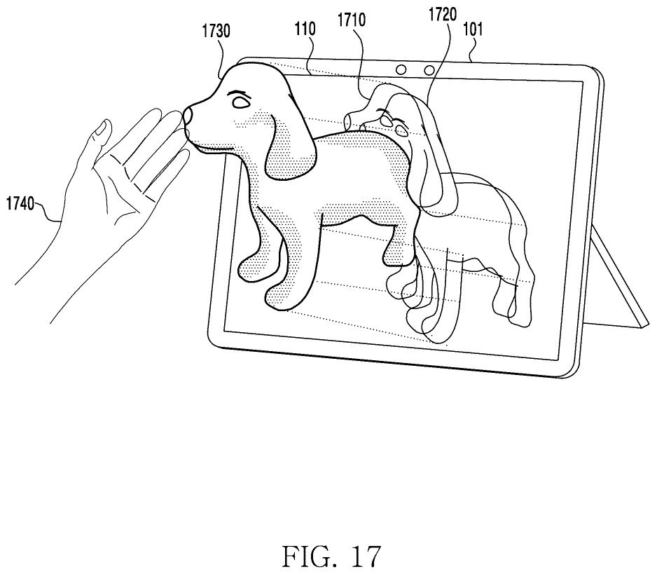

FIG. 17 is a diagram illustrating an example method in which an electronic device recognizes an input by an external object with respect to a 3D image displayed via a display according to various embodiments.

FIG. 17 illustrates an example of a method in which an electronic device 101 recognizes an input by an external object 1740 with respect to a 3D image 1730 while displaying the 3D image 1730, by displaying a plurality of images 1710 and 1720 via a display 110. The electronic device 101 of FIG. 17 may be an example of the electronic device 101 of FIG. 2.

For example, the electronic device 101 may display a first image 1710 via first display regions of the display 110 and may display a second image 1720 via second display regions of the display 110. Specific details related thereto may be referred to in FIG. 3B and FIG. 5 described above. As a non-limiting example, each of the first image 1710 and the second image 1720 may be an image including the same visual object (e.g., puppy).

Referring to FIG. 17, the electronic device 101 may identify a position of an external object 1740. The external object 1740 may be a body part (e.g., hand) of a user. However, the present disclosure is not limited thereto. For example, the external object 1740 may include an electronic pen for which a connection with the electronic device 101 is not established, pen, or stick. For example, the electronic device 101 may identify the position of the external object 1740, using at least one camera 220 or at least one sensor 230.

Although not illustrated in FIG. 17, the electronic device 101 may identify a reference position of the electronic device 101 (or the display 110) and a space above the display 110 defined from the reference position. Specific details related thereto may be referred to operation 630 of FIG. 6. For example, the electronic device 101 may identify that the external object 1740 exists within the space, and identify a position of the external object 1740 within the space.

The electronic device 101 may provide feedback in accordance with a comparison of the position of the external object 1740 with the reference range. For example, the feedback may be used to notify that the external object 1740 is adjacent to the 3D image 1730, when the position of the external object 1740 is positioned within the reference range. As a non-limiting example, when the position of the external object 1740 is positioned within the reference range, the electronic device 101 may display notification information indicating that the external object 1740 is adjacent to the 3D image 1730, via the display 110. As a non-limiting example, when the position of the external object 1740 is positioned within the reference range, the electronic device 101 may output sound of a specified band (e.g., ultrasound) via speakers (or piezo elements) of the electronic device 101, in order to recognize vibration in the external object 1740. For example, sound output via speakers (or piezo elements) may generate vibrations in the external object 1740 by causing air within an area adjacent to the external object 1740 to compress and expand. As a non-limiting example, when the position of the external object 1740 is positioned within the reference range, the electronic device 101 may output a sound indicating that the external object 1740 is adjacent to the 3D image 1730 via the display 110 via speakers (or piezo elements).

The electronic device 101 may identify an input with respect to the 3D image 1730 by the external object 1740, and execute a function according to the input. For example, the function executed by the electronic device 101 may include changing the 3D image 1730 being displayed.

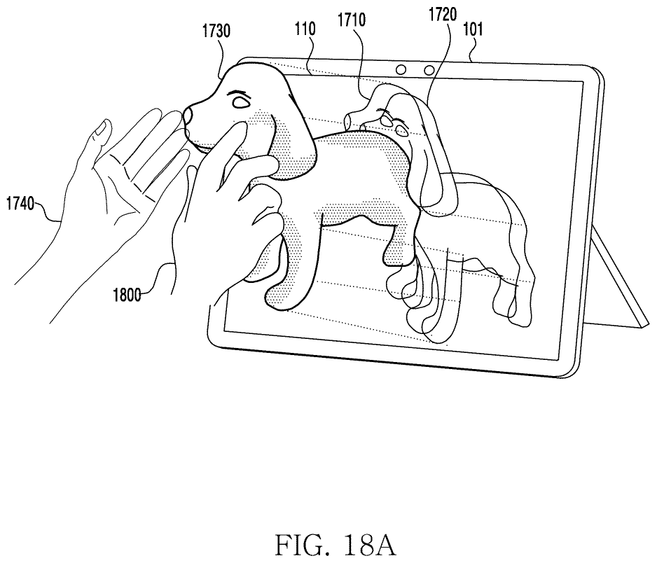

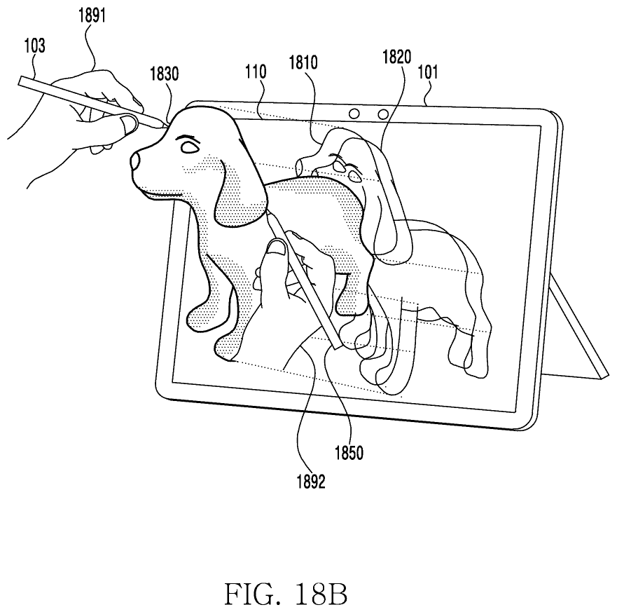

In FIGS. 2 to 17, a method in which the electronic device 101 identifies a position of one input device (e.g., the external input device 103 or the external object 1740) or recognizes an input with respect to a 3D image by the one input device is described, but the present disclosure is not limited thereto. For example, the electronic device 101 may identify positions of a plurality of input devices and recognize an input with respect to a 3D image by the plurality of input devices. Details related thereto may be referred to in FIG. 18A and FIG. 18B below.

FIGS. 18A and 18B are diagrams illustrating an example method in which an electronic device recognizes a plurality of inputs with respect to a 3D image displayed via a display according to various embodiments.

FIG. 18A illustrates an example of a method in which an electronic device 101 recognizes an input by external objects 1740 and 1800 with respect to a 3D image 1730, while displaying a 3D image 1730, by displaying a plurality of images 1710 and 1720 via a display 110, as in the example of FIG. 17. The electronic device 101 of FIG. 18 may be an example of the electronic device 101 of FIG. 2.

Referring to FIG. 18A, the electronic device 101 may identify a position of each of the external object 1740 and the external object 1800. For example, the external object 1740 may be a body part (e.g., left hand) of a user, and the external object 1800 may be another body part (e.g., right hand) of the user. However, the present disclosure is not limited thereto. For example, the external object 1740 may be a body part of a first user, and the external object 1800 may be a body part of a second user. For example, the external object 1740 may be a body part of the user, and the external object 1800 may be a stick gripped by the user.

For example, the electronic device 101 may identify the position of the external object 1740 and the position of the external object 1800, using at least one camera 220 or at least one sensor 230.

The electronic device 101 may identify a reference position of the electronic device 101 (or the display 110) and a space above the display 110 defined from the reference position. Details related thereto may be referred to operation 630 of FIG. 6. For example, the electronic device 101 may identify that the external object 1740 and/or the external object 1800 exist within the space, and identify the position of the external object 1740 and/or the position of the external object 1800 within the space. As a non-limiting example, the electronic device 101 may provide feedback, when at least one of the position of the external object 1740 or the position of the external object 1800 is positioned within the reference range.

FIG. 18B illustrates an example of a method in which the electronic device 101 recognizes an input by the external input devices 103 and 1850 with respect to the 3D image 1830, while displaying the 3D image 1830, by displaying a plurality of images 1810 and 1820 via the display 110. The electronic device 101 of FIG. 18B may be an example of the electronic device 101 of FIG. 2. The external input devices 103 and 1850 of FIG. 18B may be an example of the external input device 103 of FIG. 2.

Referring to FIG. 18B, the electronic device 101 may identify a position of each of the external input device 103 and the external input device 1850. For example, the external input device 103 may be in contact with (or gripped by) a body part 1891 (e.g., left hand) of the user, and the external input device 1850 may be in contact with (or gripped by) another body part 1892 (e.g., right hand) of the user. However, the present disclosure is not limited thereto. For example, the external input device 103 may be in contact with (or gripped by) a body part 1891 (e.g., hand) of a first user, and the external input device 1850 may be in contact with (or gripped by) a body part 1892 (e.g., hand) of a second user.

For example, the electronic device 101 may identify the position of the external input device 103 and the position of the external input device 1850, using the at least one camera 220 or the at least one sensor 230. Details related thereto may be referred to operation 640 of FIG. 6.

The electronic device 101 may identify a reference position of the electronic device 101 (or the display 110) and a space above the display 110 defined from the reference position. Details related thereto may be referred to operation 630 of FIG. 6.

For example, the electronic device 101 may identify that the external input devices 103 and 1850 exist within the space, and identify the position of the external input device 103 and/or the position of the external input device 1850 within the space As a non-limiting example, the electronic device 101 may provide feedback, when at least one of the position of the external input device 103 and the position of the external input device 1850 is positioned within the reference range.

Referring to FIGS. 2 to 18B, the present disclosure describes a case where the electronic device 101 displays a 3D image via the display 110 (or lenticular display), but the present disclosure is not limited thereto. For example, the present disclosure may be substantially equally applied to the electronic device 101 that includes (or uses) a display (or image player) supporting holography.

In addition, referring to FIGS. 2 to 18B, the present disclosure describes a case in which the electronic device 101 identifies a position of the external input device 103 (or external object) using the at least one camera 220 or the at least one sensor 230, and recognizes an input according to a relationship between the position of the external input device 103 and a position (or recognition positions) of a 3D image being displayed, but the present disclosure is not limited thereto. For example, the present disclosure may recognize a 3D image input using gaze information of a user using the external input device 103 (or having a body part in contact with the external input device 103). For example, the electronic device 101 may identify a user who grips the external input device 103 connected via the communication circuitry 240 using the at least one camera 220 or the at least one sensor 230. For example, the electronic device 101 may identify the user's gaze information (or a direction of gaze) and identify a position that the user is looking at as a position of the external input device 103 based on the gaze information. Hereinafter, for convenience of explanation, it is assumed that the position that the user is looking at (or position of the user's gaze direction) corresponds to (or is mapped to, matches) a position (or recognition positions) of the 3D image. At this time, the external input device 103 may be positioned outside a space where the 3D image is perceived as being positioned. In other words, the electronic device 101 may not recognize the external input device 103 using the at least one camera 220. The user may move the external input device 103, which is positioned outside the space. The electronic device 101 may receive motion information indicating a movement of the external input device 103 from the external input device 103 via the communication circuitry 240. The electronic device 101 may recognize it as an input with respect to the 3D image identified at the position viewed by the user, based on the motion information indicating the movement of the external input device 103.

FIG. 19 is a block diagram illustrating an example electronic device 1901 in a network environment 1900 according to various embodiments.

Referring to FIG. 19, the electronic device 1901 in the network environment 1900 may communicate with an electronic device 1902 via a first network 1998 (e.g., a short-range wireless communication network), or at least one of an electronic device 1904 or a server 1908 via a second network 1999 (e.g., a long-range wireless communication network). According to an embodiment, the electronic device 1901 may communicate with the electronic device 1904 via the server 1908. According to an embodiment, the electronic device 1901 may include a processor 1920, memory 1930, an input module 1950, a sound output module 1955, a display module 1960, an audio module 1970, a sensor module 1976, an interface 1977, a connecting terminal 1978, a haptic module 1979, a camera module 1980, a power management module 1988, a battery 1989, a communication module 1990, a subscriber identification module (SIM) 1996, or an antenna module 1997. In various embodiments, at least one of the components (e.g., the connecting terminal 1978) may be omitted from the electronic device 1901, or one or more other components may be added in the electronic device 1901. In various embodiments, some of the components (e.g., the sensor module 1976, the camera module 1980, or the antenna module 1997) may be implemented as a single component (e.g., the display module 1960).

The processor 1920 may execute, for example, software (e.g., a program 1940) to control at least one other component (e.g., a hardware or software component) of the electronic device 1901 coupled with the processor 1920, and may perform various data processing or computation. According to an embodiment, as at least part of the data processing or computation, the processor 1920 may store a command or data received from another component (e.g., the sensor module 1976 or the communication module 1990) in volatile memory 1932, process the command or the data stored in the volatile memory 1932, and store resulting data in non-volatile memory 1934. According to an embodiment, the processor 1920 may include a main processor 1921 (e.g., a central processing unit (CPU) or an application processor (AP)), or an auxiliary processor 1923 (e.g., a graphics processing unit (GPU), a neural processing unit (NPU), an image signal processor (ISP), a sensor hub processor, or a communication processor (CP)) that is operable independently from, or in conjunction with, the main processor 1921. For example, when the electronic device 1901 includes the main processor 1921 and the auxiliary processor 1923, the auxiliary processor 1923 may be adapted to consume less power than the main processor 1921, or to be specific to a specified function. The auxiliary processor 1923 may be implemented as separate from, or as part of the main processor 1921. Thus, the processor 1920 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 1923 may control at least some of functions or states related to at least one component (e.g., the display module 1960, the sensor module 1976, or the communication module 1990) among the components of the electronic device 1901, instead of the main processor 1921 while the main processor 1921 is in an inactive (e.g., sleep) state, or together with the main processor 1921 while the main processor 1921 is in an active state (e.g., executing an application). According to an embodiment, the auxiliary processor 1923 (e.g., an image signal processor or a communication processor) may be implemented as part of another component (e.g., the camera module 1980 or the communication module 1990) functionally related to the auxiliary processor 1923. According to an embodiment, the auxiliary processor 1923 (e.g., the neural processing unit) may include a hardware structure specified for artificial intelligence model processing. An artificial intelligence model may be generated by machine learning. Such learning may be performed, e.g., by the electronic device 1901 where the artificial intelligence is performed or via a separate server (e.g., the server 1908). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1930 may store various data used by at least one component (e.g., the processor 1920 or the sensor module 1976) of the electronic device 1901. The various data may include, for example, software (e.g., the program 1940) and input data or output data for a command related thereto. The memory 1930 may include the volatile memory 1932 or the non-volatile memory 1934.

The program 1940 may be stored in the memory 1930 as software, and may include, for example, an operating system (OS) 1942, middleware 1944, or an application 1946.

The input module 1950 may receive a command or data to be used by another component (e.g., the processor 1920) of the electronic device 1901, from the outside (e.g., a user) of the electronic device 1901. The input module 1950 may include, for example, a microphone, a mouse, a keyboard, a key (e.g., a button), or a digital pen (e.g., a stylus pen).

The sound output module 1955 may output sound signals to the outside of the electronic device 1901. The sound output module 1955 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1960 may visually provide information to the outside (e.g., a user) of the electronic device 1901. The display module 1960 may include, for example, a display, a hologram device, or a projector and control circuitry to control a corresponding one of the display, hologram device, and projector. According to an embodiment, the display module 1960 may include a touch sensor adapted to detect a touch, or a pressure sensor adapted to measure the intensity of force incurred by the touch.

The audio module 1970 may convert a sound into an electrical signal and vice versa. According to an embodiment, the audio module 1970 may obtain the sound via the input module 1950, or output the sound via the sound output module 1955 or a headphone of an external electronic device (e.g., an electronic device 1902) directly (e.g., wiredly) or wirelessly coupled with the electronic device 1901.

The sensor module 1976 may detect an operational state (e.g., power or temperature) of the electronic device 1901 or an environmental state (e.g., a state of a user) external to the electronic device 1901, and then generate an electrical signal or data value corresponding to the detected state. According to an embodiment, the sensor module 1976 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1977 may support one or more specified protocols to be used for the electronic device 1901 to be coupled with the external electronic device (e.g., the electronic device 1902) directly (e.g., wiredly) or wirelessly. According to an embodiment, the interface 1977 may include, for example, a high definition multimedia interface (HDMI), a universal serial bus (USB) interface, a secure digital (SD) card interface, or an audio interface.

A connecting terminal 1978 may include a connector via which the electronic device 1901 may be physically connected with the external electronic device (e.g., the electronic device 1902). According to an embodiment, the connecting terminal 1978 may include, for example, an HDMI connector, a USB connector, a SD card connector, or an audio connector (e.g., a headphone connector).

The haptic module 1979 may convert an electrical signal into a mechanical stimulus (e.g., a vibration or a movement) or electrical stimulus which may be recognized by a user via his tactile sensation or kinesthetic sensation. According to an embodiment, the haptic module 1979 may include, for example, a motor, a piezoelectric element, or an electric stimulator.

The camera module 1980 may capture a still image or moving images. According to an embodiment, the camera module 1980 may include one or more lenses, image sensors, image signal processors, or flashes.

The power management module 1988 may manage power supplied to the electronic device 1901. According to an embodiment, the power management module 1988 may be implemented as at least part of, for example, a power management integrated circuit (PMIC).

The battery 1989 may supply power to at least one component of the electronic device 1901. According to an embodiment, the battery 1989 may include, for example, a primary cell which is not rechargeable, a secondary cell which is rechargeable, or a fuel cell.

The communication module 1990 may support establishing a direct (e.g., wired) communication channel or a wireless communication channel between the electronic device 1901 and the external electronic device (e.g., the electronic device 1902, the electronic device 1904, or the server 1908) and performing communication via the established communication channel. The communication module 1990 may include one or more communication processors that are operable independently from the processor 1920 (e.g., the application processor (AP)) and supports a direct (e.g., wired) communication or a wireless communication. According to an embodiment, the communication module 1990 may include a wireless communication module 1992 (e.g., a cellular communication module, a short-range wireless communication module, or a global navigation satellite system (GNSS) communication module) or a wired communication module 1994 (e.g., a local area network (LAN) communication module or a power line communication (PLC) module). A corresponding one of these communication modules may communicate with the external electronic device via the first network 1998 (e.g., a short-range communication network, such as Bluetooth™, wireless-fidelity (Wi-Fi) direct, or infrared data association (IrDA)) or the second network 1999 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1992 may identify and authenticate the electronic device 1901 in a communication network, such as the first network 1998 or the second network 1999, using subscriber information (e.g., international mobile subscriber identity (IMSI)) stored in the subscriber identification module 1996.

The wireless communication module 1992 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1992 may support a high-frequency band (e.g., the mmWave band) to achieve, e.g., a high data transmission rate. The wireless communication module 1992 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1992 may support various requirements specified in the electronic device 1901, an external electronic device (e.g., the electronic device 1904), or a network system (e.g., the second network 1999). According to an embodiment, the wireless communication module 1992 may support a peak data rate (e.g., 20 Gbps or more) for implementing eMBB, loss coverage (e.g., 1964 dB or less) for implementing mMTC, or U-plane latency (e.g., 0.5 ms or less for each of downlink (DL) and uplink (UL), or a round trip of 19 ms or less) for implementing URLLC.

The antenna module 1997 may transmit or receive a signal or power to or from the outside (e.g., the external electronic device) of the electronic device 1901. According to an embodiment, the antenna module 1997 may include an antenna including a radiating element including a conductive material or a conductive pattern formed in or on a substrate (e.g., a printed circuit board (PCB)). According to an embodiment, the antenna module 1997 may include a plurality of antennas (e.g., array antennas). In such a case, at least one antenna appropriate for a communication scheme used in the communication network, such as the first network 1998 or the second network 1999, may be selected, for example, by the communication module 1990 (e.g., the wireless communication module 1992) from the plurality of antennas. The signal or the power may then be transmitted or received between the communication module 1990 and the external electronic device via the selected at least one antenna. According to an embodiment, another component (e.g., a radio frequency integrated circuit (RFIC)) other than the radiating element may be additionally formed as part of the antenna module 1997.

According to various embodiments, the antenna module 1997 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1901 and the external electronic device 1904 via the server 1908 coupled with the second network 1999. Each of the electronic devices 1902 or 1904 may be a device of a same type as, or a different type, from the electronic device 1901. According to an embodiment, all or some of operations to be executed at the electronic device 1901 may be executed at one or more of the external electronic devices 1902, 1904, or 1908. For example, if the electronic device 1901 should perform a function or a service automatically, or in response to a request from a user or another device, the electronic device 1901, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1901. The electronic device 1901 may provide the outcome, with or without further processing of the outcome, as at least part of a reply to the request. To that end, a cloud computing, distributed computing, mobile edge computing (MEC), or client-server computing technology may be used, for example. The electronic device 1901 may provide ultra low-latency services using, e.g., distributed computing or mobile edge computing. In an embodiment, the external electronic device 1904 may include an internet-of-things (IoT) device. The server 1908 may be an intelligent server using machine learning and/or a neural network. According to an embodiment, the external electronic device 1904 or the server 1908 may be included in the second network 1999. The electronic device 1901 may be applied to intelligent services (e.g., smart home, smart city, smart car, or healthcare) based on 5G communication technology or IoT-related technology.

The technical problems to be achieved in this document are not limited to those described above, and other technical problems not mentioned herein will be clearly understood by those having ordinary knowledge in the art to which the present disclosure belongs, from the following description.

As described above, an electronic device 101 may comprise at least one camera 220. The electronic device 101 may comprise at least one sensor 230. The electronic device 101 may comprise communication circuitry 240. The electronic device 101 may comprise a display 110 including first display regions and second display regions. The first display regions and the second display regions may alternate with each other. The electronic device 101 may comprise at least one processor 210 including processing circuitry. The electronic device 101 may comprise memory 250, comprising one or more storage media, storing instructions. The instructions, when executed by the at least one processor 210 individually or collectively, may cause the electronic device 101 to, based on execution of a three-dimensional (3D) display mode of the electronic device 101, concurrently display a first image including a visual object via the first display regions of the display 110 and a second image including the visual object via the second display regions of the display 110 such that the visual object is perceived as being positioned in a space above the display 110. The instructions, when executed by the at least one processor 210 individually or collectively, may cause the electronic device 101 to, based on data obtained using the at least one camera 220 or the at least one sensor 230, identify a position of an external input device 103 connected via the communication circuitry 240 in the space. The instructions, when executed by the at least one processor 210 individually or collectively, may cause the electronic device 101 to, based on the position within a reference range defined with respect to the visual object in the space, transmit, to the external input device 103 via the communication circuitry 240, a signal allowing to execute a function of the external input device 103.

According to an embodiment, the instructions, when executed by the at least one processor 210 individually or collectively, may cause the electronic device 101 to, while concurrently displaying the first image and the second image, obtain the data using the at least one camera 220 or the at least one sensor 230. The instructions, when executed by the at least one processor 210 individually or collectively, may cause the electronic device 101 to, based on the data, identify the position of the external input device 103 defined with respect to a reference position of the display 110.

According to an embodiment, the at least one sensor 230 may include an accelerometer or a gyro sensor. The instructions, when executed by the at least one processor 210 individually or collectively, may cause the electronic device 101 to obtain other data indicating a posture (or orientation) of the electronic device 101 using the at least one sensor 230. The instructions, when executed by the at least one processor 210 individually or collectively, may cause the electronic device 101 to, based on the other data indicating the posture of the electronic device 101, identify the reference position of the display 110 in accordance with the posture of the electronic device 101. The space may be defined from the reference position of the display 110.

According to an embodiment, the at least one camera 220 may include a first camera and a second camera disposed toward the space. The instructions, when executed by the at least one processor 210 individually or collectively, may cause the electronic device 101 to, for obtaining the data using the at least one camera 220 or the at least one sensor 230, obtain, using the first camera, first image data including a virtual object representing the external input device 103 in accordance with a field of view (FoV) of the first camera. The instructions, when executed by the at least one processor 210 individually or collectively, may cause the electronic device 101 to, for obtaining the data using the at least one camera 220 or the at least one sensor 230, obtain, using the second camera, second image data including the virtual object representing the external input device 103 in accordance with a FoV of the second camera. The instructions, when executed by the at least one processor 210 individually or collectively, may cause the electronic device 101 to, based on the first image data, the second image data, and a distance between the first camera and the second camera, identify the position of the external input device 103 in the space.

According to an embodiment, the position of the external input device 103 in the space may indicate a point of the external input device 103. The first image data may include first angles defining the point of the external input device 103 with respect to the first camera. The second image data may include second angles defining the point of the external input device 103 with respect to the second camera.

According to an embodiment, the first image data may further include third angles defining another point of the external input device 103 with respect to the first camera. The second image data may further include fourth angles defining the other point of the external input device 103 with respect to the second camera. wherein the instructions, when executed by the at least one processor 210 individually or collectively, cause the electronic device 101 to, based on the first angles, the second angles, the third angles, and the fourth angles, obtain motion information of the external input device 103. The instructions, when executed by the at least one processor 210 individually or collectively, may cause the electronic device 101 to, based on the motion information of the external input device 103, correct the position of the external input device 103 in the space. The instructions, when executed by the at least one processor 210 individually or collectively, may cause the electronic device 101 to, based on the corrected position within the reference position defined with respect to the visual object in the space, transmit, to the external input device 103 via the communication circuitry 240, the signal.

According to an embodiment, the instructions, when executed by the at least one processor 210 individually or collectively, may cause the electronic device 101 to receive, from the external input device 103 via the communication circuitry 240, motion information of the external input device 103. The instructions, when executed by the at least one processor 210 individually or collectively, may cause the electronic device 101 to, based on the motion information of the external input device 103, correct the position of the external input device 103 in the space. The instructions, when executed by the at least one processor 210 individually or collectively, may cause the electronic device 101 to, based on the corrected position within the reference position defined with respect to the visual object in the space, transmit, to the external input device 103 via the communication circuitry 240, the signal.

According to an embodiment, the at least one camera 220 may include a camera disposed toward the space. The instructions, when executed by the at least one processor 210 individually or collectively, may cause the electronic device 101 to, for obtaining the data using the at least one camera 220 or the at least one sensor 230, obtain, using the camera, first image data including a virtual object representing the external input device 103 in accordance with a field of view (FoV) of the camera. The instructions, when executed by the at least one processor 210 individually or collectively, may cause the electronic device 101 to, for obtaining the data using the at least one camera 220 or the at least one sensor 230, after obtaining the first image data, obtain, using the camera, second image data including the virtual object representing the external input device 103 in accordance with the FoV of the camera. The instructions, when executed by the at least one processor 210 individually or collectively, may cause the electronic device 101 to, based on a change of a size of the virtual object identified based on the first image data and the second image data, identify the position of the external input device 103 in the space.

According to an embodiment, the instructions, when executed by the at least one processor 210 individually or collectively, may cause the electronic device 101 to, for obtaining the data using the at least one camera 220 or the at least one sensor 230, obtain, using the at least one camera 220, other data indicating a light emitted through an infrared ray (IR) sensor of the external input device 103. The instructions, when executed by the at least one processor 210 individually or collectively, may cause the electronic device 101 to, based on the other data, identify the position of the external input device 103 in the space.

According to an embodiment, the instructions, when executed by the at least one processor 210 individually or collectively, may cause the electronic device 101 to obtain an original image including the visual object. The instructions, when executed by the at least one processor 210 individually or collectively, may cause the electronic device 101 to obtain depth information for the original image. The instructions, when executed by the at least one processor 210 individually or collectively, may cause the electronic device 101 to generate the first image and the second image from the original image using the depth information.

According to an embodiment, the instructions, when executed by the at least one processor 210 individually or collectively, may cause the electronic device 101 to, based on the depth information, identify recognition positions of the visual object to be perceived as being positioned in the space when the first image and the second image are displayed. The instructions, when executed by the at least one processor 210 individually or collectively, may cause the electronic device 101 to identify the reference range extended from the recognition positions of the visual object.

According to an embodiment, the instructions, when executed by the at least one processor 210 individually or collectively, may cause the electronic device 101 to, before the execution of the 3D display mode of the electronic device 101, display, via the display 110, a third image including the visual object. The third image may be perceived as being positioned on the display 110.

According to an embodiment, the instructions, when executed by the at least one processor 210 individually or collectively, may cause the electronic device 101 to, while the position of the external input device 103 is within the reference range defined with respect to the visual object in the space, obtain, using the at least one camera 220 or the at least one sensor 230, other data indicating a movement of the external input device 103. The instructions, when executed by the at least one processor 210 individually or collectively, may cause the electronic device 101 to, while the position of the external input device 103 is within the reference range defined with respect to the visual object in the space, based on the other data indicating the movement of the external input device 103, identify an input with respect to the visual object perceived as being positioned in the space. The instructions, when executed by the at least one processor 210 individually or collectively, may cause the electronic device 101 to, while the position of the external input device 103 is within the reference range defined with respect to the visual object in the space, based on the identified input, execute at least one function.

According to an embodiment, the at least one function may include concurrently displaying a third image including another visual object at least partially changed from the visual object via the first display regions of the display 110 and a fourth image including the other visual object via the second display regions of the display 110 such that the other visual object is perceived as being positioned in the space above the display 110.

According to an embodiment, the instructions, when executed by the at least one processor 210 individually or collectively, may cause the electronic device 101 to receive, from the external input device 103 via the communication circuitry 240, pressure information indicating a pressure applied to the external input device 103. The instructions, when executed by the at least one processor 210 individually or collectively, may cause the electronic device 101 to, based on a first change according to the pressure information indicating a first pressure, generate the other visual object from the visual object. The instructions, when executed by the at least one processor 210 individually or collectively, may cause the electronic device 101 to, based on a second change different from the first change according to the pressure information indicating a second pressure different from the first pressure, generate the other visual object from the visual object.

According to an embodiment, the instructions, when executed by the at least one processor 210 individually or collectively, may cause the electronic device 101 to, based on the position of the external input device 103 within another reference range from the display 110, switch a mode of the electronic device 101 from the 3D display mode to a 2D display mode. The instructions, when executed by the at least one processor 210 individually or collectively, may cause the electronic device 101 to, based on the 2D display mode, display, via the display 110, a third image including the visual object such that the visual object is perceived as being positioned on the display 110. The instructions, when executed by the at least one processor 210 individually or collectively, may cause the electronic device 101 to, based on the 2D display mode, recognize a touch input of the external input device 103 using the display 110. The touch input may include at least one of an input including contact points on the display 110 or a hovering input.

According to an embodiment, the instructions, when executed by the at least one processor 210 individually or collectively, may cause the electronic device 101 to receive, via the communication circuitry 240, another signal indicating that a physical button of the external input device 103 has been pressed. The instructions, when executed by the at least one processor 210 individually or collectively, may cause the electronic device 101 to, based on reception of the other signal, obtain other data indicating a movement of the external input device 103 using the at least one camera 220 or the at least one sensor 230. The instructions, when executed by the at least one processor 210 individually or collectively, may cause the electronic device 101 to, based on the other data, execute at least one function according to the movement of the external input device 103.

According to an embodiment, the first image may be displayed at a portion of the first display regions. The second image may be displayed at a portion of the second display regions.

According to an embodiment, the function of the external input device 103 may include at least one of outputting a vibration by an actuator of the external input device 103, outputting a sound by a speaker of the external input device 103, or outputting a light by an emitter of the external input device 103.

According to an embodiment, the electronic device 101 may comprise a tablet personal computer (PC). The external input device 103 may comprise a stylus pen.

As described above, an electronic device 101 may comprise at least one camera 220. The electronic device 101 may comprise a touch sensitive display 110. The electronic device 101 may comprise at least one processor 210 including processing circuitry. The electronic device 101 may comprise memory 250, comprising one or more storage media, storing instructions. The instructions, when executed by the at least one processor 210 individually or collectively, may cause the electronic device 101 to, based on a three-dimensional (3D) display mode of the touch sensitive display 110, for providing a 3D effect image at a space in front of the touch sensitive display 110, display, via the touch sensitive display 110, two images separated from each other. The instructions, when executed by the at least one processor 210 individually or collectively, may cause the electronic device 101 to, based on a position relationship between the electronic device 101 and an eye of a user in front of the electronic device 101, set a spatial range positioned in the space with respect to the 3D effect image. The instructions, when executed by the at least one processor 210 individually or collectively, may cause the electronic device 101 to, while providing the 3D effect image, identify, via the at least one camera 220, whether a specified portion of a stylus pen 103 is moved into the spatial range. The instructions, when executed by the at least one processor 210 individually or collectively, may cause the electronic device 101 to, based on the specified portion of the stylus pen 103 being moved into the spatial range, identify a position of the specified portion of the stylus pen 103 as an input with respect to the 3D effect image.

According to an embodiment, the touch sensitive display 110 may include first display regions and second display regions. The first display regions and the second display regions may alternate with each other. The instructions, when executed by the at least one processor 210 individually or collectively, may cause the electronic device 101 to, for providing the 3D effect image at the space, concurrently display a first image of the two images via the first display regions and a second image of the two images via the second display regions.

According to an embodiment, the instructions, when executed by the at least one processor 210 individually or collectively, may cause the electronic device 101 to, while concurrently displaying the first image and the second image, obtain data usable for identifying the position of the specified portion of the stylus pen 103 in the space. The instructions, when executed by the at least one processor 210 individually or collectively, may cause the electronic device 101 to, based on the data usable for identifying the position of the specified portion of the stylus pen 103, identify the position of the specified portion of the stylus pen 103 in the space in accordance with the position relationship between the electronic device 101 and the eye of the user in front of the electronic device 101. The instructions, when executed by the at least one processor 210 individually or collectively, may cause the electronic device 101 to identify whether the specified portion of the stylus pen 103 is moved into the spatial range in accordance with the position of the specified portion of the stylus pen 103 in the space.

According to an embodiment, the electronic device 101 may comprise at least one sensor 230 including an accelerometer or a gyro sensor. The instructions, when executed by the at least one processor 210 individually or collectively, may cause the electronic device 101 to obtain data usable for identifying a posture of the electronic device 101 via the at least one sensor 230. The instructions, when executed by the at least one processor 210 individually or collectively, may cause the electronic device 101 to, based on the data usable for identifying the posture of the electronic device 101, identify a reference position of the touch sensitive display 110 using the position relationship determined according to the posture of the electronic device 101. The space may be defined from the reference position of the touch sensitive display 110.

According to an embodiment, the at least one camera 220 may include a first camera and a second camera disposed toward the space. The instructions, when executed by the at least one processor 210 individually or collectively, may cause the electronic device 101 to obtain the data usable for identifying the position of the specified portion of the stylus pen 103 in the space, by obtaining, via the first camera, first image data including a virtual object representing the stylus pen 103 in accordance with a field of view (FoV) of the first camera, and obtaining, via the second camera, second image data including the virtual object representing the stylus pen 103 in accordance with a FoV of the second camera. The instructions, when executed by the at least one processor 210 individually or collectively, may cause the electronic device 101 to, based on the first image data, the second image data, and a distance between the first camera and the second camera, identify the position of the specified portion of the stylus pen 103 in the space.

According to an embodiment, the specified portion of the stylus pen 103 in the space may indicate a pen tip 263 of the stylus pen 103. The first image data may include first angles defining the specified portion of the stylus pen 103 with respect to the first camera. The second image data may include second angles defining the specified portion of the stylus pen 103 with respect to the second camera.

According to an embodiment, the electronic device 101 may further comprise communication circuitry 240. The first image data may further include third angles defining another specified portion of the stylus pen 103 with respect to the first camera. The second image data may further include fourth angles defining the other specified portion of the stylus pen 103 with respect to the second camera. The instructions, when executed by the at least one processor 210 individually or collectively, may cause the electronic device 101 to, based on the first angles, the second angles, the third angles, and the fourth angles, obtain motion information of the stylus pen 103. The instructions, when executed by the at least one processor 210 individually or collectively, may cause the electronic device 101 to, based on the motion information of the stylus pen 103, correct the position of the specified portion of the stylus pen 103 in the space. The instructions, when executed by the at least one processor 210 individually or collectively, may cause the electronic device 101 to, in accordance with the corrected position of the specified portion of the stylus pen 103 within the spatial range in the space with respect to the 3D effect image, transmit, to the stylus pen 103 via the communication circuitry 240, a signal allowing to execute a function of the stylus pen 103. The function of the stylus pen 103 may include at least one of outputting a vibration by an actuator 281 of the stylus pen 103, outputting a sound by a speaker 283 of the stylus pen 103, or outputting a light by an emitter 285 of the stylus pen 103.

According to an embodiment, the electronic device 101 may further comprise communication circuitry 240. The instructions, when executed by the at least one processor 210 individually or collectively, may cause the electronic device 101 to receive, from the stylus pen 103 via the communication circuitry 240, motion information of the stylus pen 103. The instructions, when executed by the at least one processor 210 individually or collectively, may cause the electronic device 101 to, based on the motion information of the stylus pen 103, correct the position of the specified portion of the stylus pen 103 in the space. The instructions, when executed by the at least one processor 210 individually or collectively, may cause the electronic device 101 to, in accordance with the corrected position of the specified portion of the stylus pen 103 within the spatial range in the space with respect to the 3D effect image, transmit, to the stylus pen 103 via the communication circuitry 240, a signal allowing to execute a function of the stylus pen 103. The function of the stylus pen 103 may include at least one of outputting a vibration by an actuator 281 of the stylus pen 103, outputting a sound by a speaker 283 of the stylus pen 103, or outputting a light by an emitter 285 of the stylus pen 103.

According to an embodiment, the at least one camera 220 may include a camera disposed toward the space. The instructions, when executed by the at least one processor 210 individually or collectively, may cause the electronic device 101 to obtain the data usable for identifying the position of the specified portion of the stylus pen 103 in the space, by obtaining, via the camera, first image data including a virtual object representing the stylus pen 103 in accordance with a field of view (FoV) of the camera, and after obtaining the first image data, obtaining, via the camera, second image data including the virtual object representing the stylus pen 103 in accordance with the FoV of the camera. The instructions, when executed by the at least one processor 210 individually or collectively, may cause the electronic device 101 to, based on a change of a size of the virtual object identified based on the first image data and the second image data, identify the position of the specified portion of the stylus pen 103 in the space.

According to an embodiment, the instructions, when executed by the at least one processor 210 individually or collectively, may cause the electronic device 101 to obtain the data usable for identifying the position of the specified portion of the stylus pen 103 in the space, by obtaining, via the at least one camera 220, data indicating a light emitted through an infrared ray (IR) sensor of the stylus pen 103. The instructions, when executed by the at least one processor 210 individually or collectively, may cause the electronic device 101 to, based on the data indicating the light emitted through the IR sensor of the stylus pen 103, identify the position of the specified portion of the stylus pen 103 in the space.

According to an embodiment, the instructions, when executed by the at least one processor 210 individually or collectively, may cause the electronic device 101 to obtain an original image for providing the 3D effect image. The instructions, when executed by the at least one processor 210 individually or collectively, may cause the electronic device 101 to obtain depth information for the original image. The instructions, when executed by the at least one processor 210 individually or collectively, may cause the electronic device 101 to generate the first image and the second image from the original image using the depth information.

According to an embodiment, the instructions, when executed by the at least one processor 210 individually or collectively, may cause the electronic device 101 to, based on the depth information, identify recognition positions of the 3D effect image to be perceived as being positioned in the space when the first image and the second image are concurrently displayed. The instructions, when executed by the at least one processor 210 individually or collectively, may cause the electronic device 101 to, in accordance with the position relationship including a direction of the eye with respect to the electronic device 101 and a distance from the electronic device 101 to the eye, set the spatial range, positioned in the space, extended from the recognition positions of the 3D effect image.

According to an embodiment, the instructions, when executed by the at least one processor 210 individually or collectively, may cause the electronic device 101 to, based on a 2D display mode before an execution of the 3D display mode, for providing a 2D effect image on the touch sensitive display 110, display, via the touch sensitive display 110, one image. The 3D effect image may be perceived as being positioned at the space in front of the touch sensitive display 110. The 2D effect image may be perceived as being positioned on the touch sensitive display 110.

According to an embodiment, the instructions, when executed by the at least one processor 210 individually or collectively, may cause the electronic device 101 to, based on the specified portion of the stylus pen 103 being moved into the spatial range, execute at least one function in accordance with the identified input.

According to an embodiment, the at least one function may include displaying, via the touch sensitive display 110, other two images changed from the two images for providing another 3D effect image at least partially changed from the 3D effect image.

According to an embodiment, the electronic device 101 may further comprise communication circuitry 240. The instructions, when executed by the at least one processor 210 individually or collectively, may cause the electronic device 101 to receive, from the stylus pen 103 via the communication circuitry 240, pressure information indicating a pressure applied to the stylus pen 103. The instructions, when executed by the at least one processor 210 individually or collectively, may cause the electronic device 101 to, based on a first change in accordance with the pressure information indicating a first pressure, generate the other 3D effect image from the 3D effect image. The instructions, when executed by the at least one processor 210 individually or collectively, may cause the electronic device 101 to, based on a second change different from the first change in accordance with the pressure information indicating a second pressure different from the first pressure, generate the other 3D effect image from the 3D effect image.

According to an embodiment, the instructions, when executed by the at least one processor 210 individually or collectively, may cause the electronic device 101 to, based on the position of the specified portion of the stylus pen 103 within a reference range in the space from the touch sensitive display 110, switch a mode of the electronic device 101 from the 3D display mode to a 2D display mode. The instructions, when executed by the at least one processor 210 individually or collectively, may cause the electronic device 101 to, based on the 2D display mode, for providing a 2D effect image on the touch sensitive display 110, display, via the touch sensitive display 110, one image. The instructions, when executed by the at least one processor 210 individually or collectively, may cause the electronic device 101 to identify, using the touch sensitive display 110, an input received from the stylus pen 103. The input identified using the touch sensitive display 110 may include at least one of an input including contact points on the touch sensitive display 110 or a hovering input.

According to an embodiment, the electronic device 101 may further comprise communication circuitry 240. The instructions, when executed by the at least one processor 210 individually or collectively, may cause the electronic device 101 to receive, via the communication circuitry 240, a signal indicating that a physical button 267 of the stylus pen 103 has been pressed. The instructions, when executed by the at least one processor 210 individually or collectively, may cause the electronic device 101 to, based on reception of the signal, obtain data usable for identifying the position of the specified portion of the stylus pen 103 via the at least one camera 220. The instructions, when executed by the at least one processor 210 individually or collectively, may cause the electronic device 101 to, based on the data usable for identifying the position of the specified portion of the stylus pen 103, execute at least one function.

As described above, an electronic device 101 may comprise at least one camera 220 configured to obtain an image usable for identifying a distance from the electronic device 101 to an eye and a position of a stylus pen 103 being in conjunction with the electronic device 101. The electronic device 101 may comprise at least one sensor 230 configured to obtain data usable for identifying a direction of the eye with respect to the electronic device 101. The electronic device 101 may comprise a touch sensitive display 110 configured to operate in one of a two-dimensional (2D) display mode and a three-dimensional (3D) display mode. The electronic device 101 may comprise at least one processor 210 including processing circuitry. The electronic device 101 may comprise memory 250, comprising one or more storage media, storing instructions. The instructions, when executed by the at least one processor 210 individually or collectively, may cause the electronic device 101 to, based on the 2D display mode that represents one effect image by displaying, via the touch sensitive display 110, one image, identify, using the touch sensitive display 110, an input received from the stylus pen 103. The instructions, when executed by the at least one processor 210 individually or collectively, may cause the electronic device 101 to, based on the 3D display mode that represents one effect image by displaying, via the touch sensitive display 110, two images separated from each other, identify, using the at least one sensor 230 and the at least one camera 220, an input received from the stylus pen 103.

As described above, a system may comprise an electronic device 101. The system may comprise a stylus pen 103 being in conjunction with the electronic device 101. The electronic device 101 may be configured to, based on a three-dimensional (3D) display mode of the electronic device 101, for providing a 3D effect image at a space in front of the electronic device 101, display two images separated from each other. The electronic device 101 may be configured to, transmit, to the stylus pen 103, a signal to notify the 3D display mode of the electronic device 101. The stylus pen 103 may be configured to obtain data usable for identifying a pressure applied to the stylus pen 103. The stylus pen 103 may be configured to, in response to reception of the signal from the electronic device 101, transmit, to the electronic device 101, pressure information indicating the pressure applied to the stylus pen 103 identified based on the data. The electronic device 101 may be configured to receive, from the stylus pen 103, the pressure information indicating the pressure applied to the stylus pen 103. The electronic device 101 may be configured to identify a position of a specified portion of the stylus pen 103 as an input having the pressure with respect to the 3D effect image.

The effects that can be obtained from the present disclosure are not limited to those described above, and any other effects not mentioned herein will be clearly understood by those having ordinary knowledge in the art to which the present disclosure belongs.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1940) including one or more instructions that are stored in a storage medium (e.g., internal memory 1936 or external memory 1938) that is readable by a machine (e.g., the electronic device 1901). For example, a processor (e.g., the processor 1920) of the machine (e.g., the electronic device 1901) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
at least one camera;
a touch sensitive display;
at least one processor including processing circuitry; and
memory, comprising one or more storage media, storing instructions,
wherein the instructions, when executed by the at least one processor individually or collectively, cause the electronic device to:
based on a three-dimensional (3D) display mode of the touch sensitive display, for providing a 3D effect image at a space in front of the touch sensitive display, display, via the touch sensitive display, two images separated from each other;
based on a position relationship between the electronic device and an eye of a user in front of the electronic device, set a spatial range positioned in the space with respect to the 3D effect image;
while providing the 3D effect image, identify, via the at least one camera, whether a specified portion of a stylus pen is moved into the spatial range; and
based on the specified portion of the stylus pen being moved into the spatial range, identify a position of the specified portion of the stylus pen as an input with respect to the 3D effect image.

2. The electronic device of claim 1,
wherein the touch sensitive display includes first display regions and second display regions, and
wherein the first display regions and the second display regions alternate with each other,
wherein the instructions, when executed by the at least one processor individually or collectively, cause the electronic device to:
for providing the 3D effect image at the space, concurrently display a first image of the two images via the first display regions and a second image of the two images via the second display regions.

3. The electronic device of claim 2,
wherein the instructions, when executed by the at least one processor individually or collectively, cause the electronic device to:
while concurrently displaying the first image and the second image, obtain data usable for identifying the position of the specified portion of the stylus pen in the space;
based on the data usable for identifying the position of the specified portion of the stylus pen, identify the position of the specified portion of the stylus pen in the space in accordance with the position relationship between the electronic device and the eye of the user in front of the electronic device; and
identify whether the specified portion of the stylus pen is moved into the spatial range in accordance with the position of the specified portion of the stylus pen in the space.

4. The electronic device of claim 3,
wherein the electronic device comprises at least one sensor including an accelerometer and/or a gyro sensor,
wherein the instructions, when executed by the at least one processor individually or collectively, cause the electronic device to:
obtain data usable for identifying a posture of the electronic device via the at least one sensor; and
based on the data usable for identifying the posture of the electronic device, identify a reference position of the touch sensitive display using the position relationship determined according to the posture of the electronic device,
wherein the space is defined from the reference position of the touch sensitive display.

5. The electronic device of claim 3,
wherein the at least one camera includes a first camera and a second camera disposed toward the space,
wherein the instructions, when executed by the at least one processor individually or collectively, cause the electronic device to:
obtain the data usable for identifying the position of the specified portion of the stylus pen in the space by:
obtaining, via the first camera, first image data including a virtual object representing the stylus pen in accordance with a field of view (FoV) of the first camera, and
obtaining, via the second camera, second image data including the virtual object representing the stylus pen in accordance with a FoV of the second camera; and
based on the first image data, the second image data, and a distance between the first camera and the second camera, identify the position of the specified portion of the stylus pen in the space.

6. The electronic device of claim 5,
wherein the specified portion of the stylus pen in the space indicates a pen tip of the stylus pen,
wherein the first image data includes first angles defining the specified portion of the stylus pen with respect to the first camera, and
wherein the second image data includes second angles defining the specified portion of the stylus pen with respect to the second camera.

7. The electronic device of claim 6,
wherein the electronic device further comprises communication circuitry,
wherein the first image data further includes third angles defining another specified portion of the stylus pen with respect to the first camera, and
wherein the second image data further includes fourth angles defining the other specified portion of the stylus pen with respect to the second camera,
wherein the instructions, when executed by the at least one processor individually or collectively, cause the electronic device to:
based on the first angles, the second angles, the third angles, and the fourth angles, obtain motion information of the stylus pen;
based on the motion information of the stylus pen, correct the position of the specified portion of the stylus pen in the space; and
in accordance with the corrected position of the specified portion of the stylus pen within the spatial range in the space with respect to the 3D effect image, transmit, to the stylus pen via the communication circuitry, a signal allowing to execute a function of the stylus pen,
wherein the function of the stylus pen includes at least one of outputting a vibration by an actuator of the stylus pen, outputting a sound by a speaker of the stylus pen, and/or outputting a light by an emitter of the stylus pen.

8. The electronic device of claim 6,
wherein the electronic device further comprises communication circuitry,
wherein the instructions, when executed by the at least one processor individually or collectively, cause the electronic device to:
receive, from the stylus pen via the communication circuitry, motion information of the stylus pen;
based on the motion information of the stylus pen, correct the position of the specified portion of the stylus pen in the space; and
in accordance with the corrected position of the specified portion of the stylus pen within the spatial range in the space with respect to the 3D effect image, transmit, to the stylus pen via the communication circuitry, a signal allowing execution of a function of the stylus pen,
wherein the function of the stylus pen includes at least one of outputting a vibration by an actuator of the stylus pen, outputting a sound by a speaker of the stylus pen, and/or outputting a light by an emitter of the stylus pen.

9. The electronic device of claim 3,
wherein the at least one camera includes a camera disposed toward the space,
wherein the instructions, when executed by the at least one processor individually or collectively, cause the electronic device to:
obtain the data usable for identifying the position of the specified portion of the stylus pen in the space by:
obtaining, via the camera, first image data including a virtual object representing the stylus pen in accordance with a field of view (FoV) of the camera, and
after obtaining the first image data, obtaining, via the camera, second image data including the virtual object representing the stylus pen in accordance with the FoV of the camera; and
based on a change of a size of the virtual object identified based on the first image data and the second image data, identify the position of the specified portion of the stylus pen in the space.

10. The electronic device of claim 3,
wherein the instructions, when executed by the at least one processor individually or collectively, cause the electronic device to:
obtain the data usable for identifying the position of the specified portion of the stylus pen in the space by:
obtaining, via the at least one camera, data indicating a light emitted through an infrared ray (IR) sensor of the stylus pen; and
based on the data indicating the light emitted through the IR sensor of the stylus pen, identify the position of the specified portion of the stylus pen in the space.

11. The electronic device of claim 3,
wherein the instructions, when executed by the at least one processor individually or collectively, cause the electronic device to:
obtain an original image for providing the 3D effect image;
obtain depth information for the original image; and
generate the first image and the second image from the original image using the depth information.

12. The electronic device of claim 11,
wherein the instructions, when executed by the at least one processor individually or collectively, cause the electronic device to:
based on the depth information, identify recognition positions of the 3D effect image to be perceived as being positioned in the space based on the first image and the second image being concurrently displayed; and
in accordance with the position relationship including a direction of the eye with respect to the electronic device and a distance from the electronic device to the eye, set the spatial range, positioned in the space, extended from the recognition positions of the 3D effect image.

13. The electronic device of claim 1,
wherein the instructions, when executed by the at least one processor individually or collectively, cause the electronic device to:
based on a 2D display mode before an execution of the 3D display mode, providing a 2D effect image on the touch sensitive display, display, via the touch sensitive display, one image,
wherein the 3D effect image is configured to be perceived as being positioned at the space in front of the touch sensitive display, and
wherein the 2D effect image is configured to be perceived as being positioned on the touch sensitive display.

14. The electronic device of claim 1,
wherein the instructions, when executed by the at least one processor individually or collectively, cause the electronic device to:
based on the specified portion of the stylus pen being moved into the spatial range, execute at least one function in accordance with the identified input.

15. The electronic device of claim 14,
wherein the at least one function includes displaying, via the touch sensitive display, other two images changed from the two images for providing another 3D effect image at least partially changed from the 3D effect image.

16. The electronic device of claim 15,
wherein the electronic device further comprises communication circuitry,
wherein the instructions, when executed by the at least one processor individually or collectively, cause the electronic device to:
receive, from the stylus pen via the communication circuitry, pressure information indicating a pressure applied to the stylus pen;
based on a first change in accordance with the pressure information indicating a first pressure, generate the other 3D effect image from the 3D effect image; and
based on a second change different from the first change in accordance with the pressure information indicating a second pressure different from the first pressure, generate the other 3D effect image from the 3D effect image.

17. The electronic device of claim 3,
wherein the instructions, when executed by the at least one processor individually or collectively, cause the electronic device to:
based on the position of the specified portion of the stylus pen within a reference range in the space from the touch sensitive display, switch a mode of the electronic device from the 3D display mode to a 2D display mode;
based on the 2D display mode:
providing a 2D effect image on the touch sensitive display, display, via the touch sensitive display, one image; and
identifying, using the touch sensitive display, an input received from the stylus pen,
wherein the input identified using the touch sensitive display includes at least one of an input including contact points on the touch sensitive display and/or a hovering input.

18. The electronic device of claim 1,
wherein the electronic device further comprises communication circuitry,
wherein the instructions, when executed by the at least one processor individually or collectively, cause the electronic device to:
receive, via the communication circuitry, a signal indicating that a physical button of the stylus pen has been pressed;
based on reception of the signal, obtain data usable for identifying the position of the specified portion of the stylus pen via the at least one camera; and
based on the data usable for identifying the position of the specified portion of the stylus pen, execute at least one function.

19. An electronic device comprising:
at least one camera configured to obtain an image usable for identifying a distance from the electronic device to an eye and a position of a stylus pen being in conjunction with the electronic device;
at least one sensor configured to obtain data usable for identifying a direction of the eye with respect to the electronic device;
a touch sensitive display configured to operate in one of a two-dimensional (2D) display mode and a three-dimensional (3D) display mode;
at least one processor including processing circuitry; and
memory, comprising one or more storage media, storing instructions,
wherein the instructions, when executed by the at least one processor individually or collectively, cause the electronic device to:
based on the 2D display mode representing one effect image by displaying, via the touch sensitive display, one image, identify, using the touch sensitive display, an input received from the stylus pen; and
based on the 3D display mode representing one effect image by displaying, via the touch sensitive display, two images separated from each other, identify, using the at least one sensor and the at least one camera, an input received from the stylus pen.

20. A system comprising:
an electronic device; and
a stylus pen being in conjunction with the electronic device,
wherein the electronic device is configured to:
based on a three-dimensional (3D) display mode of the electronic device, for providing a 3D effect image at a space in front of the electronic device, display two images separated from each other; and
transmit, to the stylus pen, a signal to notify the 3D display mode of the electronic device,
wherein the stylus pen is configured to:
obtain data usable for identifying a pressure applied to the stylus pen; and
in response to reception of the signal from the electronic device, transmit, to the electronic device, pressure information indicating the pressure applied to the stylus pen identified based on the data,
wherein the electronic device is configured to:
receive, from the stylus pen, the pressure information indicating the pressure applied to the stylus pen; and
identify a position of a specified portion of the stylus pen as an input having the pressure with respect to the 3D effect image.
